(19) United States
(12) Patent Application Publication
(10) Pub. No.: US 2007/0027929 A1
(43) Pub. Date: Feb. 1, 2007

(54) System, method, and/or computer program product for a file system interface

(76) Inventor: Gary J. Whelan, Holly Springs, NC (US)

Correspondence Address: LITMAN LAW OFFICES, LTD, PO BOX 15035, CRYSTAL CITY STATION, ARLINGTON, VA, 22215, US

(21) Appl. No.: 11/193,441

(22) Filed: Aug. 1, 2005

(51) Int. Cl. G06F 17/30

(52) U.S. Cl. 707/200

(57) ABSTRACT

A system, method and/or computer program product for a file system interface (FSIP) that scans a file system of the computer system to obtain file system information, automatically collects and organizes the file system information into an internal cache of the file system information organized in a predetermined manner to enable instantaneous response of query(s) that provides a predetermined view of the file system, automatically monitors the file system for changes, and automatically maintains the internal cache. The FSIP maintains file system information internal data structure consistency, instructs the computer system to construct visual report(s) of the file system without rescanning the system, and instructs the computer system to scan a predefined portion of the file system, whereby multiple portions of the file system can be simultaneously scanned. The FSIP stores the file system information in a single data store, and executes a depth first traversal of the file system.

### BACKGROUND OF THE INVENTION

1. Field of the Invention

The present invention relates generally to computer systems and data storage and, more particularly, to a system, method and/or computer program product for a file system interface.

2. Description of the Related Art

Computer systems store information on storage devices and retrieve information from the storage devices. The storage devices are the hardware components of which file systems write to and read from. File systems are created with software components built into the Operating Systems. Application and user access to data has changed very little over the past twenty years. The usefulness of many files on a storage subsystem can be come unknown over time. Many types of files that are not needed are left around by programs and users. Files may also have aged to the point where they are no longer needed. There can also be many copies of the exact same file on the storage subsystems and a multiplicity of subsystems. The way that that files are presented to users has also changed very little in the past several years. Currently, there are no platforms available to allow users to write their own macros, scripts, and programs to easily interface to specific files or file types.

Therefore, a need exists for a system, method and/or computer program product for a file system interface.

### SUMMARY OF THE INVENTION

The present invention is a system, method and/or computer program product for a file system interface. The system, method and/or computer program product for a file system interface carry out steps including scanning a file system of the computer system to obtain file system information, automatically collecting and organizing the file system information into an internal cache of the file system information organized in a predetermined manner to enable instantaneous response of at least one query that provides a predetermined view of the file system, automatically monitoring the file system for changes, and automatically maintaining the internal cache. The system, method and/or computer program product for a file system interface can further carry out steps including maintaining internal data structure consistency of the file system information, instructing the computer system to construct at least one visual report of the file system without rescanning the system, and instructing the computer system to scan a predefined portion of the file system, whereby multiple portions of the file system can be simultaneously scanned. The system, method and/or computer program product for a file system interface can further carry out steps including storing file system report information in a single data store, executing a depth first traversal of the file system, and storing the file system information in a set of data structures in memory that is built incrementally during the traversal.

The system, method and/or computer program product for a file system interface can further carry out steps including enabling a facility enabling user-specified computer instructions to be executed, linking to the one or more of the multiple visual reports available to a user, generating varied reports based on the age of some or all files on the file system, determining the presence of duplicate files on the computer system, generating a report of security permissions for some or all parts of the file system, generating a report of security vulnerability of some or all parts of the file system, and providing with an original file/files virtual views of backup, mirror, revisions, snapshot, and volume shadow copies of the original file/files.

The system, method and/or computer program product for a file system interface can further carry out steps including providing transparent views of remote file systems running the steps, and instructing a computer system to record the users file system transactions, and to store and replay the file system transactions. The system, method and/or computer program product for a file system interface can further carry out steps including reading and writing files to virtual locations, displaying icons in a matter to automate execution of software programs, providing virtual views of remote file shares, securely administering remote file system interface platforms, and enabling remote File System Interface Platform (FSIP) users to allow, disallow and store authorized and unauthorized connections.

The system, method and/or computer program product for a file system interface can further carry out steps including securely selecting computer resources available to authorized connections, keeping one copy of duplicate files, and programmatically creating shortcuts to the single copy where remaining duplicate files reside and removing the duplicate files to save on disk storage space. The system, method and/or computer program product for a file system interface can further carry out steps including migrating a single copy of a duplicate to shared storage and creating a shortcut to point to the single copy in shared storage, migrating old/aging files to alternate lower cost media, and programmatically creating a shortcut to the migrated file.

The system, method and/or computer program product for a file system interface can further carry out steps including processing database transactions at any number of locations running a FSIP, creating synchronized databases in disparate geographical locations, automatically creating database tables and features based on input transactions, creating a database without requiring human programming, and creating client side database transactions by selecting display elements. The system, method and/or computer program product for a file system interface can further carry out steps including monitoring file system changes and maintaining file system interface data structures, transferring data to another file system when data is changed, working in conjunction with a user messaging system, effecting a query to obtain information on a predetermined user from all File Access Processors, a local directory on the system, and a directory services system, creating a permissions monitor to manage company wide data security, adding security credentials from a user that performs an add remote operation to a remote system, storing the added security credentials to the remote system, and managing file system changes by alerting users of security changes.

The system, method and/or computer program product for a file system interface can further carry out steps including updating internal structures, automatically transmitting changed file, and sending journal changes to journal monitors, enabling manual transfer of files to a user or group, creating a Personal Virtual Network to emulate a LAN and provide a LAN to LAN connection over an authorized FSIP, enabling the use of personal voice and video over a FSIP, providing a user collaboration interface, creating animation icons, displaying an animation icon, enabling automatic file transfer, enabling operation on a JAVA enabled web browser, providing a gateway to connect a JAVA enabled web browser with a FSIP, and enabling the use of personal voice and video over a FSIP. The system, method and/or computer program product for a file system interface can further carry out steps including detecting use of plug and play devices, such as cameras, phones, other removable media, or the like, and automatically transmitting files to remote users and groups. The system, method and/or computer program product for a file system interface can further carry out steps including providing a single secure messenger configured to securely transfer messages including email messages and instant messenger messages. The system is configured to provide a distributed computing environment executable on any business/personal computer using any type of operating system or hardware.

### BRIEF DESCRIPTION OF THE DRAWINGS

FIG. 1 is a high level diagram of some of the operating system interfaces used by a FSIP according to the present invention.

FIG. 2 is a high level diagram of an FSIP for a single system according to the present invention.

FIG. 3 is a high level diagram of FSIP used with multiple systems according to the present invention.

FIG. 4 is a more detailed view of the FSIP with operation system interfaces according to the present invention.

FIG. 5 is an illustration of the Services Manager component of the FSIP according to the present invention.

FIG. 6 is an illustration of FSIP Service Processors according to the present invention.

FIG. 7 is the transmission header relationship as the Tree Hopper Application Program Interface (THAPI) requests flow to and from clients and Service Processors, and between service managers on a network according to the present invention.

FIG. 8 is an illustration of some of the routing and security components in both the THAPI header and the Service Manager Route Headers according to the present invention.

FIG. 9 is an illustration of a prior art directory scanning technique.

FIG. 10 is an illustration showing how the FSIP Access Processor scans and hops in the forward direction according to the present invention.

FIG. 11 is an illustration showing how the FSIP Access Processor completes the scan in a backwards direction, and summarizes key file system information according to the present invention.

FIG. 12 is a flow chart illustrating some of the steps performed during the depth first scanning example in the FSIP Access Processor according to the present invention.

FIG. 13 is a flow chart illustrating some of the decisions used to determine the next directory in the FSIP processor first search according to the present invention.

FIG. 14 is a screen shot of the FSIP monitor displaying multi-threaded depth first scanning according to the present invention.

FIG. 15 is an illustration showing how views can be built in a link list residing in memory according to the present invention.

FIG. 16 is an illustration showing how views can be built with a dynamic link table residing in memory according to the present invention.

FIG. 17 is an illustration showing how multi-point directory blocks can be built to facilitate concurrent multi-point file transfer and file virtualization according to the present invention.

FIG. 18 is a screen shot of the FSIP monitor display showing progress information during concurrent multi-point file transfers according to the present invention.

FIG. 19 is a flow chart showing how file system access rights are built and then summarized according to the present invention.

FIG. 20 is a screen shot of a single computer or company wide system security management and monitor according to the present invention.

FIG. 21 is an illustration showing how security alerts are passed by each service manager and gathered by the file system security monitor to alert companies or users of the file system permission changes that could make their systems' vulnerable according to the present invention.

FIG. 22 is an illustration showing the file system change journal according to the present invention.

FIG. 23 is an illustration showing how storage and security reports are stored centrally according to the present invention.

FIG. 24 is an illustration of the FSIP processor sending messages to storage owners or users so they can view and interact with the file system using a windows or web based interface according to the present invention.

FIG. 25A is a flow chart of the automatic transmitting of plug and play files according to the prior art.

FIG. 25B is a flow chart of the automatic transmitting of plug and play files according to the present invention.

FIG. 26 is a screen shot when a user clicks on the plus sign of the Tree Hopper explorer on a file, where it displays virtual files in a user defined color according to the present invention.

FIG. 27 is a screen shot showing the age file view of the Tree Hopper explorer according to the present invention.

FIG. 28 is a screen shot showing a duplicate file view of the Tree Hopper explorer according to the present invention.

FIG. 29 is a screen shot showing an extension view of the Tree Hopper explorer according to the present invention.

FIG. 30 is a screen shot showing the size view of the Tree Hopper explorer according to the present invention.

FIG. 31 is a screen shot showing a specified file type of the Tree Hopper explorer according to the present invention.

FIGS. 32A and 32B are flow charts of a shortcut creator utility according to the prior art.

FIGS. 32C and 32D are flow charts of a shortcut creator utility according to the present invention.

FIG. 33A is a screen shot of the Tree Hopper Remote Access Manager graphical user interface according to the present invention.

FIG. 33B is a screen shot of the Tree Hopper graphical user interface for connecting to or disconnecting from remote systems using the Remote Access Manager graphical user interface according to the present invention.

FIG. 34 is a flow chart showing the add remote process performed by the graphical user interface and the Service Managers on both systems according to the present invention.

FIG. 35A is a screen shot showing the Service Manager logon popup screen according to the present invention.

FIG. 35B is a screen shot showing an approval request for a Service Manager Add Remote according to the present invention.

FIG. 35C is a screen shot showing a user disapproved for a Service Manager Add Remote according to the present invention.

FIG. 36 is a flow chart of some of the steps the File Access Processor can take when monitoring the file system change journal according to the present invention.

FIG. 37 is a screen shot showing the properties menu for remote users according to the present invention.

FIG. 38 is a screen shot of the features menu for local groups according to the present invention.

FIG. 39 is a screen shot of a Tree Hopper plug-in that a user can use with Windows Explorer to manually transfer files to a group according to the present invention.

FIG. 40 is a simple diagram showing how a Service Manager can tunnel personal private network feature to another Service Manager over a network according to the present invention.

FIG. 41 is a simple flow diagram showing how a Service Manager can tunnel personal voice and video to another Service Manager over a network according to the present invention.

FIG. 42 is a screen shot of the user collaboration interface according to the present invention.

FIG. 43 is a screen shot of the instant messenger with user activity alert icons and anicons according to the present invention.

FIG. 44 is a flow chart showing how events can be registered and listened for with the Service Manager according to the present invention.

FIG. 45 is an illustration of the tiered relationship of client systems and database systems, and the central administrator running the database management software according to the present invention.

FIG. 46 is a flow chart showing some of the steps the Distributed Database Configuration graphical user interface can take to interact with a user and send commands to remote Service Managers according to the present invention.

FIG. 47 is an illustration of some of the elements of the routing tables Service Managers use for client, server, and transaction routing according to the present invention.

FIG. 48 is a flow diagram showing some of the steps an FSIP Service Manager performs when a Database Access processor issues a register database and how the Service Manager propagates to all Service Managers in the database service group according to the present invention.

FIG. 49 is a flow chart showing some of the steps a Service Manager does to send database information to other Service Managers dynamically when a TCP/IP connection is established according to the present invention.

FIG. 50 is a flow chart showing some of the synchronization processing of finding the last table update processed by an FSIP Service Manager, and recreating TH_DB_WRITE records to update the Database Access Processor according to the present invention.

FIG. 51 is a flow chart showing some of the steps of how client applications find out about databases and tables according to the present invention.

FIG. 52 is a flow chart showing some of the steps of how the Service Manager logs and routes a THAPI request according to the present invention.

FIG. 53 is a flow chart showing some of the steps of how a Service Manager can keep track of transactions and retransmit the transactions if necessary according to the present invention.

FIG. 54 is a flow chart showing some of the steps of how query and write transactions responses are processed by each Service Manager according to the present invention.

FIG. 55 is a screen shot showing the distributed application and database generator GUI according to the present invention.

FIG. 56 is a flow chart showing some of the steps of how the generator builds and outputs the distributed database application according to the present invention.

FIG. 57 is a flow chart showing some of the steps of how the generator builds and outputs the FSIP Database Access Processor according to the present invention.

FIG. 58 is a simple example of a relational mapping xml output according to the present invention.

FIG. 59 is a java sample output of a client application writing to the database according to the present invention.

FIG. 60 is a flow chart of some of the steps a client and Service Manager can take when write transaction is needed according to the present invention.

FIG. 61 is an illustration of the THAPI running in a web browser and how a web server in conjunction with an FSIP Service Manager can provide gateway functionality between web browsers and FSIP systems according to the present invention.

FIG. 62 is a block diagram of a computer system that can be used with the FSIP according to the present invention.

Similar reference characters denote corresponding features consistently throughout the attached drawings.

### DETAILED DESCRIPTION OF THE PREFERRED EMBODIMENTS

The present invention is a system, method and/or computer program product for a file system interface. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The system, method and/or computer program product for a file system interface according to the invention facilitates the assessment of file systems, and then reports and reacts on these results. The inventive system, method and/or computer program product provides a novel approach to scanning files. This novel approach actually hops the file directory tree to the end and scans directories in depth first order. The name used herein for this novel approach is called Tree Hopper. As used herein, the system, method and/or computer program product for a file system interface according to the invention will be referred to as the File System Interface Platform (FSIP).

The FSIP enables the pre-building of “views” of a file system while performing the Tree Hopper scanning functionality. These views provide sub-second response to common user requests. User requests are functions such as sort by size, sort by file name, sort by file extension, sort by age, search, etc. There are programs on the market today that can do these functions, but perform the processing when the user asks for them. The Tree Hopper approach pre-builds these “views” in advance by utilizing control block link lists, pointer tables, know in the art routines, and novel programming methods designed to optimize this process. For example, the FSIP has a dynamic link table mechanism, which builds link tables automatically with a simple calling convention, versus having to be programmed. In addition to these “views”, the FSIP provides several new views of file systems not included in products on the market today. Such new views include age, stale data, duplicate, extensions, size views, etc.

Multiple age views correspond to a technique where the user can specify multiple age parameters and the views are built in advance. Programs exist that can sort by time, but the Tree Hopper creates link lists in memory based on how much time since last accessed, modified or created. It is not easy to extrapolate this from merely sorting on time. Another novel “view” is the duplicate file view. Duplicate files clutter storage subsystems everywhere. Summarized file system permission is even another view not available in the prior art. You can sort by file extension very easily or search by file extension. But what if you wanted a view of all the file types, with a total of size for each type, and have a sorted by size list of all files within a type? The FSIP builds these views automatically. In particular, the FSIP can scan a file system of a computer system to obtain file system information, automatically collect and organize the file system information into an internal cache of the file system information organized in a predetermined manner to enable instantaneous response of at least one query that provides a predetermined view of the file system, automatically monitor the file system for changes, and automatically maintain the internal cache.

The Tree Hopper scans the file system in a unique order, so it can give summarization views of directories and files by size, name, age, journal record number and security permissions. Programs exist that can display the size of a directory, by rescanning, but the FSIP apparatus can display the size of all directories and subdirectories at the same time already pre-calculated. Directory and file access permissions are important characteristics of file systems. The FSIP scanning method facilitates the summarization of security permissions, queries user and group accounts from the user database, and summarizes security vulnerabilities anywhere in the directory structure. This saves information technology professionals significant time by not having to manually go through reports that are generated from software on the market today.

Once you have these “views” of the file system, the FSIP facilitates the removal of un-useful files from the storage subsystem. This is accomplished by graphical user interface software that can delete unwanted files, migrate to tape un-accessed files, and combine duplicate files. There are also instances where information technology experts have to provide unique processing of a file. The FSIP provides interfaces for exit routines, macro interfaces and communication interfaces to solve that problem, making it a development platform. The exit facility allows for a custom program or script to be executed when a certain file, file type or a multiplicity thereof are encountered while scanning the file system.

Any number of parameters can be passed to the exit routine, such as the access full file path of the file encountered, and any other parts of the file attributes. An example is when a file is encountered that needs to be migrated to a different device or location. The exit routine gets called and can perform that function. The macro facility interfaces with operating system specific interfaces to load applications, pass parameters to the applications, and issue a macro command for that application to process. For example, when a certain file type is encountered, a word processor may need to be loaded. A macro may then be issued to find and replace data in that file. The user only needs to be concerned with writing or recording a macro, and making a simple configuration statement change for the FSIP.

Multi-threaded, consolidated reporting and multiple processors, scales the FSIP to work in large data centers where storage subsystems are abundant. The FSIP can work on more than one host computer and access multiple storage subsystems at the same time. Output data is centrally stored by all instances of the FSIP to create a scalable architecture to scan large quantities of data at the same time. This FSIP design point is believed to be novel for file system scanning methods in the current art.

The FSIP provides a unique and different approach to scanning file systems, creating “views” of file systems, reducing space on file systems, performing unique functions on specific files or a multiple thereof, multi-threading, with common repository to work on multiple storage subsystems at the same time, and distributing report pointers versus reports.

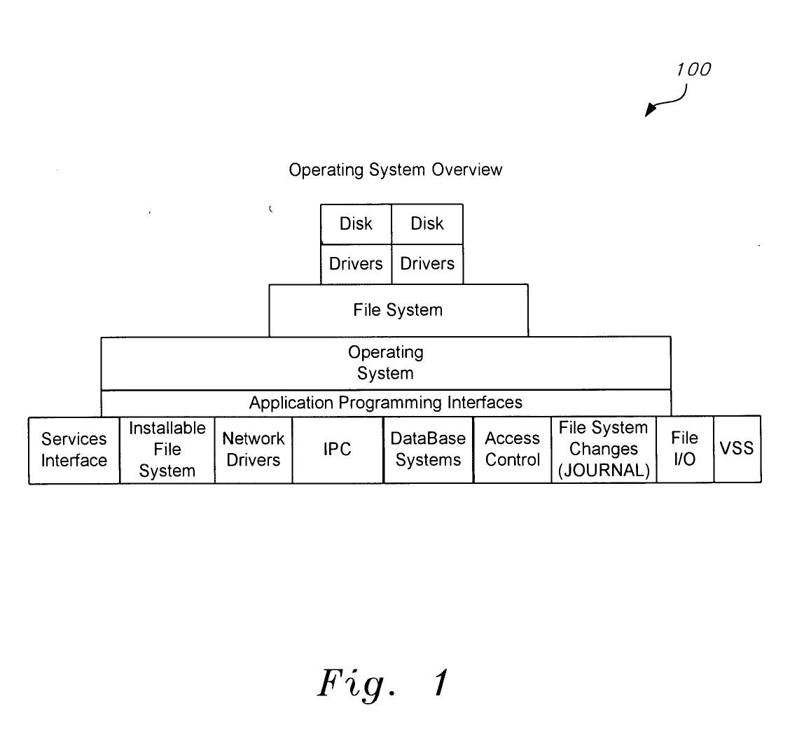

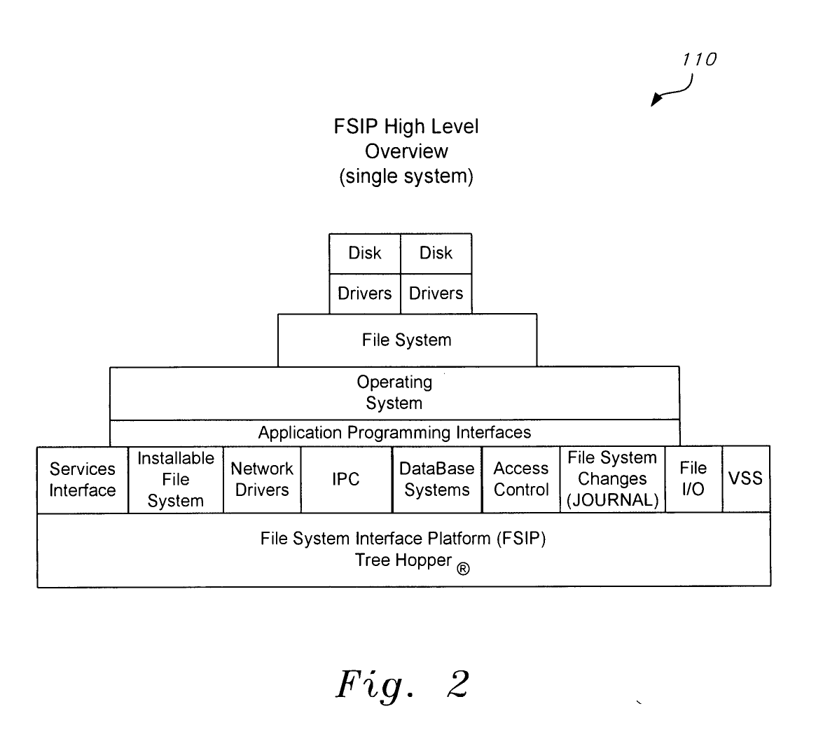

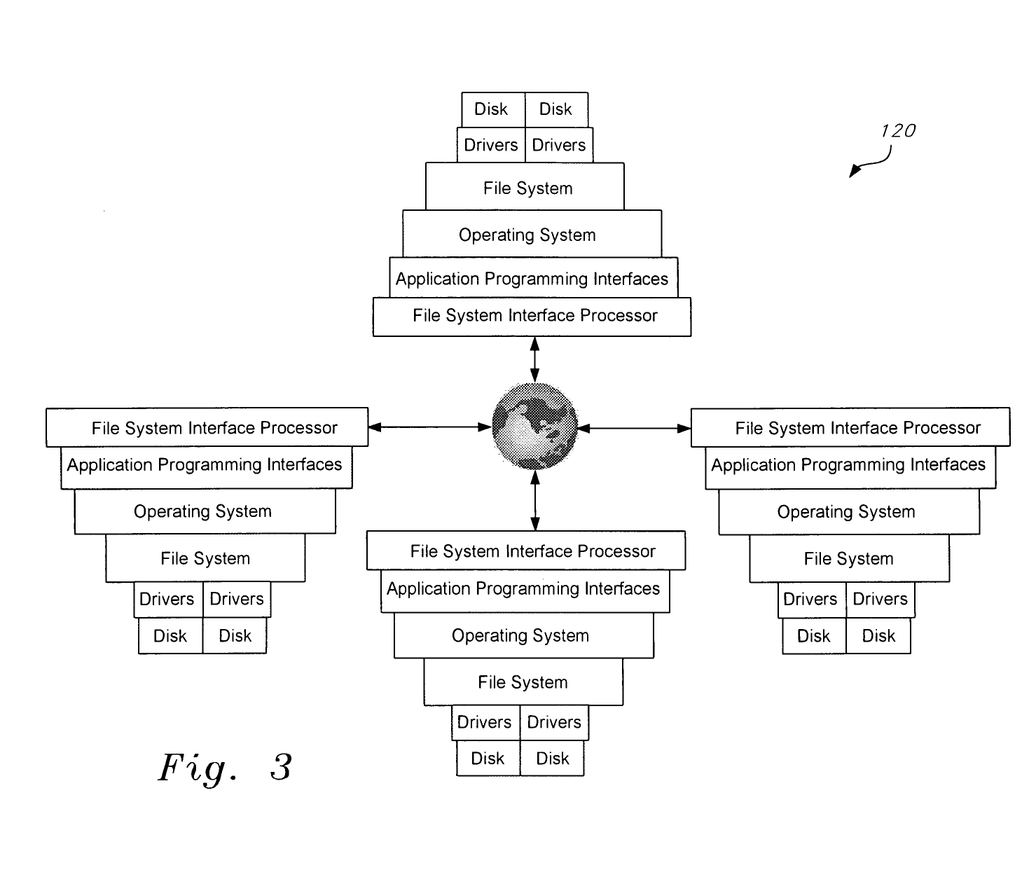

FIG. 1 shows a high level diagram 100 of operating system interfaces used by the FSIP according to the present invention. These interfaces include basic operating system interfaces that have, for the most part, changed very little in the past fifteen years. Operating systems have file systems that write directory or folder information and file information to disk media. They interface with disk drivers so hardware controller and disk manufacturers can provide hardware specific interfaces. The Application Programming Interfaces level illustrates the system and application interfaces utilized by the present invention. FIG. 2 is a high level diagram 110 of the FSIP for a single system that illustrates how the invention can plug into the operating system Application Programming Interfaces. FIG. 3 is a high level diagram 120 of the FSIP used with multiple systems. Any number of systems can be connected together securely, can be encrypted, and the FSIP provides remote access features that are not available in the prior art, such as automatically generated user credentials.

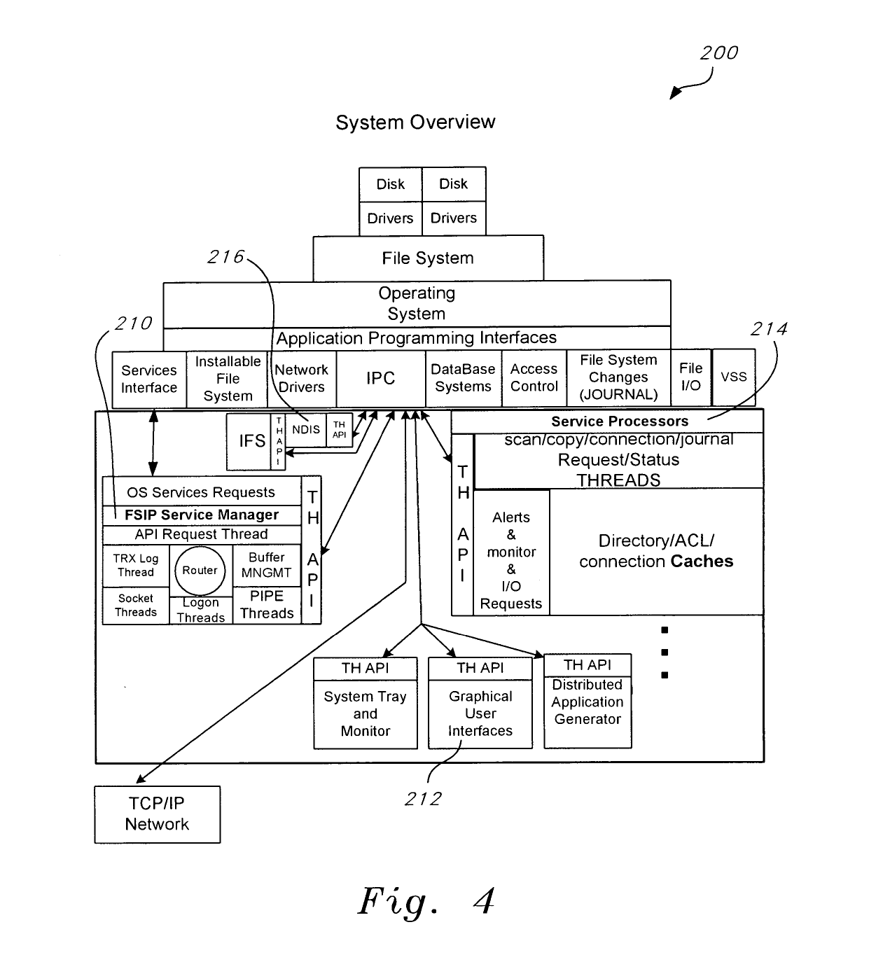

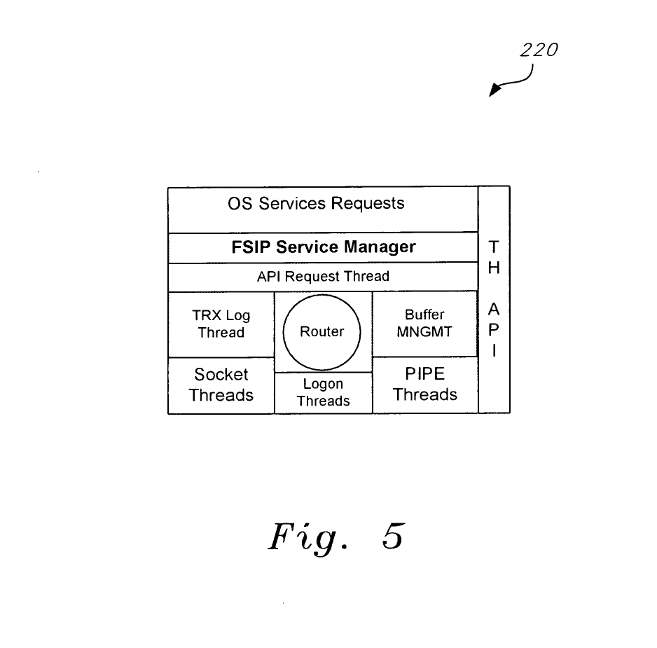

FIG. 4 is a detailed view of the FSIP 200 with the operation system interfaces. The FSIP 200 is broken down into three distinct layers that allow scaling from a single personal computer to an enterprise wide configuration. The layers include the FSIP Service Manager layer 210, the user interface layer 212, the Service Processors layer 214. Also included are device drivers 216 that are a type of Service Processor. FIG. 5 is an illustration 220 of the Services Manager component of the FSIP. The Service Manger interfaces with the operation system services interface, manages all of the Service Processors, and provides TCP/IP wide area networking, numerous interface routines for Service Processors, and user interfaces.

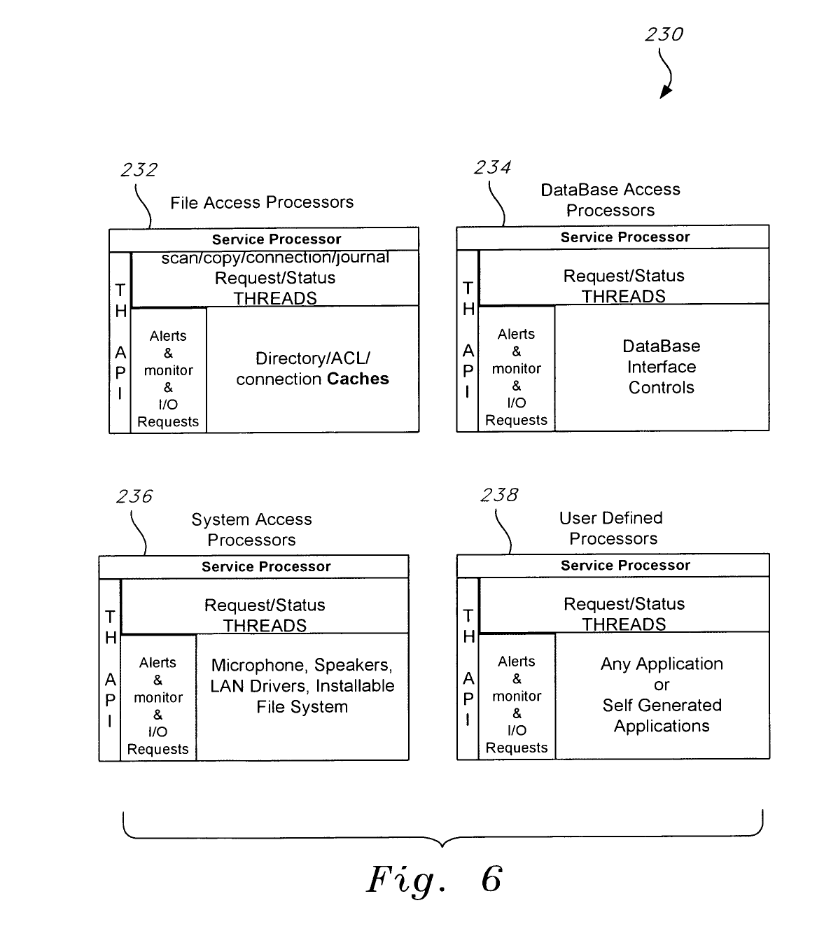

FIG. 6 is an illustration 230 of various types of Service Processors. High level components of the File Access Processors 232 have many novel approaches to extended file access both locally and remotely. These novel approaches include caching file system information in pre-calculated views, summarizing file system and security information, transmitting data when files are changed and other features described herein. DataBase Access Processors 234 have many novel approaches for enhancing database access, such as automatic generation of client and server applications, distributed databases, and transaction routing. System Access Processors 236 can interface with any system component to support other novel features in the present invention, like Personal Virtual Networking. User Defined Processor 238 can be user programmed or self generated applications. This unique system, with its combination of components and security, provides for a feature rich Distributed Computing Environment that can run on any business and/or personal computer in conjunction with any type of operating system and/or hardware. These various Service Processors can be loaded automatically or on demand.

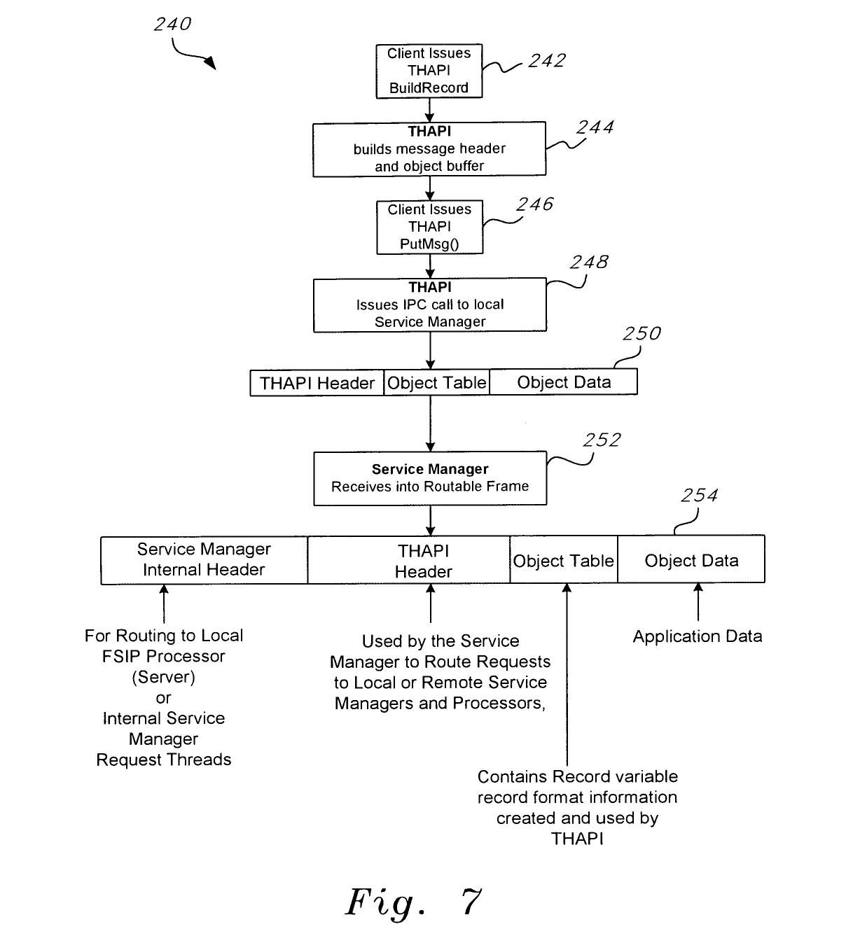

FIG. 7 is the transmission header relationship 240 as the Tree Hopper Application Program Interface (THAPI) requests flow to and from clients and servers, and between service managers on a network. The THAPI is a full feature multi-platform object and record oriented API that facilitates interprocess communications, between User Interfaces, Service Managers, and Service Processors. The FSIP system includes THAPI multi-language interfaces that run on the Service Processors of the User Interface and Service Manager to build messages both for local and remote interprocess communications. When the User Interface system issues THAPI commands 242 the THAPI assembles the headers and object buffers for the application 244. The application can send the request with a PutMsg( ) 246 call to the local Service Manager 248. An example of some of the message fields that are sent is shown in 250. There is a header known as the THAPI header which has information to the route, the command, and the control of the message. The object table defines the variable record format of the object, and then the actual data follows.

The Service Manager receives the routable frame 252 and puts the frame into a slightly larger buffer 254 so it can be routed to a process within the Service Manager, a Service Processor on the local system, or a Service Manager or Service Processor on a remote system. The Service Manager internal header has control information so requests can be routed locally. The THAPI does not require a local Service Manager 248 in all cases, for example if the THAPI is running in a JAVA enabled web browser. In this case the browser can perform THAPI interprocess communications to remote Service Managers.

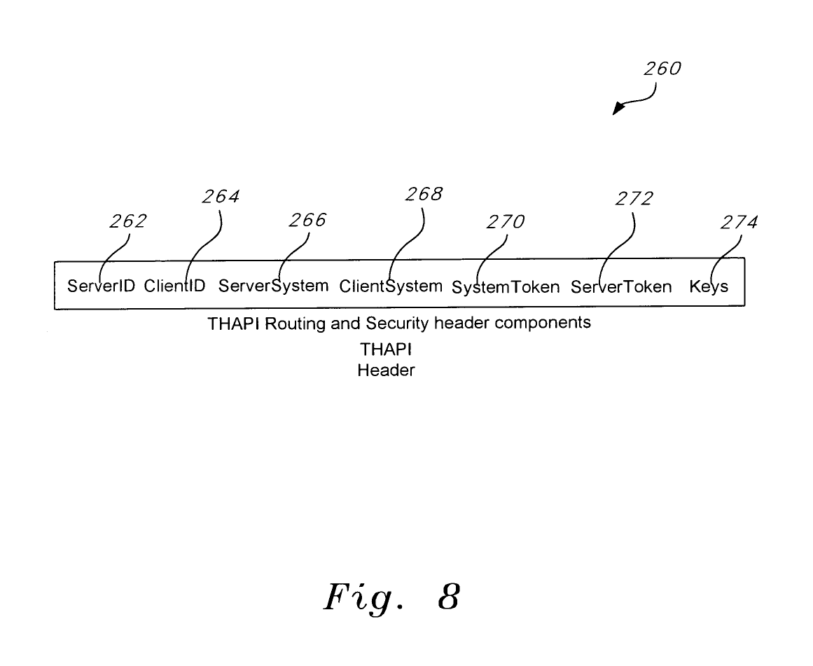

FIG. 8 is an illustration 260 of some of the routing and security components in the THAPI header. The FSIP system first encrypts the packet using an encryption algorithm such as SSL, PKI, etc., that is not enough for companies and home users to open their systems. The ServerID 262 identifies a specific FSIP Service Processor. The ClientID 264 identifies a specific client. The ServerSystem 266 identifies the system on which the FSIP Service Processor is running. The ClientSystem 268 identifies the system on which the client is running. By using the ServerID 262, ClientID 264, ServerSystem 266, and ClientSystem 268, the FSIP can be encapsulated in any protocol and routed anywhere. The SystemToken 270 is the access token for the system. This access token is generated when one Service Manager logs into another Service Manager.

After system level authentication, the ServerToken 272 is the access token the client application users to login to an FSIP processor. The Keys 274 represent key fields that are used to scramble the access tokens and other fields making each frame different and extremely difficult to analyze and unlikely to penetrate by unauthorized users. In the prior art users can access systems with a login, usually a single login. The token generated can now be used every time the system is accessed to identify the user. There are known vulnerabilities with this approach. With an analyzer a hacker can obtain a token and inject frames with valid token, and gain access to the system. Even with private key encryption, if the pass phrase is obtained and tokens are compromised, unauthorized access can be made.

The FSIP uniquely uses two different logins and tokens, and changes them in every frame. One token is for system to system communication, and the other token is for client to server communication. This approach allows multiple clients to access different authorized resources through a single connection. These logins can use one of three techniques. In the first technique, the login can use a Security Service Provider Interface (SSPI), which is a multi-frame digest supported by the operating system. This is good for single system enterprise logins. For the second technique, the login uses userIDs and groups using administrative tools supplied by the operating system. This is somewhat harder to administer and only good for skilled administrators. For the third technique, the FSIP self generates userIDs and passwords. Self generation has several advantages including but not limited to ease of administration and enhanced security by avoiding common userIDs and passwords, which users tend to do. The FSIP supports all three of these techniques. In addition, the FSIP changes the Keys, and uses these changing keys to change other information in the header, including the two access tokens, so many of the fields are constantly changing to help prevent unauthorized access. The use of two separate logins, one for system to system, and the other for client to server, further prevents unauthorized access.

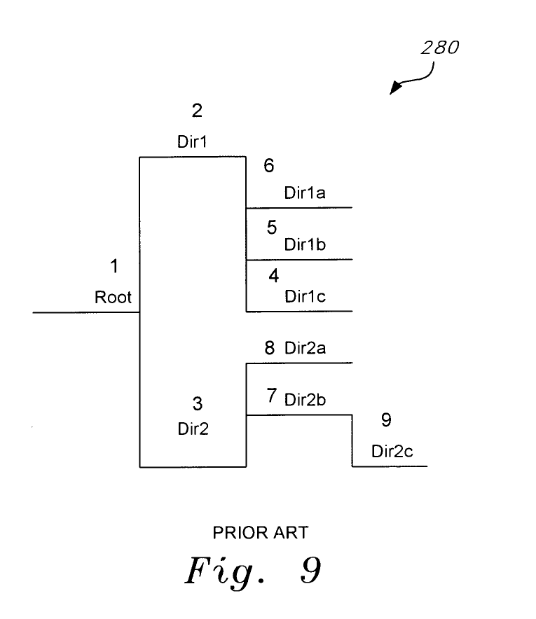

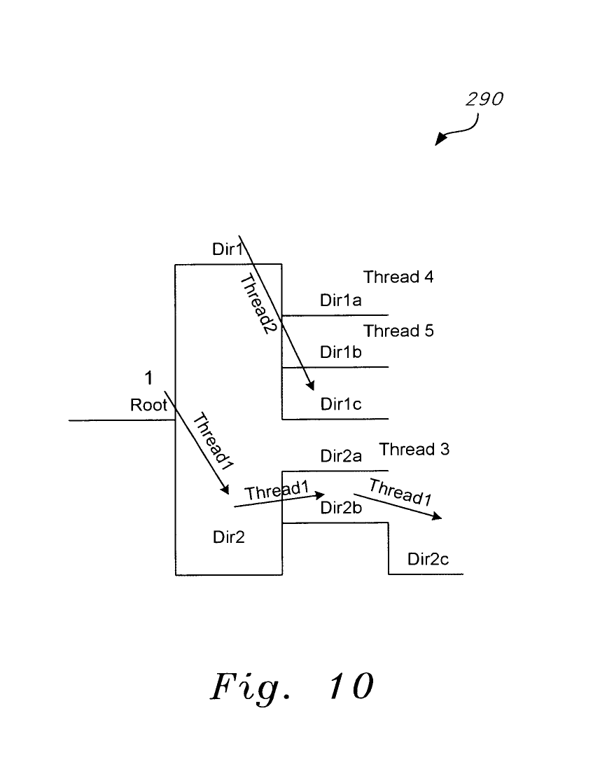

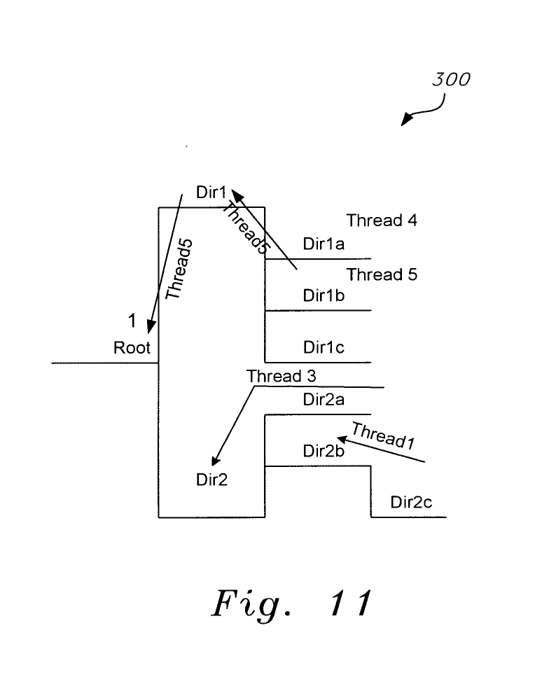

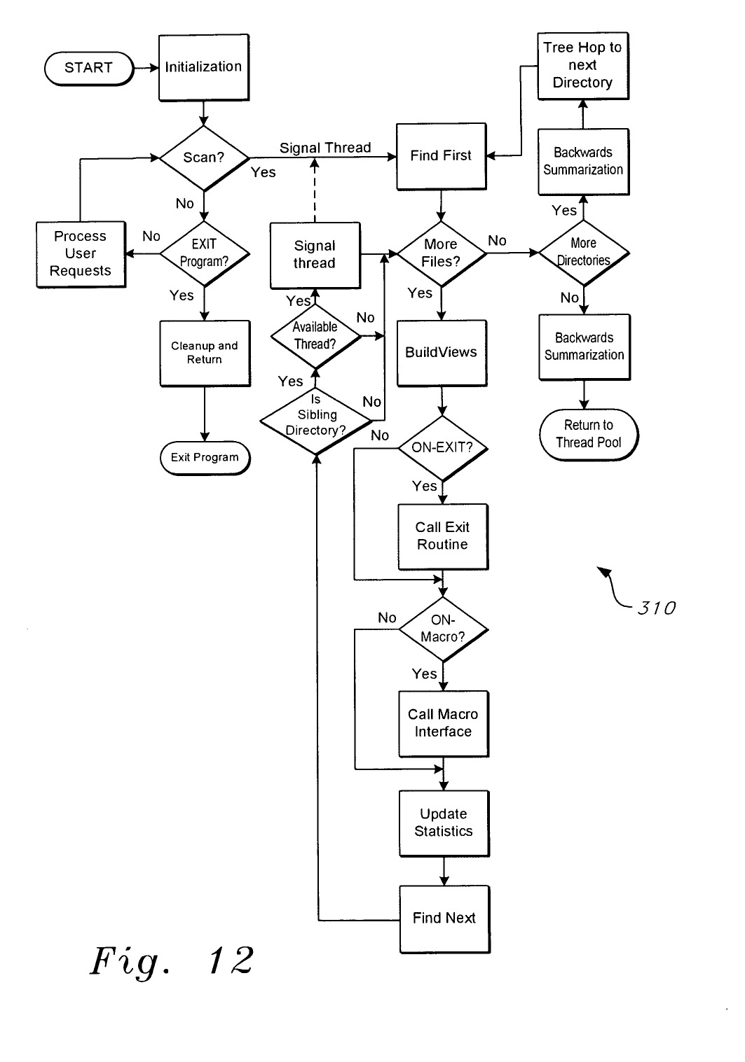

FIG. 9 is an illustration 280 of a prior art directory scanning technique. FIG. 10 is an illustration 290 showing how the FSIP processor multi-threaded scans and hops in the forward direction. FIG. 11 is an illustration 300 showing how the FSIP processor completes the scan in a backwards direction, and summarizes key file system information. The summarization and data structures are then managed and maintained as file system changes take place. FIG. 12 is a flow chart 310 illustrating the major steps performed by the multi-threaded depth first scanning running in a File Access Processor (FAP). After the initialization of the FAP a scanning decision is made. During the initialization, and based on configuration a thread pool can be created. At first a single thread can be signaled to start the scan. This thread does a Find First system API call and goes to the main scanning loop by building the views with link list and link table control blocks, then conditionally issues exit routines and macro exits, updates monitor statistics, and then does the Find Next system API call.

Every time after a Find Next system API call is made, a check is made to see if a directory is detected. If a directory is detected and more threads are available in the thread pool, another thread is signaled to start another depth first scan starting with that directory. This loop continues until there are no more files and directories in the subdirectory. A decision is then made to summarize and return to the thread pool, or to summarize and continue in depth the first tree hop to the child subdirectory. Threads return to the thread pool so that only one thread in a subdirectory summarizes backwards past its parent directory. When the entire drive or directory path is completed only one thread finishes and summarizes to the root.

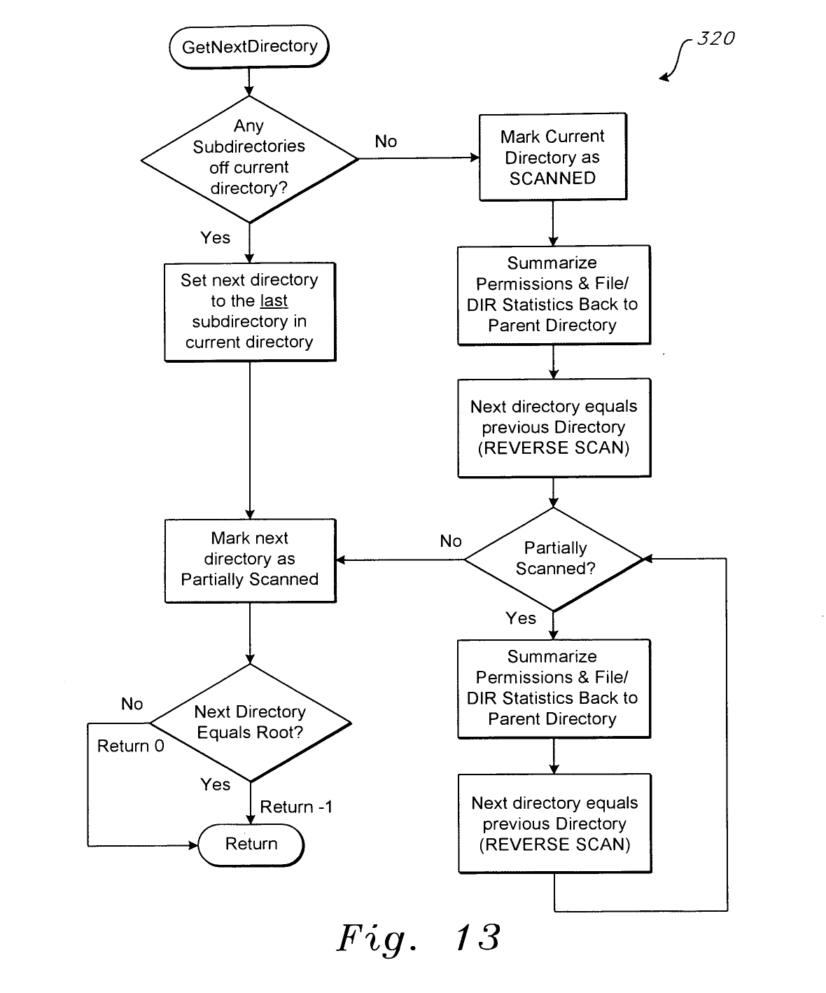

FIG. 13 is a flow chart 320 illustrating some of the decisions and processing used to determine the next directory, also known as a tree hop, in the FAP depth first search. The first decision block checks to see if there are any child directories. Depth first scan processes child directories before processing sibling directories. A multi-thread depth first signals threads to depth first scan siblings while the thread is scanning in a depth first manor. If there are child directories they are selected for the next scan and returned to the main loop as illustrated in FIG. 12. If there are no child directories then the thread summarizes backwards, sets the next directory to the parent or previous, and determines if there are any sibling directories to scan at the partially scanned decision block. If or when all siblings are completed, then the thread summarizes backwards until it hits the root or returns to the thread pool because another thread is active in that subdirectory.

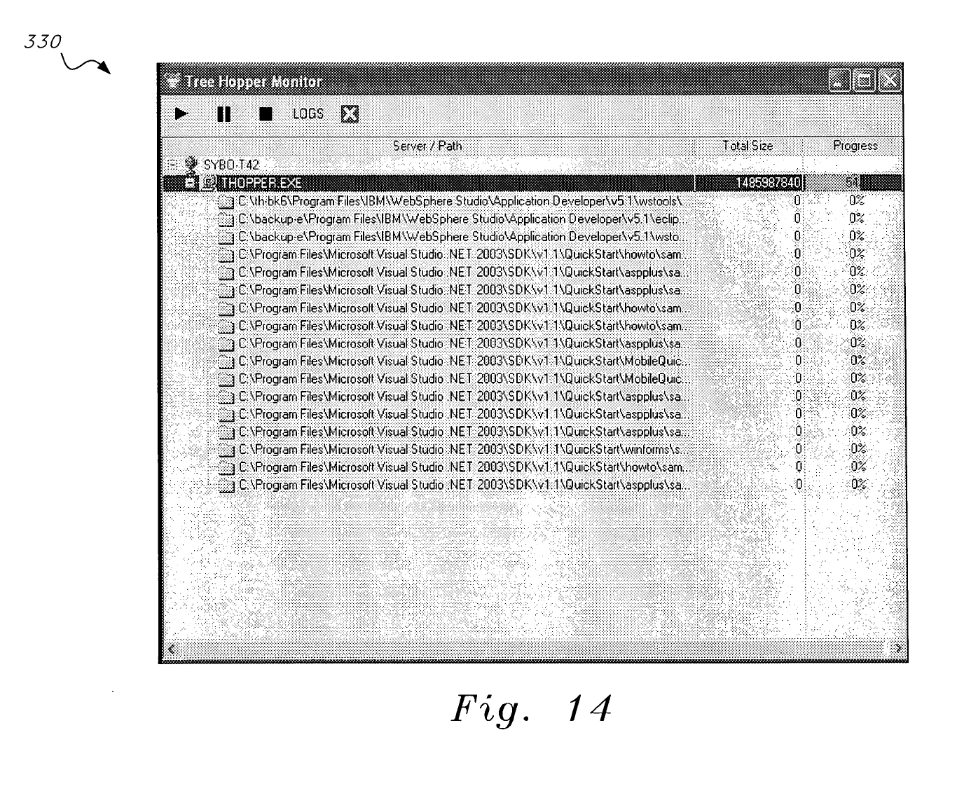

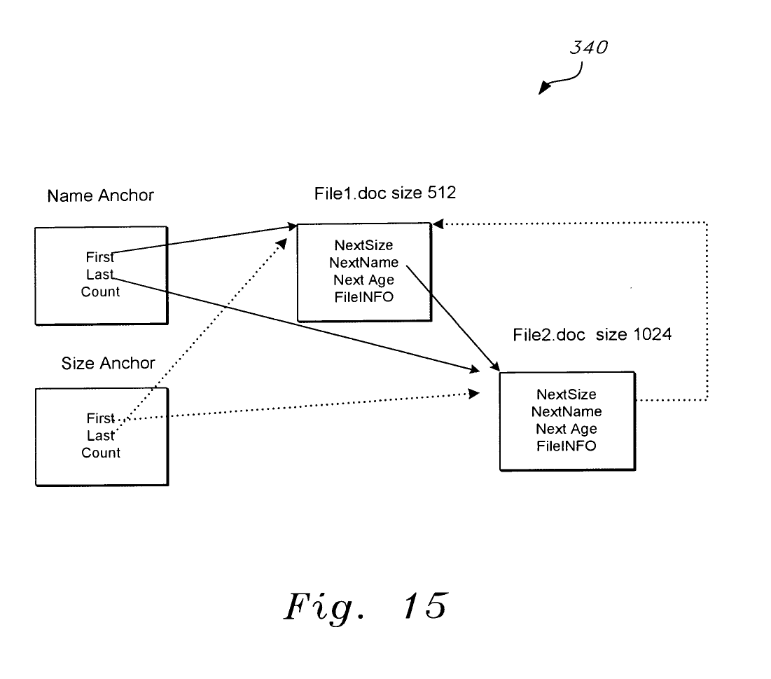

FIG. 14 is a screen shot 330 of the FSIP monitor displaying statistics from the multi-threaded depth first scanning. FIG. 15 is an illustration 340 showing how views can be built in a link list. Link lists are well known techniques for storing information in memory. Link lists are only used for some of the features in the FAP. FIG. 16 is an illustration 350 showing how views can be built with a dynamic link table. Since link lists are sequential in nature, they do not provide an efficient way to keep information sorted. The dynamic link table features in the FAP allow for any number of sorted lists all pointing to the same control information, but in different orders, allowing for views to be instantaneously accessed. The illustration 350 shows a name and a size link table. Both point to the same file or directory control block but each table is in a different order. The FAP also has a novel approach of connecting link tables to one another, which is needed for some of the features of the present invention. An example is the summarizing of file system security information. Since a file or directory can have any number of Access Control Entries and a single Access Control Entry can be associated to any number of directories or files, the link tables can be connected, so when a directory is summarized, it's link table is connected to the access control entry table, so both can be summarized at the same time. The dynamic Link table mechanism can perform this automatically.

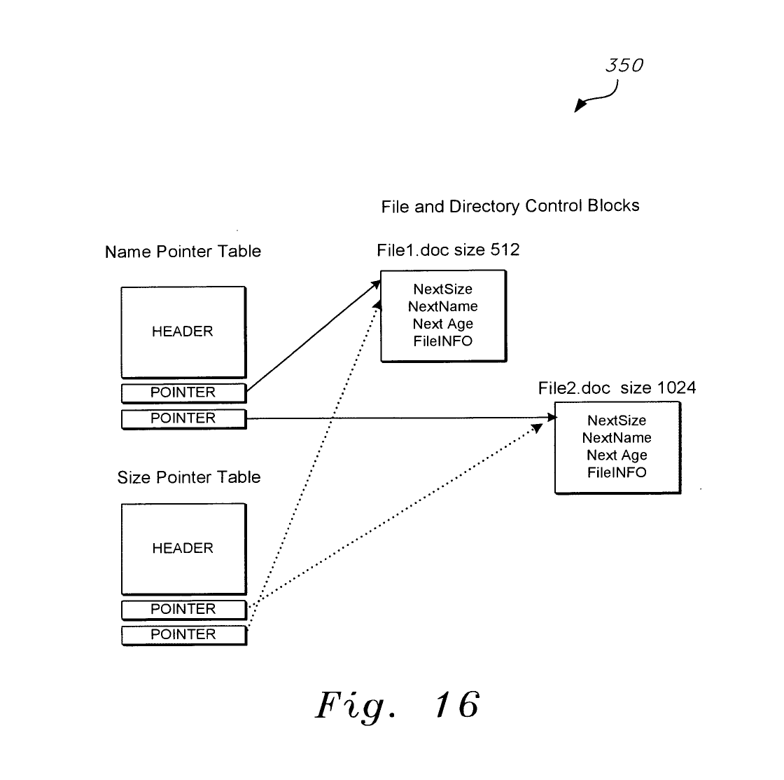

FIG. 17 is an illustration 360 showing how multi-point directory blocks are built to facilitate concurrent multi-point file transfer according to the present invention. The source directory block is built during the buildview process in the FAP. The FAP can also scan any number of target computers during the depth first search. If target or targets are specified the scanning thread also performs directory lookups on all target machines while doing directory lookups on the source machine. As a result for each target machine a mirror directory block is created and is linked to the source directory block. Linked off of each mirror directory block is a list of that target directory.

This information is used by the FAP for several features not found in the prior art. For example, with a list of source and target directory contents, the FAP can make decisions for transmitting changed files to any number of target machines concurrently. The FAP reads a single block of data from the source and writes to all targets concurrently. In the prior art, the file is read repeatedly for each target and is then written to each target. The present invention improves performance by reading data once for any number of target file copies. By linking target and source directories together the FAP has a routine that compares the targets for data that no longer is on the source. Other users might delete a file from their hard drive or storage subsystem, but the file still remains on the destination drive or storage subsystem. This is known as stale backup data according to the current invention. In the prior art, users are not aware of the stale data until when they do a system restore and find out the restore is much larger than the original drive.

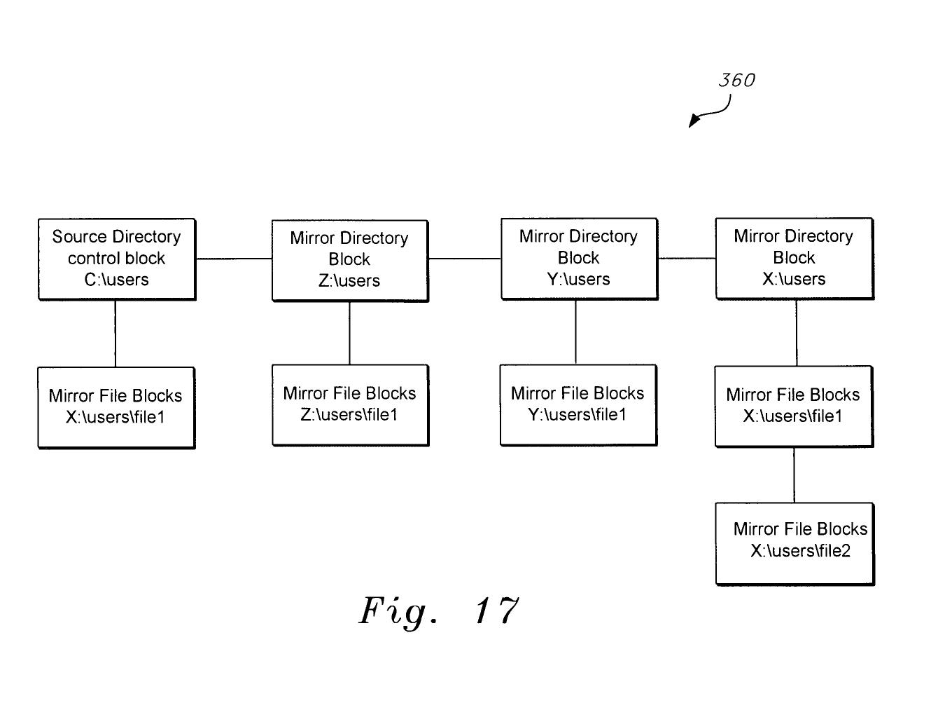

This is illustrated in FIG. 17 where x:\users\file2 is on the target storage device but not on the source. This happens often on computers in the prior art where backup software continues to backup files to a backup media, and they pay no regard to data the user may no longer need and delete from the source drive. The FAP solves this by knowing about stale data, which is data that is on the user's backup but not on their drive. The FAP has several features to deal with this including but not limited to present the user with a popup, have aging parameters the user can select how long to leave it there, provide virtual views in a tree view, and/or combinations thereof. FIG. 18 is a screen shot 370 of the FSIP monitor display showing progress information during concurrent multi-point file transfers. The display shows a single file being copied to ten target machines at the same time.

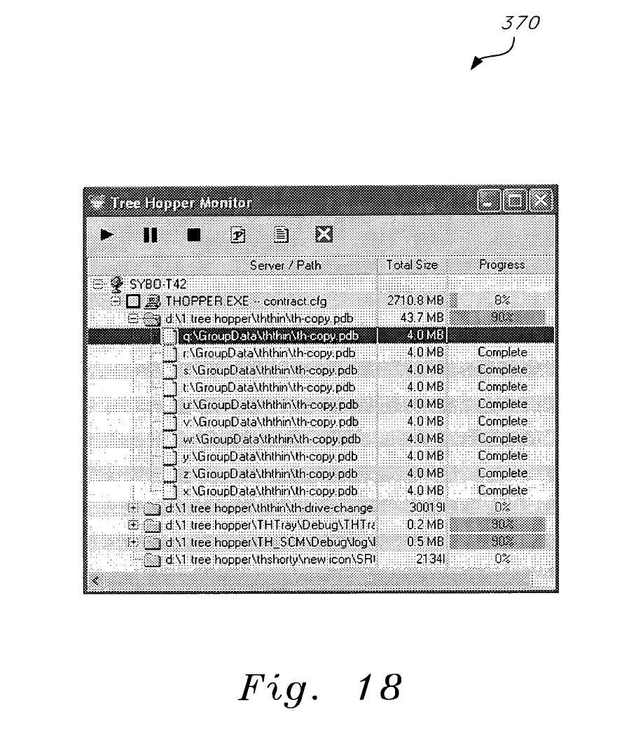

FIG. 19 has a flow chart 380 showing how file system access rights are built in link tables, and a flow chart 390 showing how to summarize these views during the backwards part of the FAP process. Once these permissions are summarized the FAP can query the user and group database and provide a unique view of who has access to what, including actual rights, without wading through a ton of paper using the operation system provided tools like the command dump ACL and windows explorer. In addition, once this summarize and merge is completes the Tree Hopper monitor can provide user and permissions monitoring and management.

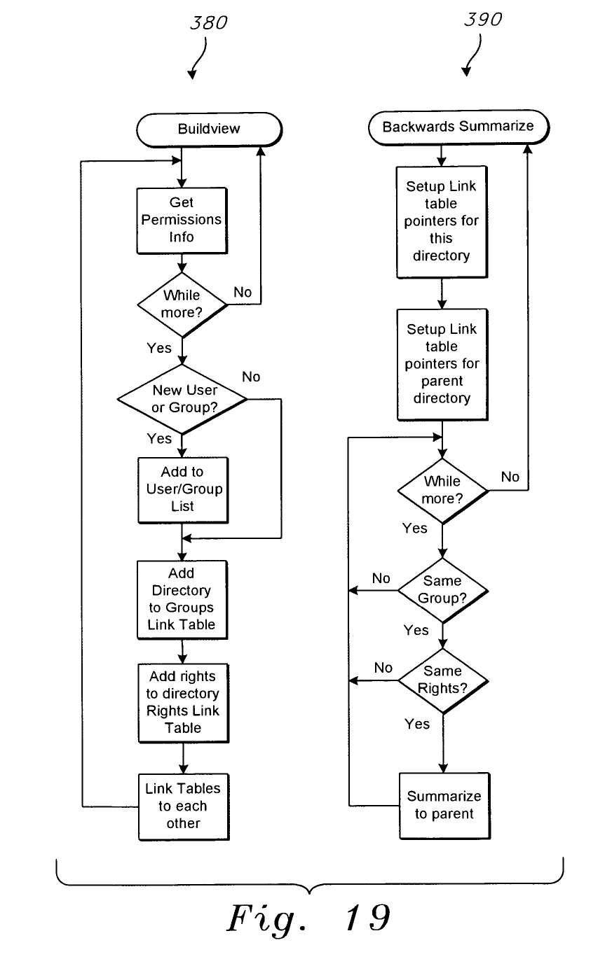

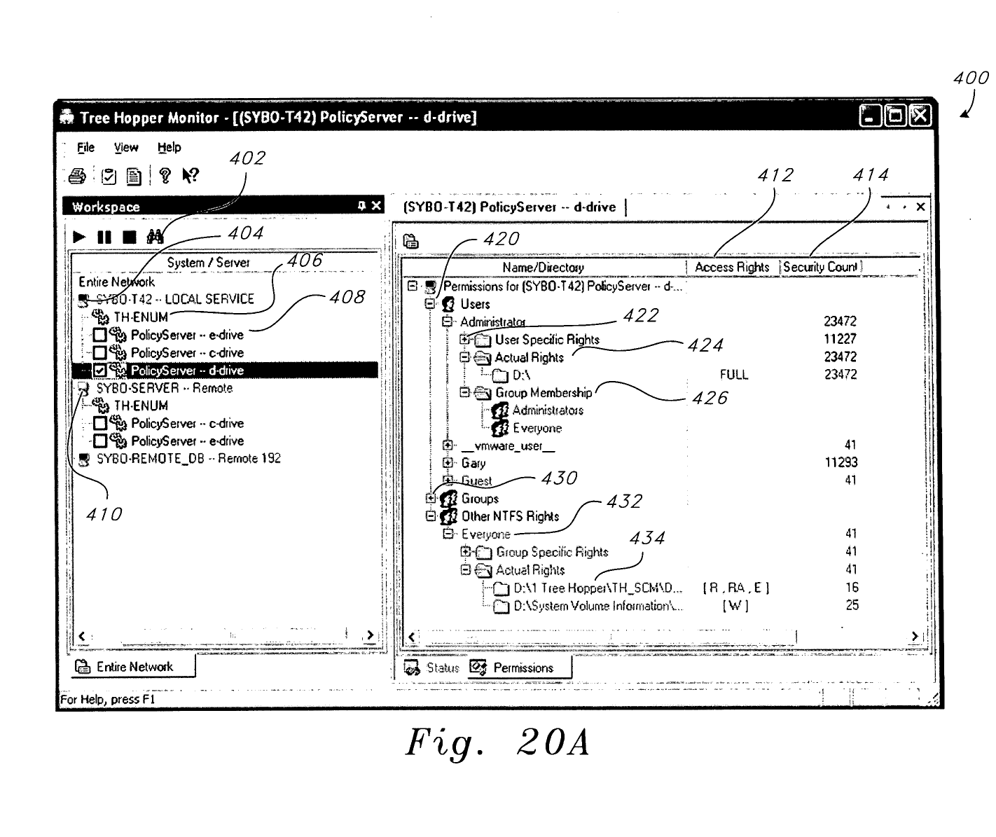

FIG. 20A is a screen shot 400 of a company wide file system security management and monitor. This product provides a much needed function to protect companies from major security vulnerabilities. In addition to the summarization and user/group merge, the monitor can issue a change journal listen request to any FAP and when a security change is made on a system the monitor is alerted immediately to further mitigate data theft and destruction vulnerabilities. When company employees terminate employment or are moved within the company, a mechanism 402 in the form of binoculars is used to find and modify permissions for those employees. On the same line as the mechanism 402 are other controls used to interact with Service Managers and Service Processors. The administrator can use the binoculars to get a list of users and groups, or to type in a user name. This can cause a query to all File Access Processors, the local user directory on a system, and a directory services system to obtain information on any user including their group membership. In the prior art the administrator would have to go to each system and run an operating system command such as dump ACL and manually filter through it.

Service Managers 404 and 410 are securely attached to each other. Under the Service Managers 404 and 410 are Service Processors including a System Access Processor 406 and a File Access Processor 408, where in the right hand window a sample of a file system permissions monitor is displayed. The file system permissions are summarized and then merged with users and groups that are obtained by system calls to the system being displayed and the directory services system, if one is in place. Users 420 and Groups 430 show the users and group trees for the D drive on the system SYBO-T42. Listed under can be all users and groups respectively. User specific rights 422 and actual rights 424 are for the user administrator, and the group membership 426 is for the administrator. Actual rights 424 are calculated by the FSIP to determine the actual rights a user or group has based on user specific rights and the group membership rights to which the user is assigned. Also included in the files system scan and on the display is the group Everyone 432 and the actual rights directory 434 for the group Everyone 432. The Access Rights 412 is for all entities and the Security Count 414 is for all entities. FIG. 20B is a screen shot 435 of the display from a permissions search when the binoculars 402 are depressed. The result shows all the systems and permissions the user GARY has access to on all connected systems, specifically the SYBO-T42 404 and the SYBO-SERVER 410 in this simple example. In the prior art the user and group information is easily available and displayable, but the complete system and company wide, the actual files permissions for these users and groups, is not available in the prior art. Also in the prior art, one could use operating system tools to display effective rights for a user or group, but there are several display screens and key inputs, and it works only on one directory at a time. In the current invention the Actual Rights 424 is a novel approach to provide a holistic view of Actual Rights for all users and groups for an entire file system or a multiplicity of file systems. This is novel because in the prior art it only worked with a single user or group for a single object on a single system, and it was cumbersome doing that. With FSIP, a company can easily get a single company wide view of Actual Rights in a single display automatically, for all users, groups, file systems, on any number of systems. The permissions monitor provides a single place to manage company wide data security.

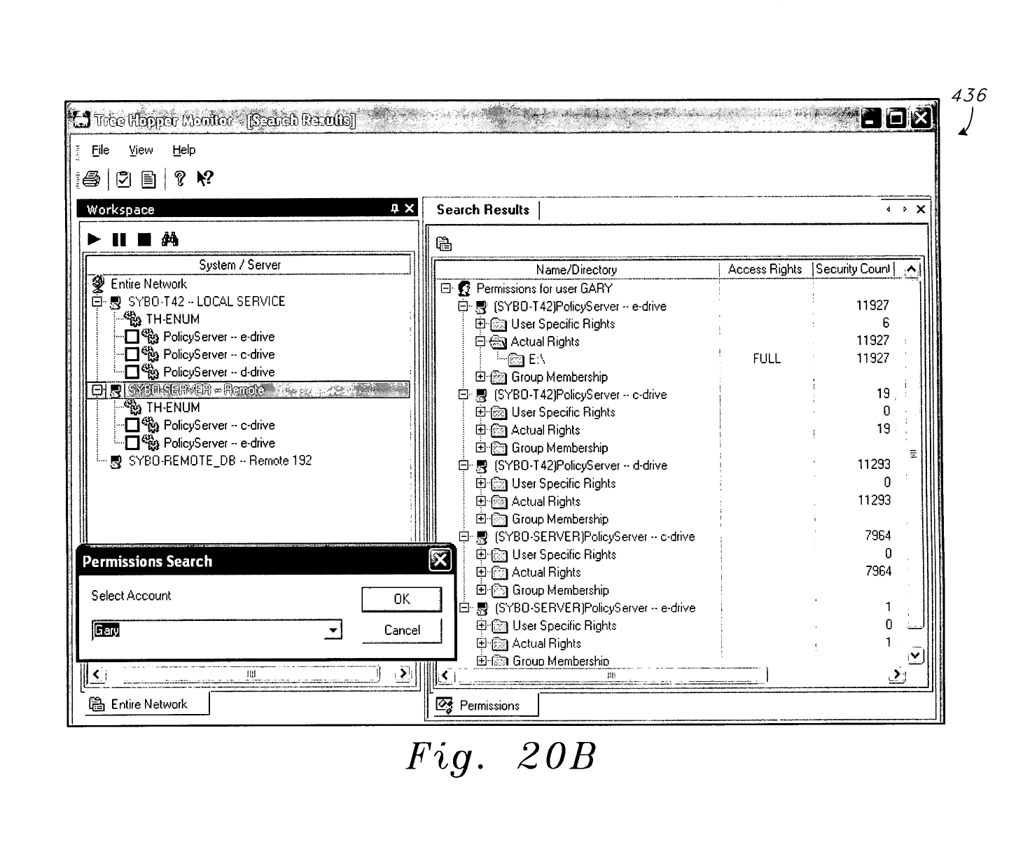

FIG. 21 is an illustration 440 showing how security alerts are passed by each service manager and gathered by the file system security monitor to alert companies or users of the file system permission changes that could make their systems vulnerable. FIG. 22 is a screen shot 450 of the monitor showing the file system change journal. In this example the monitor is displaying file system security changes to the c:\medical records folder on SYBO-SERVER. This alert is presented when the security change is made. By monitoring the file system change journal the FAP can alert security professionals immediately when systems' security settings are changed. In the monitor's permissions screen, the user can see what the security change is and counter any potential vulnerabilities immediately. This is not available in the prior art. As described earlier, in the prior art administrators are limited to run dump ACL type of commands that are human intensive and hard to understand, and is error prone. A security change like this could go months or even years without being noticed in some organizations.

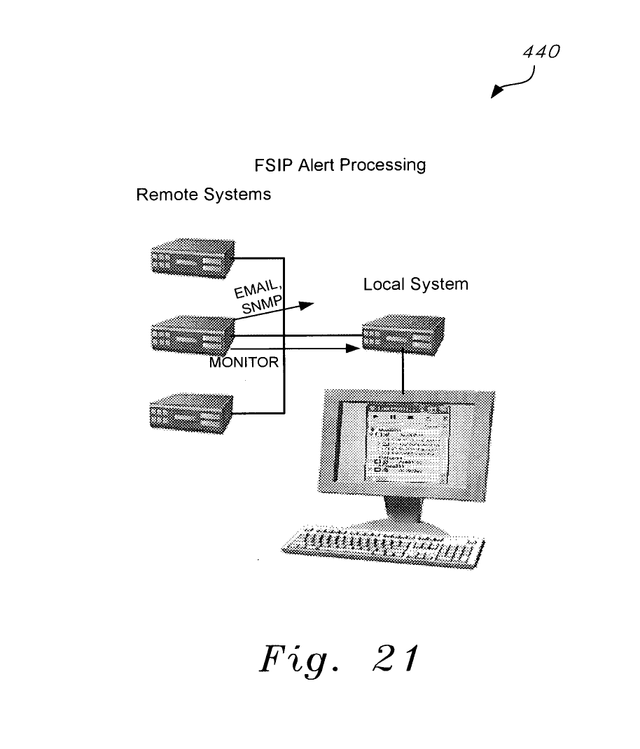

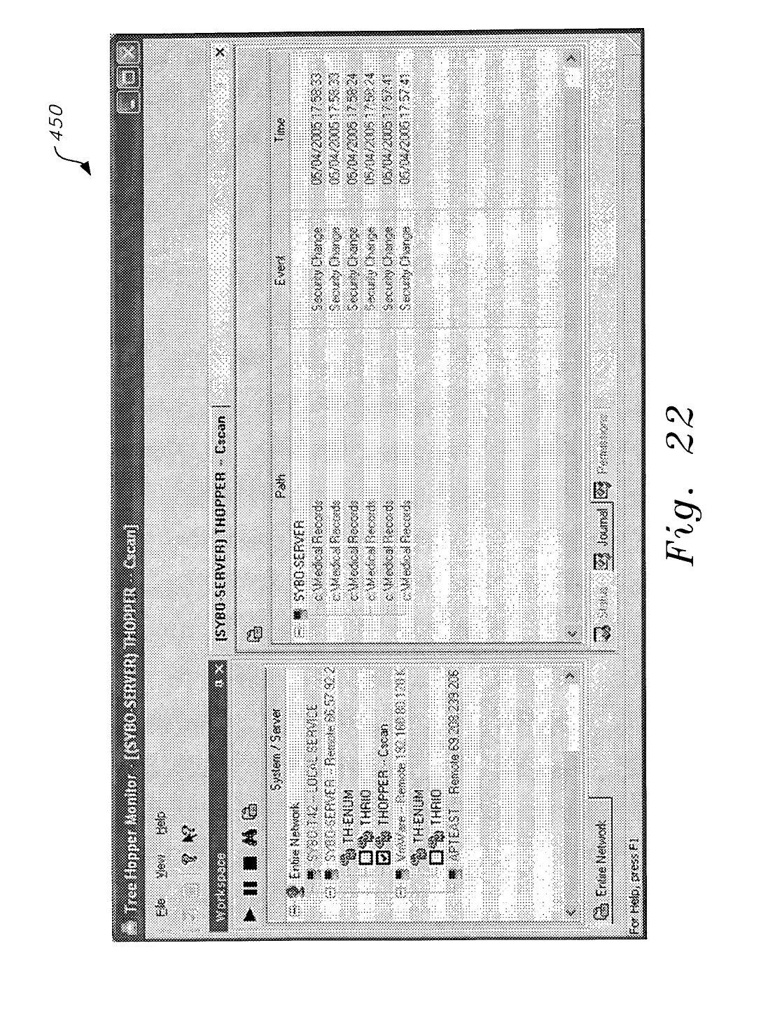

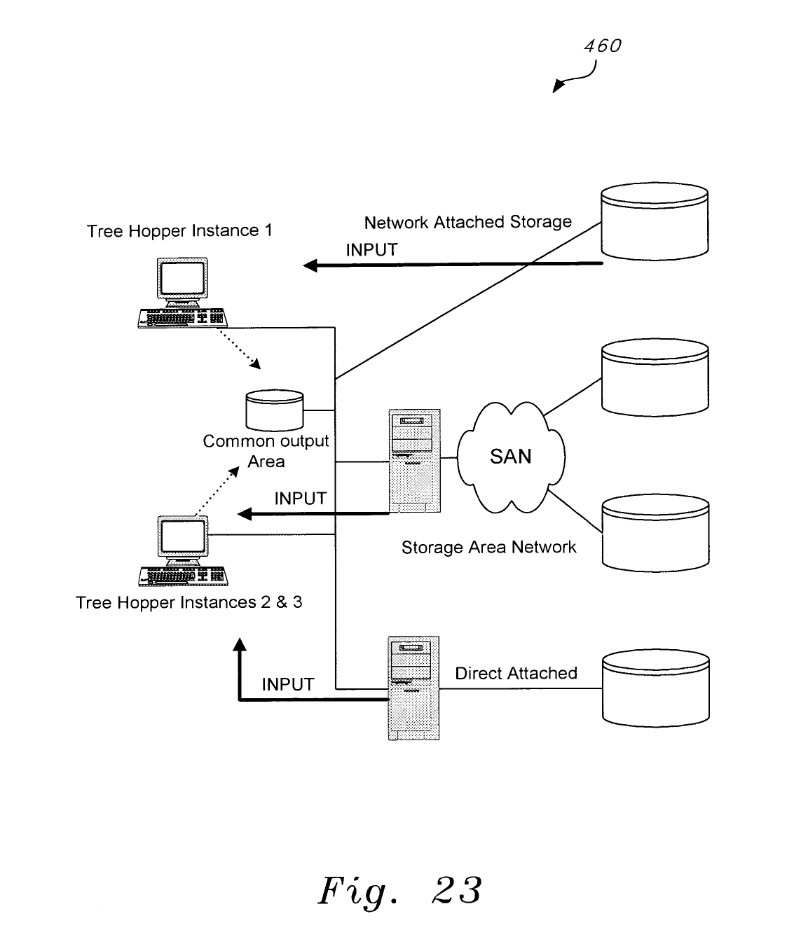

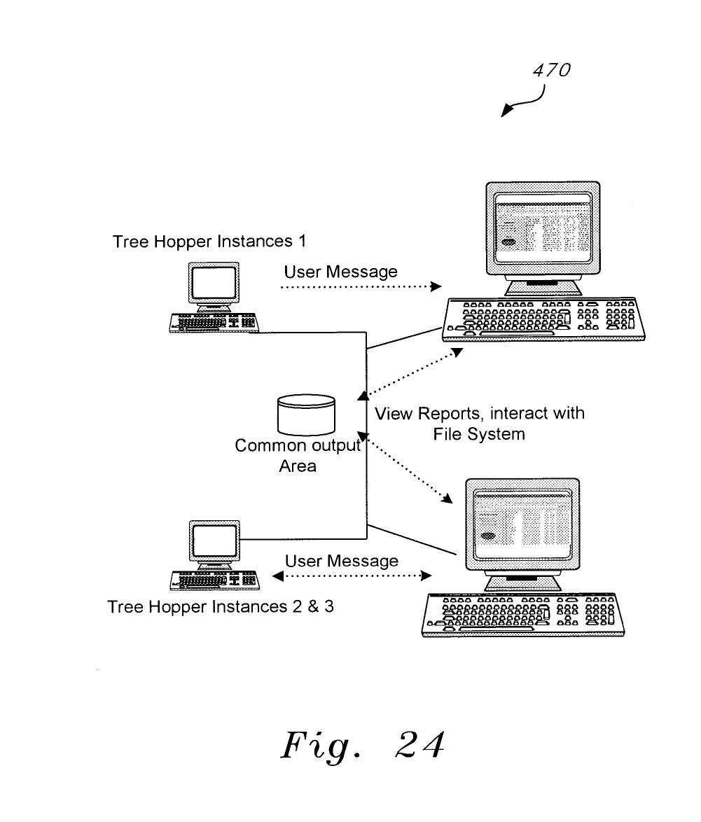

FIG. 23 is an illustration 460 showing how storage and security reports are stored centrally. By storing reports centrally in an HTML format, web pointers can be sent to the owners. FIG. 24 is an illustration 470 of the FSIP processor sending messages to storage owners or users so they can view and interact with the file system using a windows or web based interface. The Tree Hopper explorer provides useful easy to use extensions to assist in the cleansing of storage by the owner. The Tree Hopper Explorer has JAVA so it can also run in a web browser and can be sent as an applet during the storage audit process. There are storage analysis products in the prior art. These products are designed for use by a storage administrator only. They have no way to break down reports per user and email a useful cleansing tool so users can correct storage misuse and save companies large dollar amounts in wasted storage.

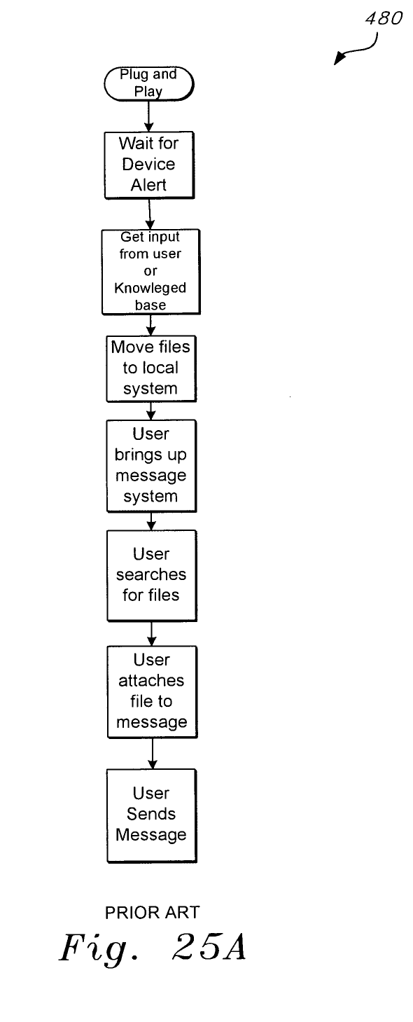

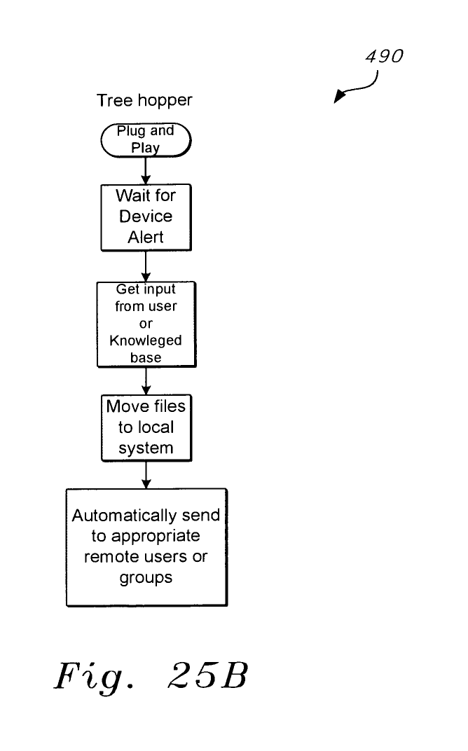

FIG. 25A is a flow chart illustration 480 of the automatic transmitting of plug and play files (e.g., removable media files) according to the prior art. FIG. 25B is a flow chart illustration 490 of the automatic transmitting of plug and play files according to the present invention. FIG. 26 is a screen shot 500 of the Tree Hopper Explorer. Please note the plus signs and minus signs next to the files in the right side window. When a user clicks on the plus sign of a file it displays virtual files, which can be in a user or administered defined color. Different colors can be used for different types of virtual files. This is a significant feature over the prior art. When the file Gary-Boat.JPG is selected, a list of backup, revisions, snapshots, or other copies are displayed. These are virtual files of the original file and can reside anywhere, but are displayed with the original file. The prior art has mechanisms for mapping of drives or folders that have copies in it. Some manufactures allow for users to right click the file, select properties, and then go thru other screens to find revisions, or snapshots, and finally restore them. The prior art approach is not intuitive. Nowhere in the prior art is the backup, revision, snapshot or other copy so easy for the user to view, load or restore, as in the FSIP. In the prior art the user has to spend time to understand how to search for his/her snapshot, revision or backup. When the Tree Hopper Explorer does a list file to the FAP to retrieve file and folder information, the FAP sends an indicator with all the file and folder information if virtual files are present. Then Tree Hopper Explorer can issue THAPI commands to the FAP to either automatically retrieve and display virtual files, or put an indicator, like a plus sign, next to the original file indicating virtual files. The FAP can retrieve mirror directory and file blocks for virtual files, or issue commands to the file system, and return it so the user sees it under the view where the original file is and not requiring them to go to other sections, windows or programs.

FIG. 27 is a Tree Hopper Explorer screen shot 510 showing the age file view of files. Since the FAP has control block information stored in link tables based on age, the user can specify any age value they want, and the response is instantaneous. Then, with the migration tools, the user can migrate aged data to other medias, and the Tree Hopper Explorer will create a shortcut to the middleware to manage restore of the file if the user wants to retrieve it. This is done without a central database repository which is a novelty of the present invention. In the prior art migration requires a central database with knowledge of where the file is moved. The present invention uses shortcuts that store the commands to middleware in the shortcut with the location of the migrated file. Now the user sees the file where it is, and when clicking on it, the file is restored by middleware software running on the local computer, not a server and database like the prior art. This flexibility brings high end storage management to organization and personal computer use.

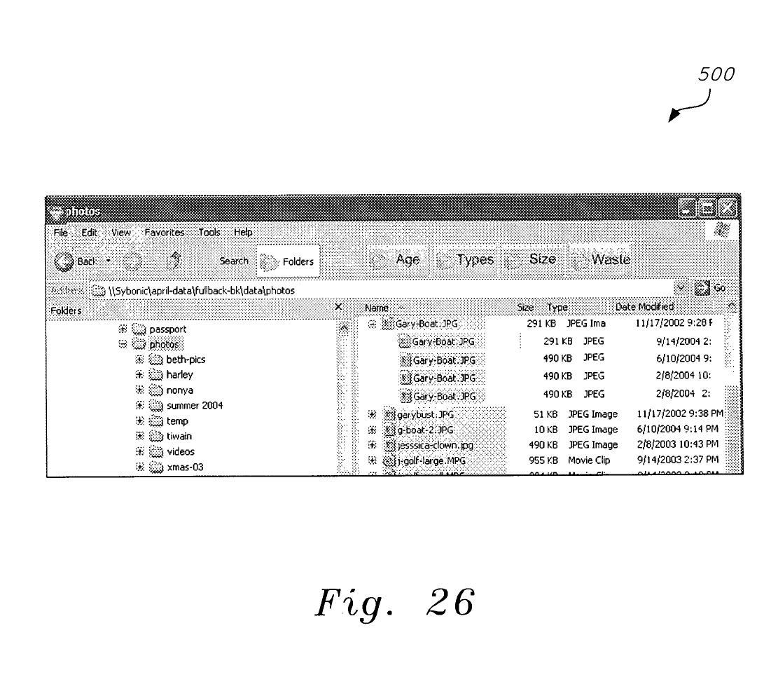

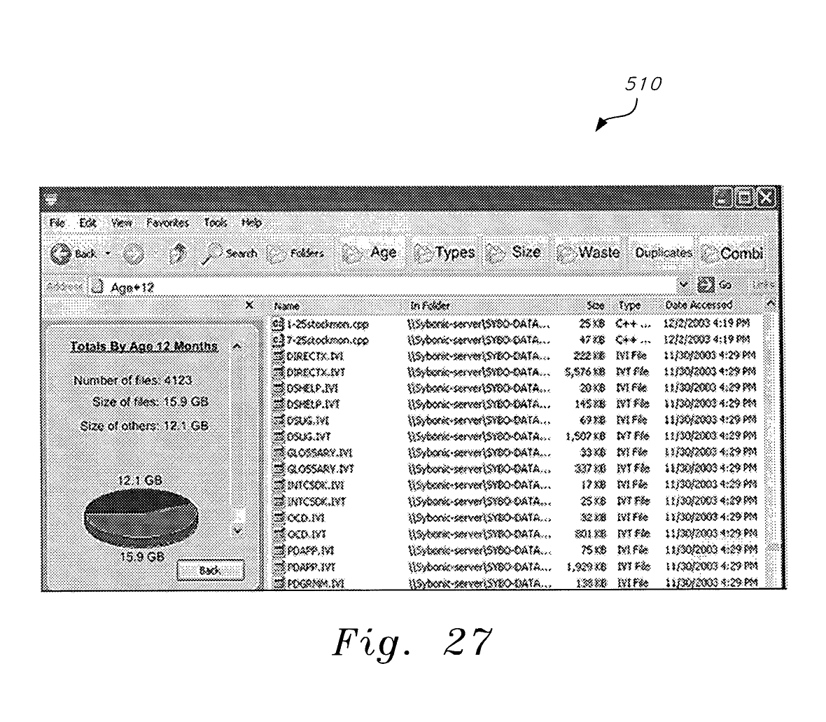

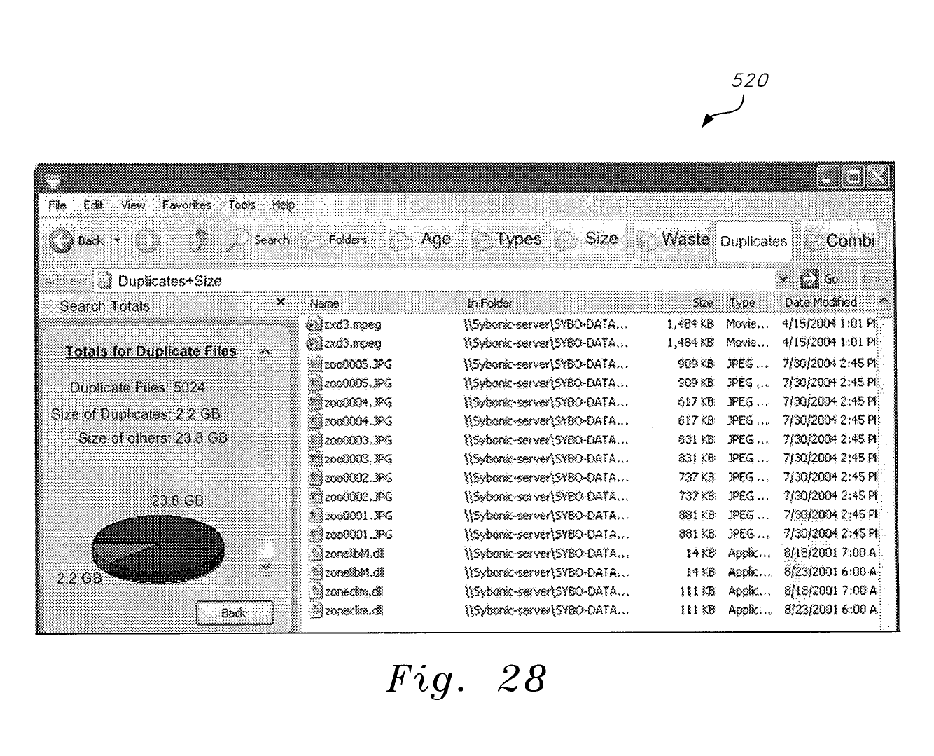

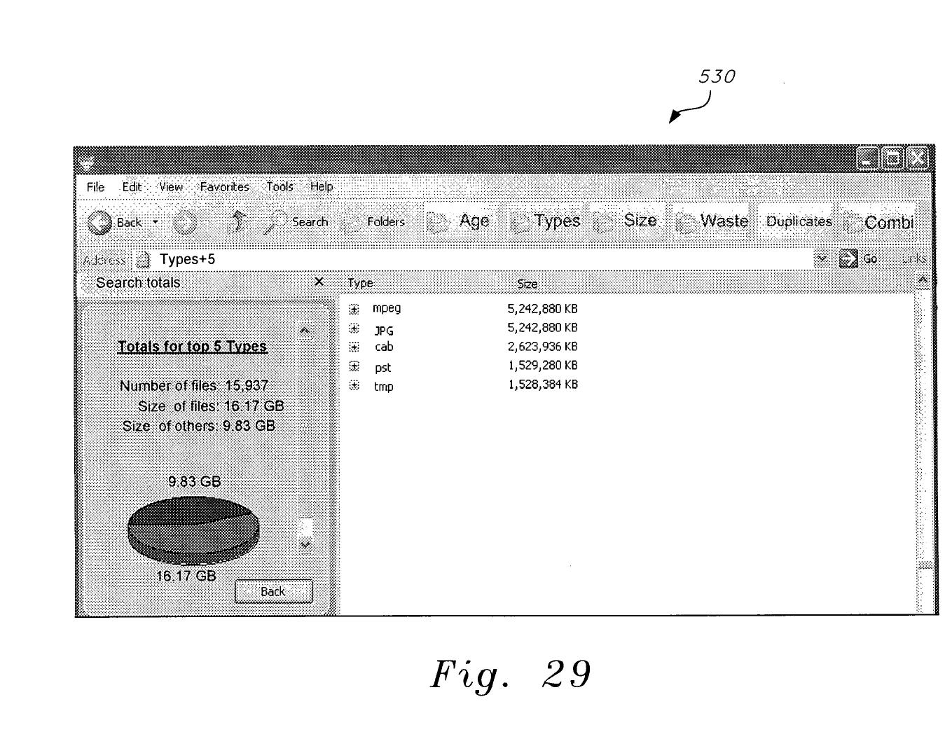

FIG. 28 is another Tree Hopper Explorer screen shot 520 showing a duplicate file view. Duplicate files are stored in a link table pointing to the same file and directory blocks as all the other FAP features. With the shortcut feature the users can have all instances point to a single copy, delete unnecessary copies, and/or migrate them. FIG. 29 is a Tree Hopper Explorer screen shot 530 showing a view by file extension. Again the explorer can issue FSIP commands to the FAP component of the FSIP and receive instantaneous responses because of link tables. FIG. 30 is a Tree Hopper Explorer screen shot 540 showing a list of files by size. Wouldn't it be nice to have an instantaneous view of the largest files on a system or subsystem to assist in cleansing? In the prior art one can issue several commands to search and then sort by size, but it is slow and many users may not know how to do it. Probably not surprising is that this view is also a link table pointing to the same data structure as all the other link tables.

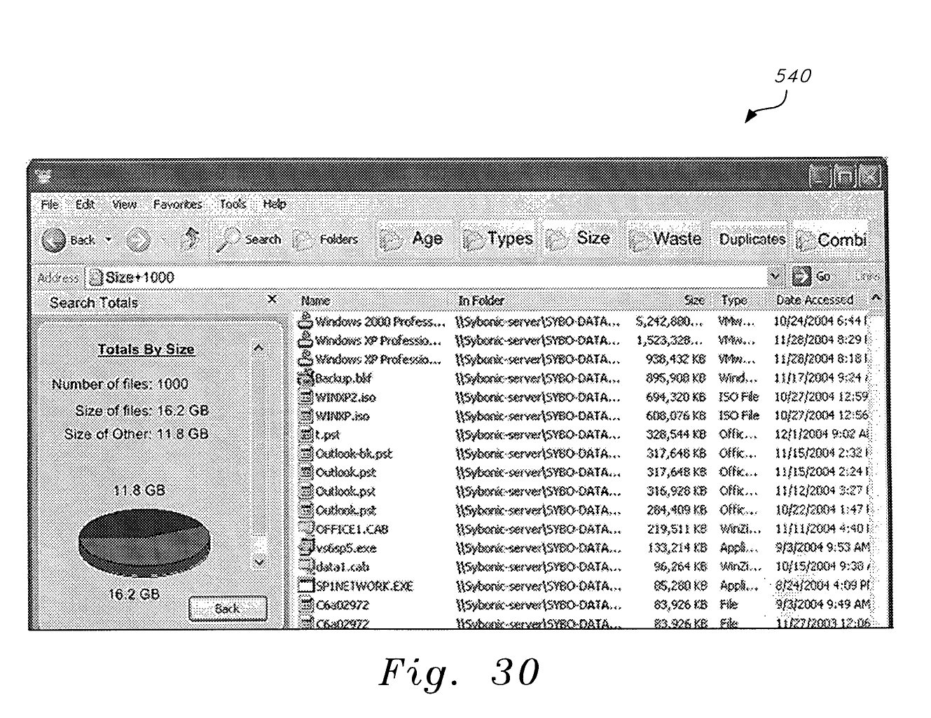

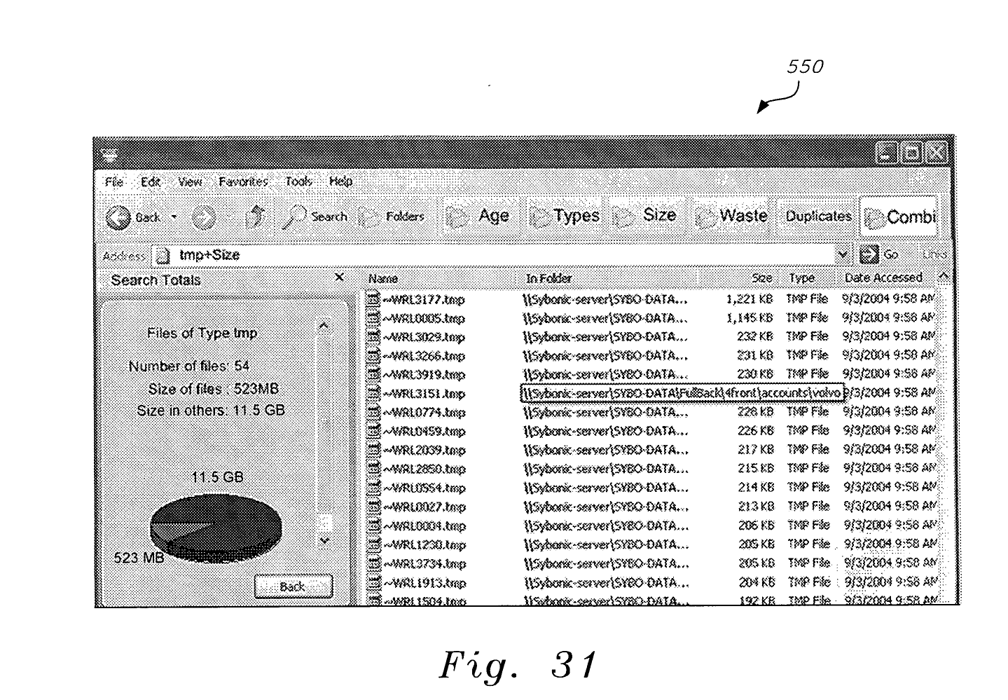

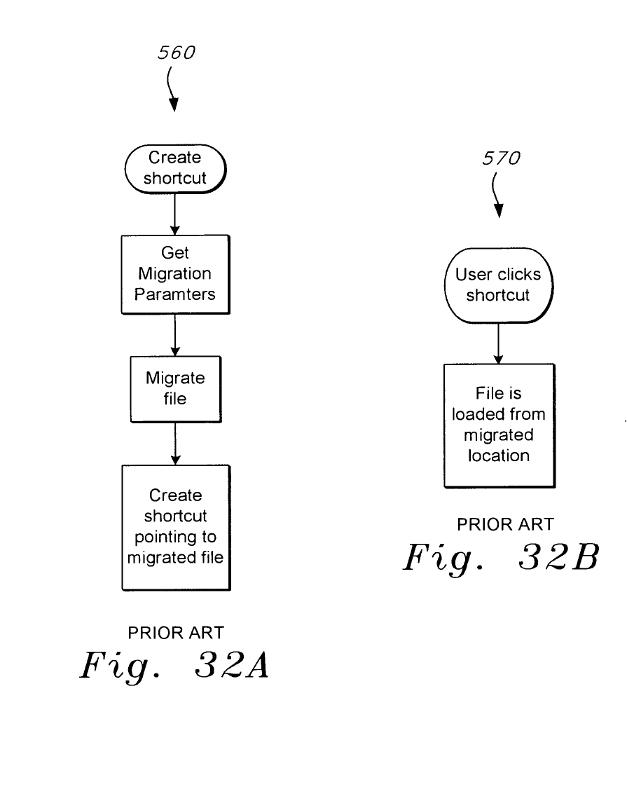

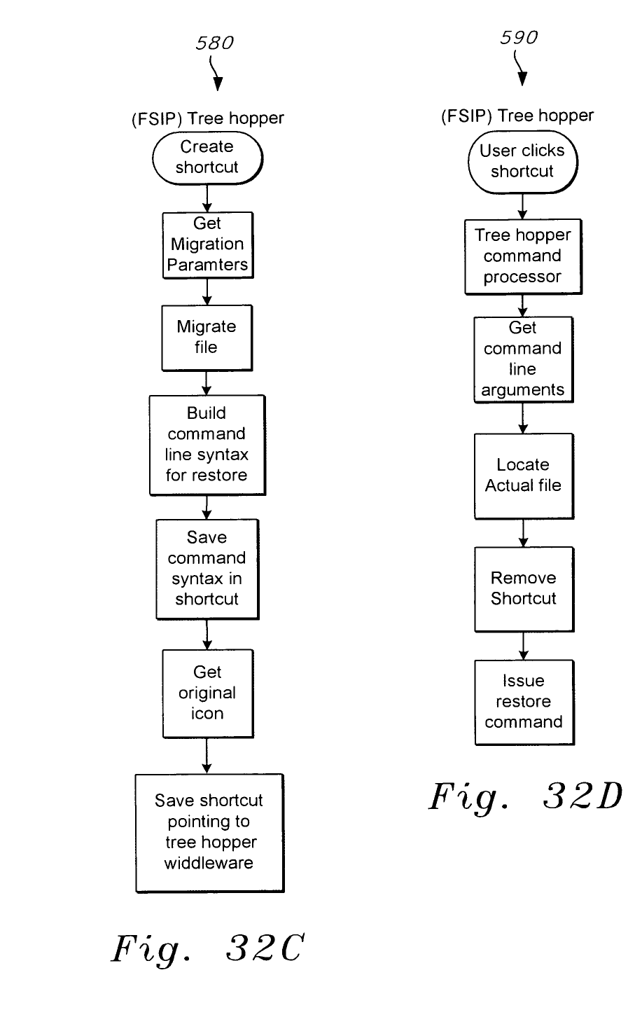

FIG. 31 is another Tree Hopper Explorer screen shot 550 showing a specified file type of search and display. Users can quickly and easily view a list of files by file extension without a rescan of the file system. The Tree Hopper Explorer can also display directory sizes. In the prior art one can click on properties, then wait while the directory is scanned. To summarize the Tree Hopper Explorer user interface combined with the other FSIP components provides unique features for single users and large scale data centers alike. FIG. 32A is a flow chart 560 of shortcut creation according to the prior art. This flow chart 560 shows that after a file is migrated to an alternate location, a simple shortcut is created pointing to the new location of the file. FIG. 32B is a flow chart 570 according to the prior art when a user clicks on the shortcut. This flow chart 570 illustrates how the file loaded from the location pointed by the shortcut.

FIG. 32C is a flow chart 580 that shows the FSIP method of creating a shortcut. The FSIP can lookup user defined migration parameters or prompt the user for them. The file is then migrated to the alternate location. Unlike the prior art, this location can be on any media anywhere on the network. For example, if a company uses a table backup system, the FSIP can issue the commands to that system. The prior art requires that the file is reachable either locally or on a network share drive. After the FSIP migrates the file a shortcut is created pointing the shortcut, not to the file, but to the FSIP middleware command with the location of the file, restore command and/or any additional parameters required to restore the file.

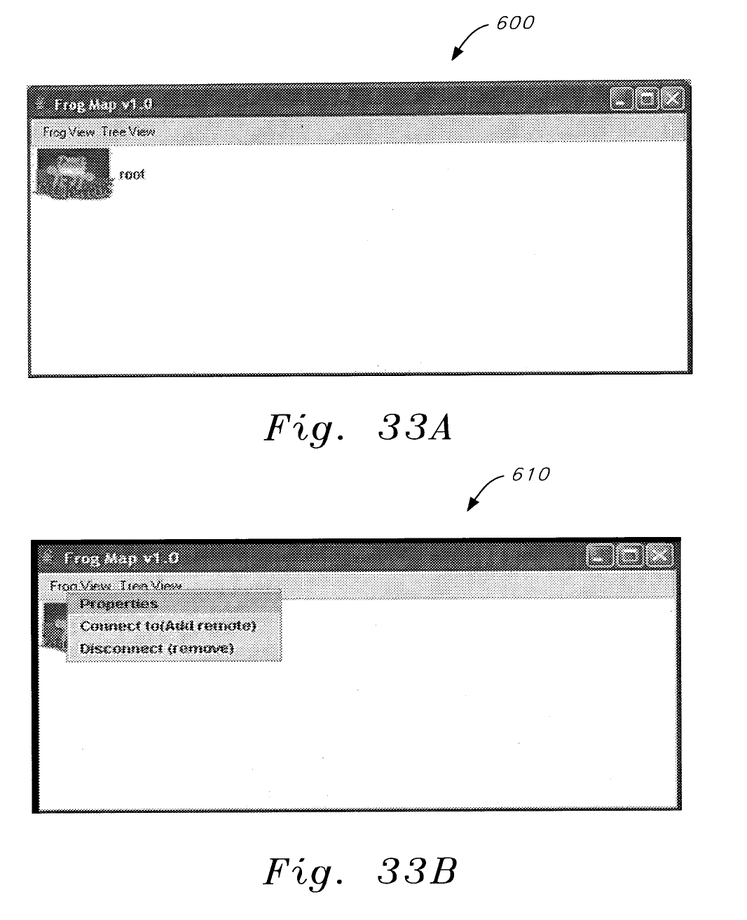

FIG. 32D is a flow chart 590 of the process the FSIP does when a user clicks the shortcut to the file. For the FSIP, unlike the prior art, the shortcut points to an FSIP command with a group of parameter syntax that will delete the shortcut, and restore the file from any backup system anywhere on the network. In summary, the features illustrated in FIGS. 32C and 32D provide much needed archival functions for companies and end users alike. FIGS. 33A and 33B are screen shots 600 and 610 of the Tree Hopper Remote Access Manager, illustrating a user connecting to or disconnecting from another instance of an FSIP anywhere on a network or the internet according to the present invention.

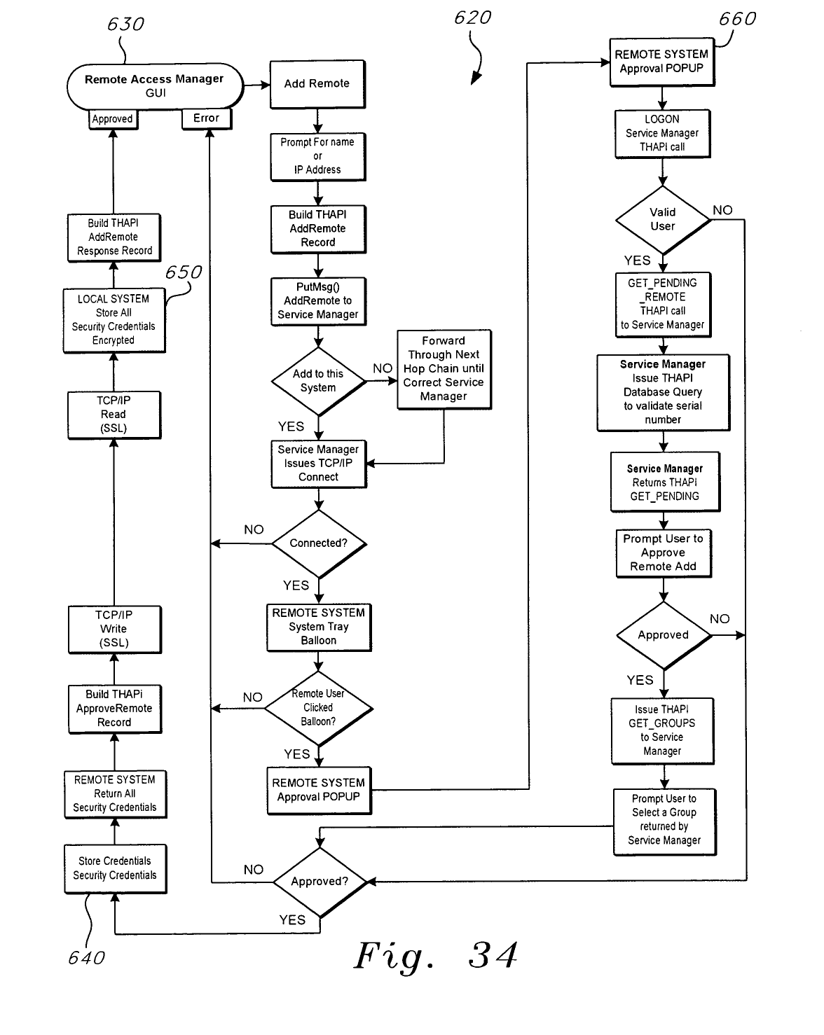

FIG. 34 is a flow chart 620 showing the process the Remote Access Manager graphical user interface can go through to connect any number of FSIP instances together according to the present invention. When a user selects Add Remote, the Remote Access Manager can perform the functions shown the in the flow chart. Initially, a remote user at a computer issues a command to effect a connection with the Remote Access Manager 630. The remote user can perform functions 660 to approve the connection. Security credentials can be stored 640 for the user that added the remote access, and can be stored in an encrypted format on the system that added the remote access 650.

In the prior art, systems can be connected and users can gain access by mechanism in both the local system, or a central database designed to manage user accounts and access rights. The problem with the prior art approach is general users do not know how to administer users and groups either centrally or on their local system. The novel approach in the FSIP is the Service Manager can add, remove, and/or modify user accounts, groups and/or passwords without user intervention. This approach is called “self generating account information” in the present invention. The value to this approach is general users with minimal computer administration skill can take advantage of all the remote access features in the FSIP system, and be assured those connections are secure so would be hackers cannot have unauthorized access to their system. The users of the FSIP can also use the prior art methods that are included in the operating system if they choose.

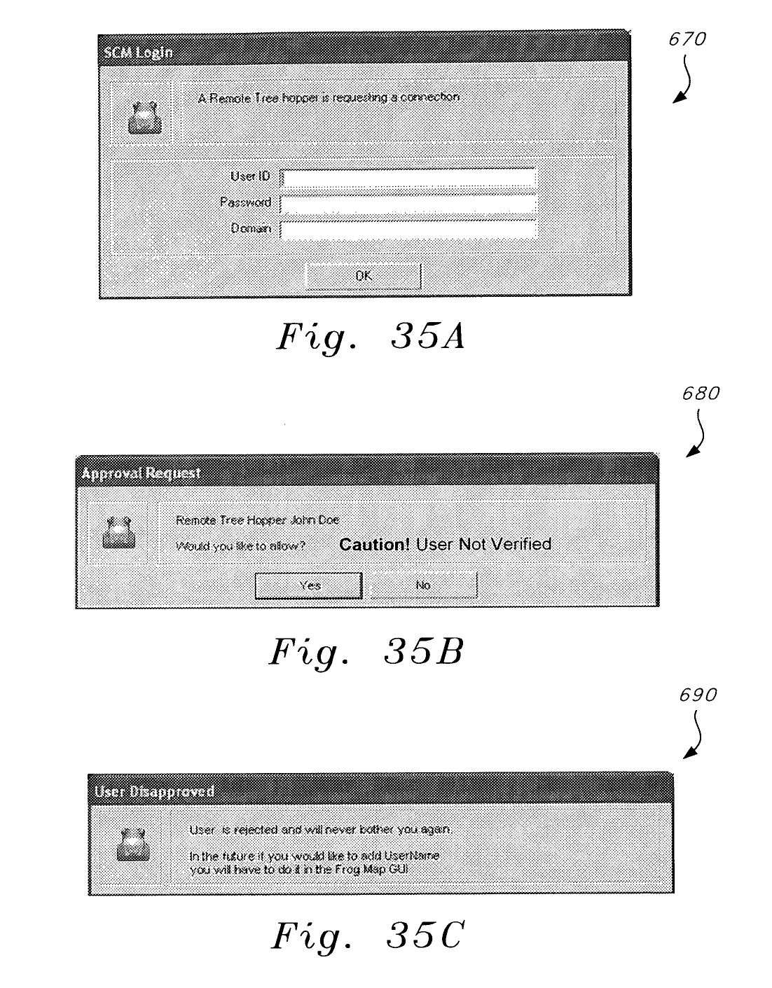

FIG. 35A is a screen shot 670 showing the Service Manager logon popup screen. This is the first part of the approval process for adding a remote connection. The user needs to log on to the Service Manager to add remote functions and to insure access rights. This prohibits a would be hacker from adding themselves as a remote access on a user's computer when the user walks away from their computer and leaves their computer logged on to the FSIP.

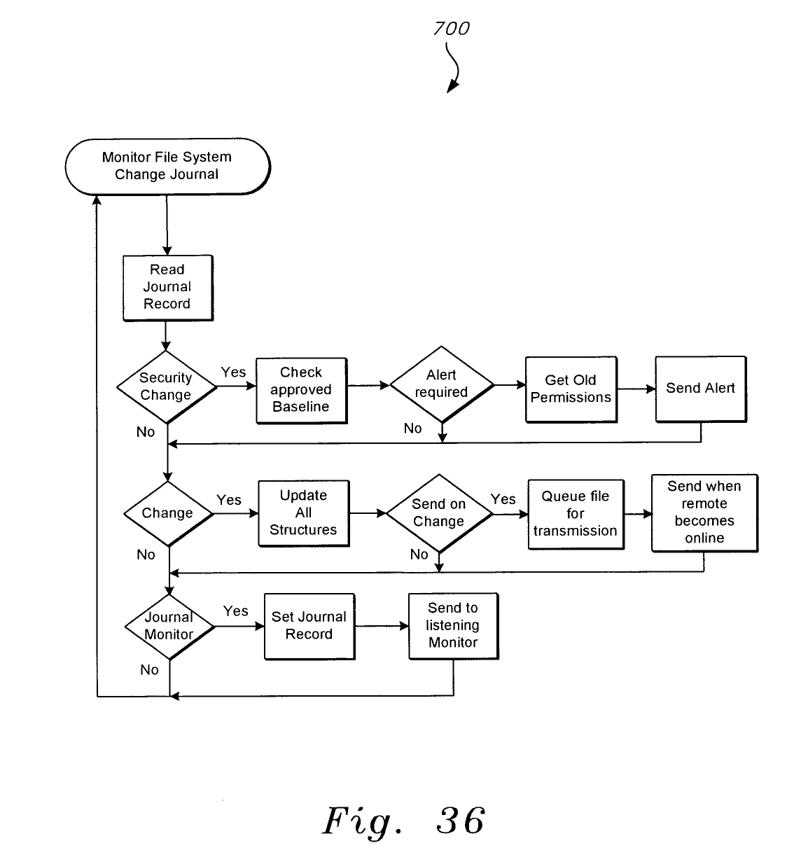

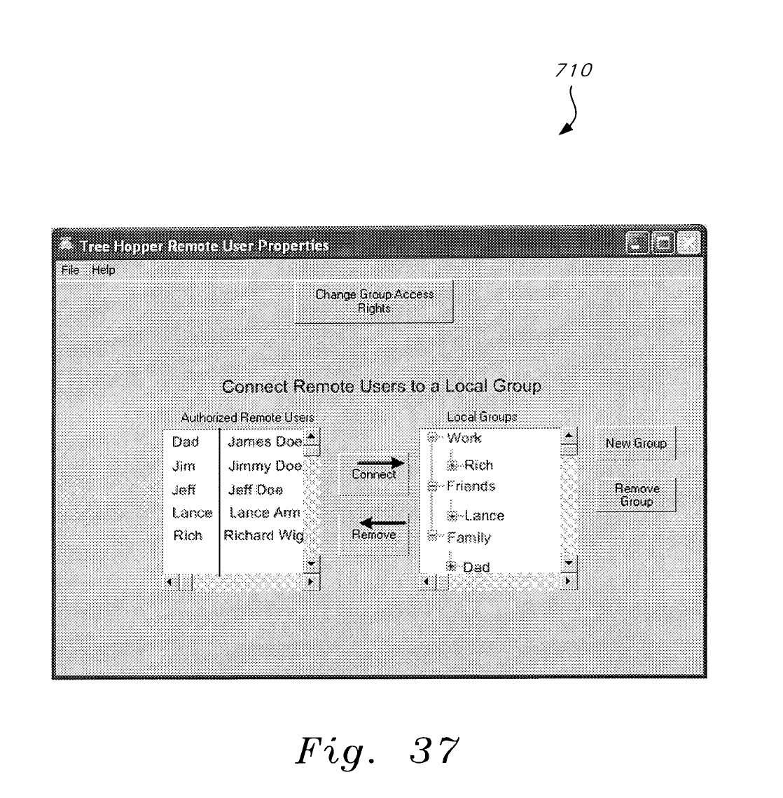

FIG. 35B is a screen shot 680 showing an approval request for a connection from another system that issued an add Remote Access. The Service Manager with no intervention from the user issues a THAPI database query to a database that has serial number registration information. This query identifies the user that performed the add Remote Access. In the example screen shot 680 the user is cautioned because the THAPI database query could not identify the system that issued the Add Remote Access. Otherwise a message will appear indicating that the user has been verified. FIG. 35C is a screen shot 690 showing a Remote Access add has been disapproved by the user. These are just a few sample screen shots a user goes through in the approval process. There are other menus where users can select user, group and access privileges for remote FSIP instances. FIG. 36 is a flow chart 700 illustration of managing file system changes to alert users of security changes, update internal structures, automatically transmit changed files, and/or send journal change records to journal monitors.

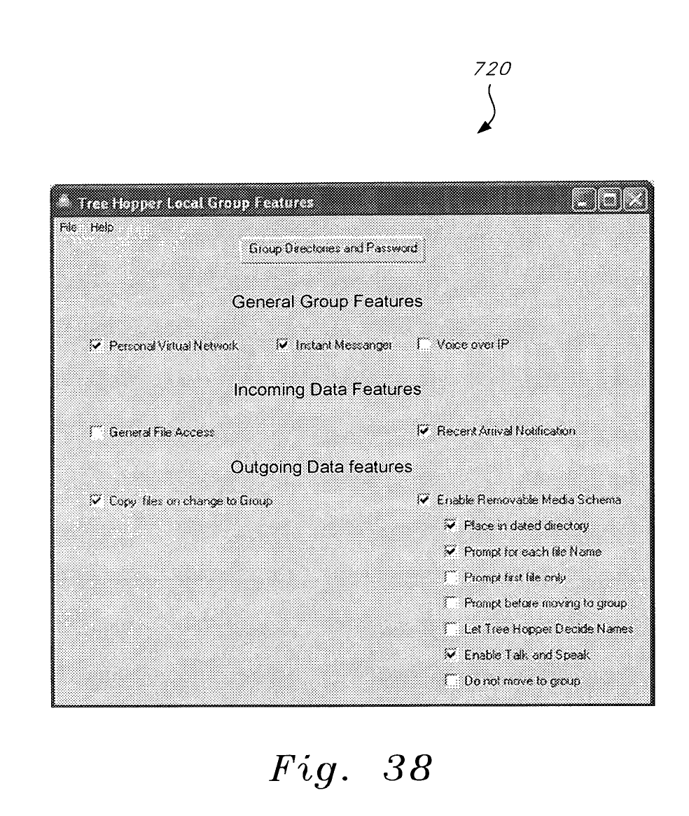

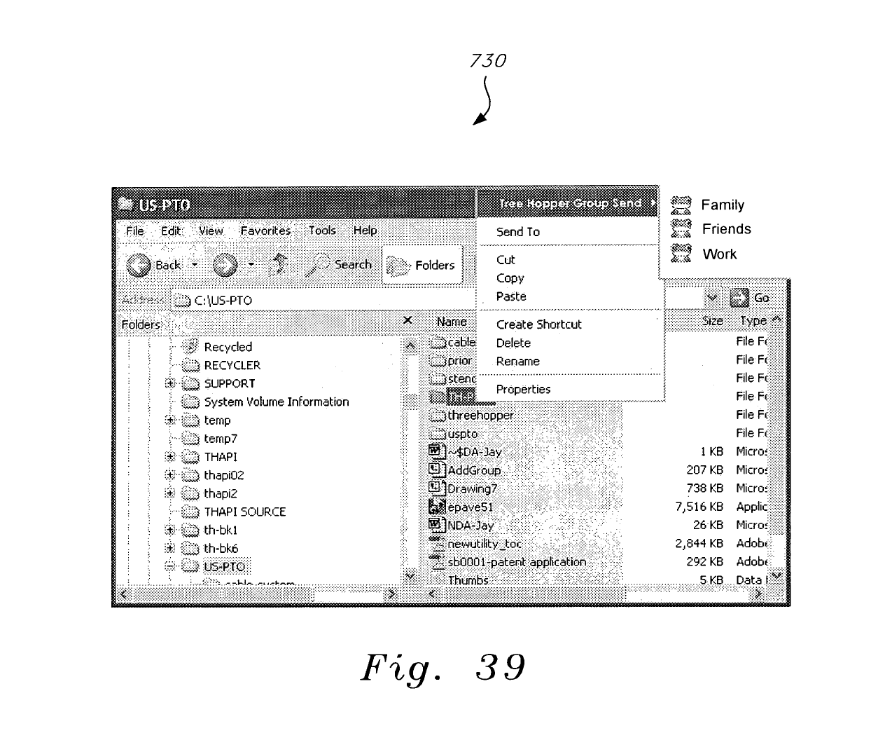

FIG. 37 is a screen shot 710 showing the properties menu for remote users. Remote users can be added to or removed from local groups. There is also a button where group access rights can be assigned. FIG. 38 is a screen shot 720 of the local group feature menus. This allows a user to select group access rights. There is also a button where directories and passwords can be selected. FIG. 39 is a screen shot 730 of a Tree Hopper plug-in that a user can use with Windows Explorer to manually transfer files to a user or group. In the prior art there are plug ins that allow a user to send files via a messaging system, but in that case it would then be attached to a message, and the user needs to send it as an attachment. At the other side the user needs to go to the messaging to view and/or save the file. The novel approach in the FSIP system bypasses all those steps. This novel approach automates data exchange versus the prior art and is further illustrated in FIG. 25A and FIG. 25B.

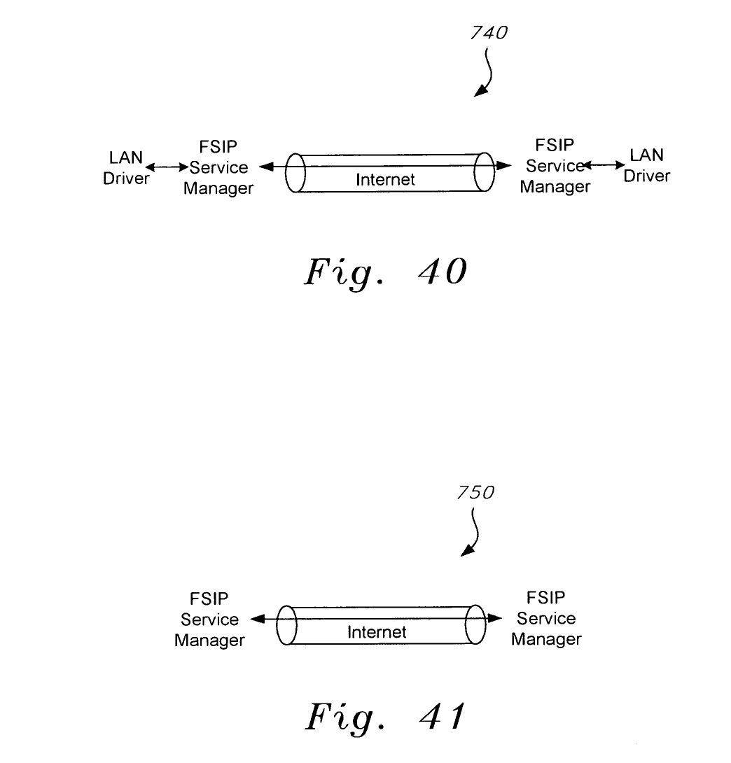

FIG. 40 is a flow diagram 740 of a personal private network feature. In the prior art Virtual Private networks can connect remote users to other systems. The problem with that approach is const and administration. General users cannot take advantage of those capabilities. The FSIP approach can use a System Access Processor (SAP) to emulate a LAN and provide a LAN to LAN connection over an authorized FSIP connection. This is known as a Personal Virtual Network and requires no special hardware or complex administration.

FIG. 41 is a flow diagram 750 of a personal voice and video over the FSIP. In the prior art there are systems for doing voice and video over IP. These systems require specialized hardware and software. The FSIP can utilize a SAP to do session initiation protocol (SIP), h323, or other industry standard protocols, and tunnel them between FSIP instances. The value to the user is if they have a voice over IP system as a residential service, they can access this service from anywhere they are on the internet.

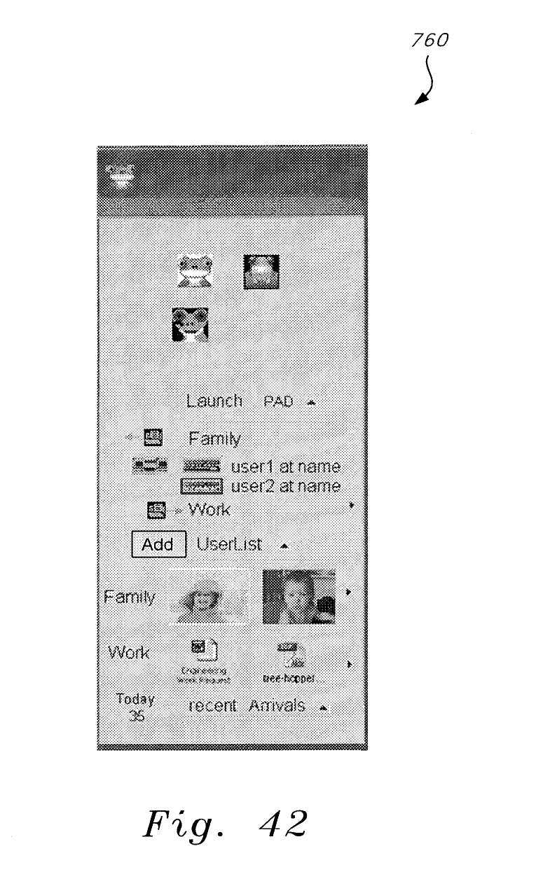

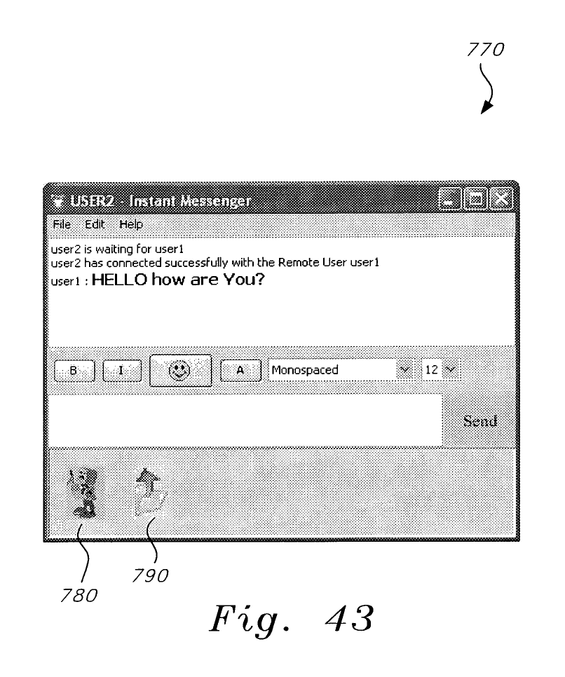

FIG. 42 is a screen shot 760 of the user collaboration interface. This has many novel features versus the prior art. In the prior art, users can send files via messaging systems, but as previously described requires several steps and can be confusing for less skilled users. The novel approach in the FSIP is files can arrive automatically from a number of FSIP features. This Graphical Interface can display thumbnails, icons or other information or recent arrivals. As an example, a user in group family takes some photos of their children. They connect the camera to a computer. The FSIP plug and play interface gets alerted from the operating system, and the FSIP follows the configuration parameters from that user that could include automatically transferring to a local hard drive and automatically sending to the family group. The FSIP would automatically signal this GUI and the thumbnails of those photos could be displayed under recent arrivals on the group family with minimal or no intervention by anyone. This GUI uses animation icons called anicons in the present invention. The anicons can illustrate any number of things including files are arriving, files are leaving, user(s) are connecting, user(s) are disconnecting, user(s) are typing, and other types of activities.

FIG. 43 is a screen shot 770 of the instant messenger with user activity alert icons 780 and 790, known as animation cons or anicons in the present invention. The prior art shows a user typing a message in the status area of the instant message window. The FSIP instant messenger animates icons or anicons 780 and 790 when activities occur and are not limited to when user typing occurs. When files are arriving from a group an anicon 780 or 790 can be displayed, or other types of activities can also display an anicon 780 or 790. Another unique feature of the FSIP instant messaging is automatic file transfer. The prior art messenger allows for one to manually send files, but none offer a system like the FSIP to automatically send and receive files. Also the FSIP Secure Messenger supports both instant and email messages not found in the prior art.

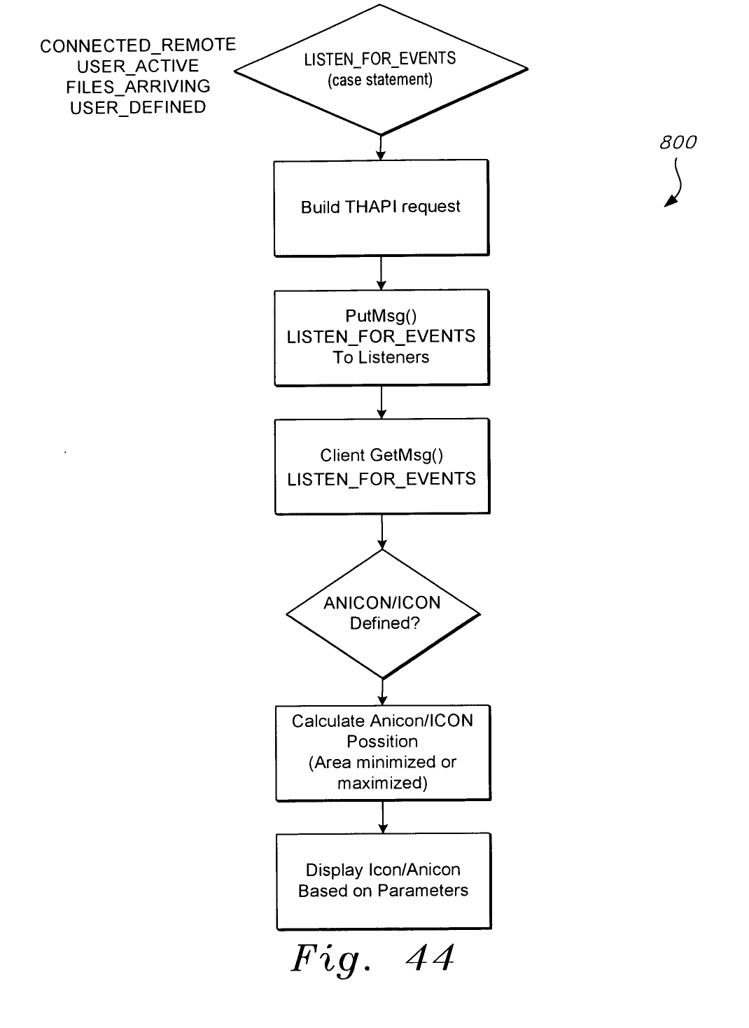

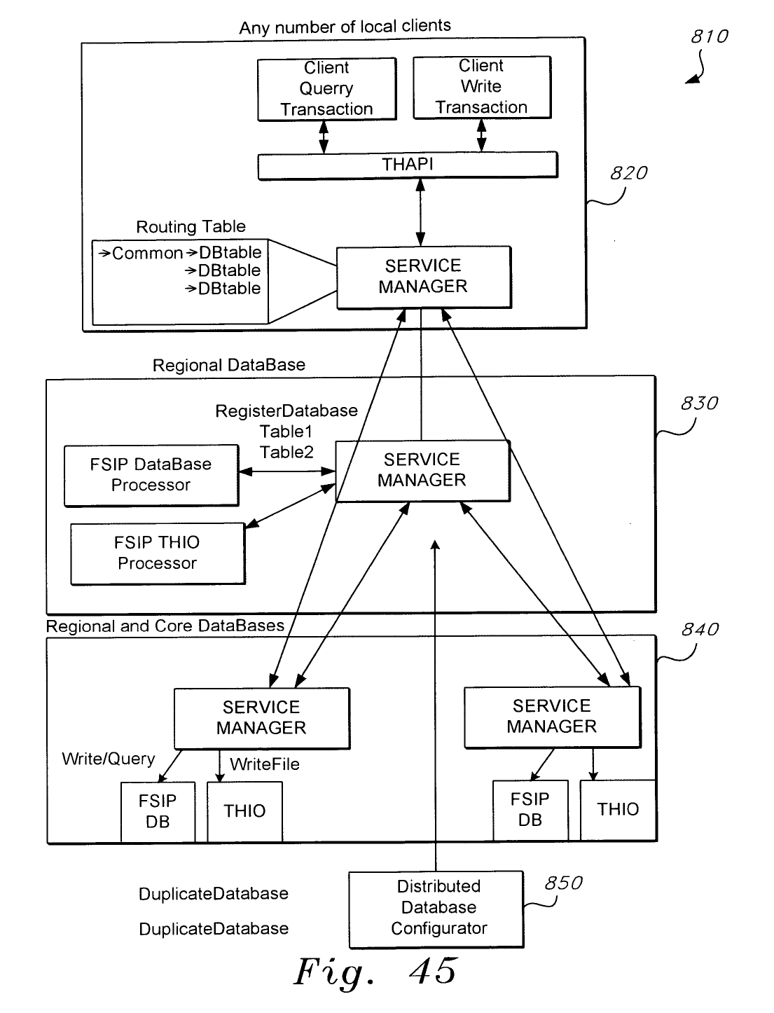

FIG. 44 is a flow chart 800 showing how events can be registered and listened for with the Service Manager. This feature allows for multiple applications, such as the Collaboration GUI and the instant messenger GUI to get alerts when remote users are doing things. FIG. 45 is an illustration 810 of the tiered relationship of client systems 820, regional database systems 830, central database systems 840, and the central administrator 850 running the database management software. With the FSIP distributed database features any number of users known as client systems 820 in this figure will have database table routing entries and the Service Manager on that system can log and send transactions to regional databases 830 and/or to a central database 840. A sophisticated guaranteed delivery mechanism is located in the Service Manager to insure database constancy across any number of distributed systems. In the prior art, database systems themselves can synchronize distributed databases, and central storage devices can synchronize databases. In the present invention, database synchronization can be the responsibility of the FSIP Service Managers residing on the client systems 820, the regional systems 830, and/or the central databases 840.

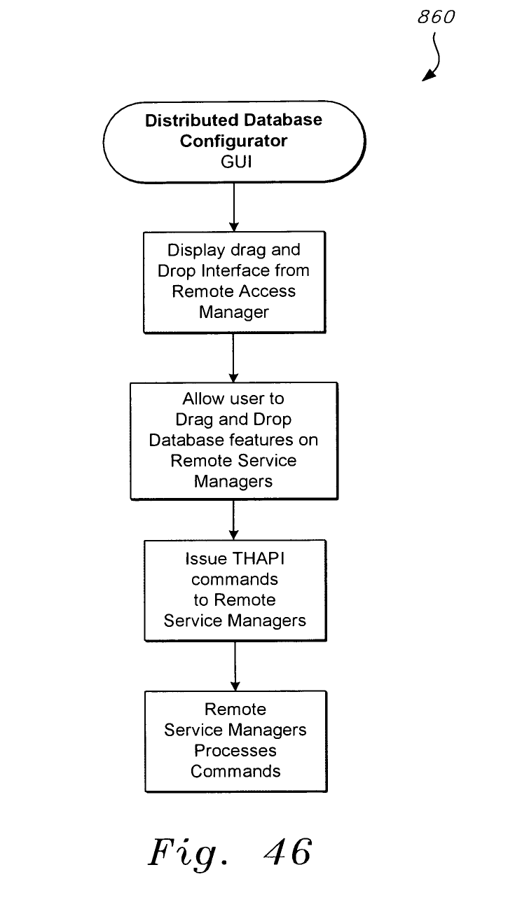

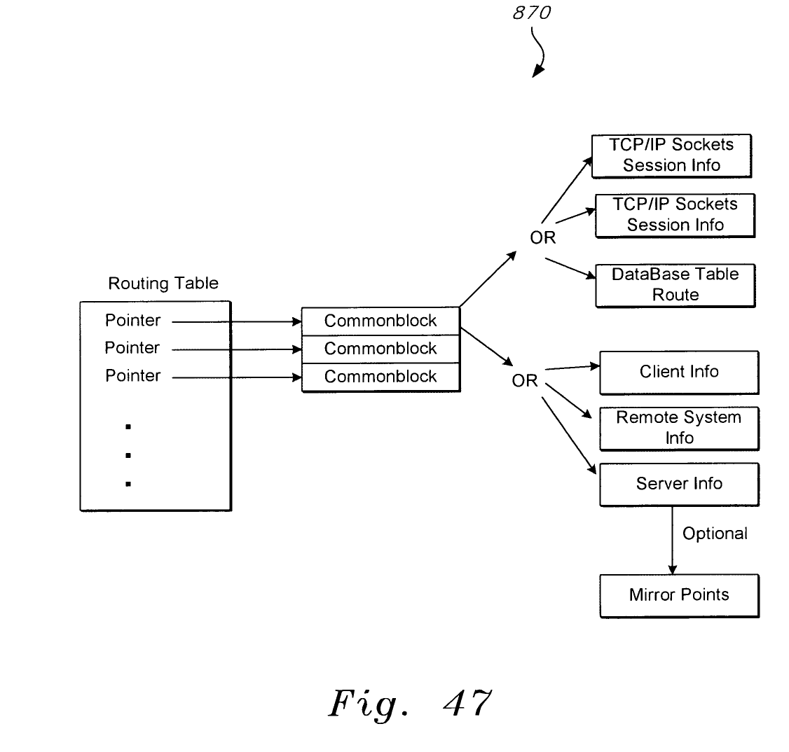

FIG. 46 is a simple flow chart 860 showing some of the high level steps the Distributed Database Configuration graphical user interface can take to initiate communications using THAPI to communicate to distributed databases. FIG. 47 is an illustration 870 of the routing tables that Service Managers can use for routing anything to anywhere including, but not limited to System Alerts, Monitor requests, remote and local Input/Output, Voice, Video, Personal Virtual Networks, database transaction routing, etc. The Service Manager has a flexible routing table that has a pointer to a common control block. This common control block can point to any type of routing entry. This example shows TCP/IP, PIPES, and database Tables, but can be expanded to include other types of routes. The common control block includes pointers to other types of information.

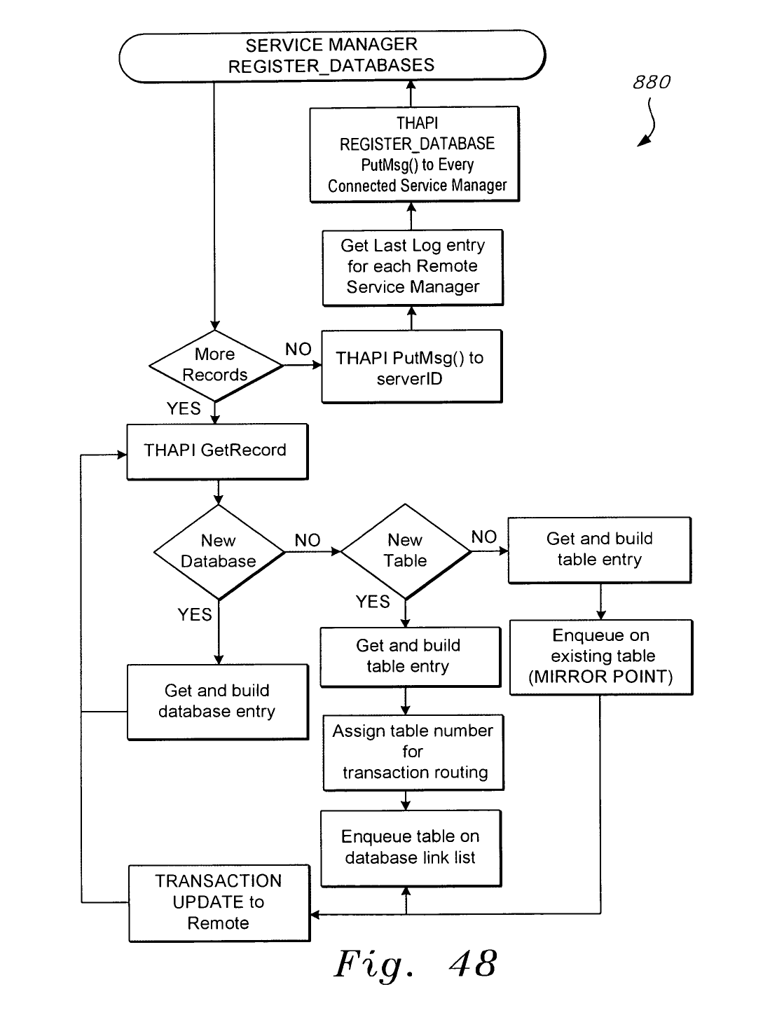

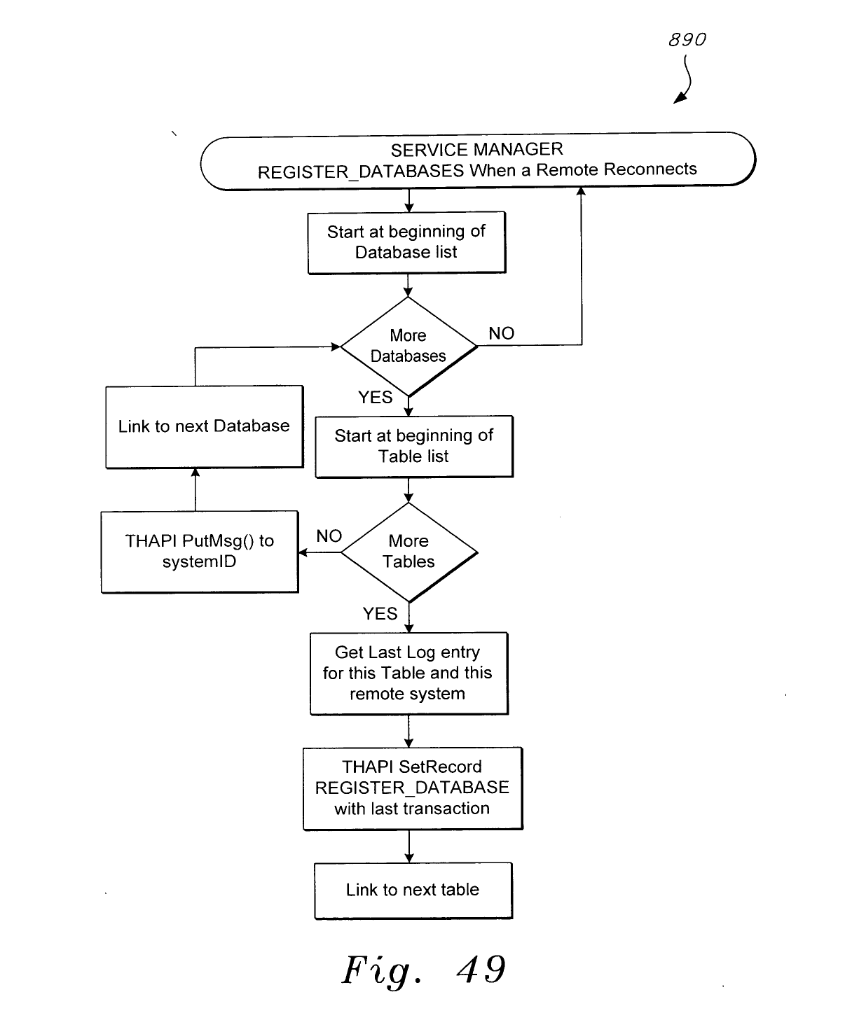

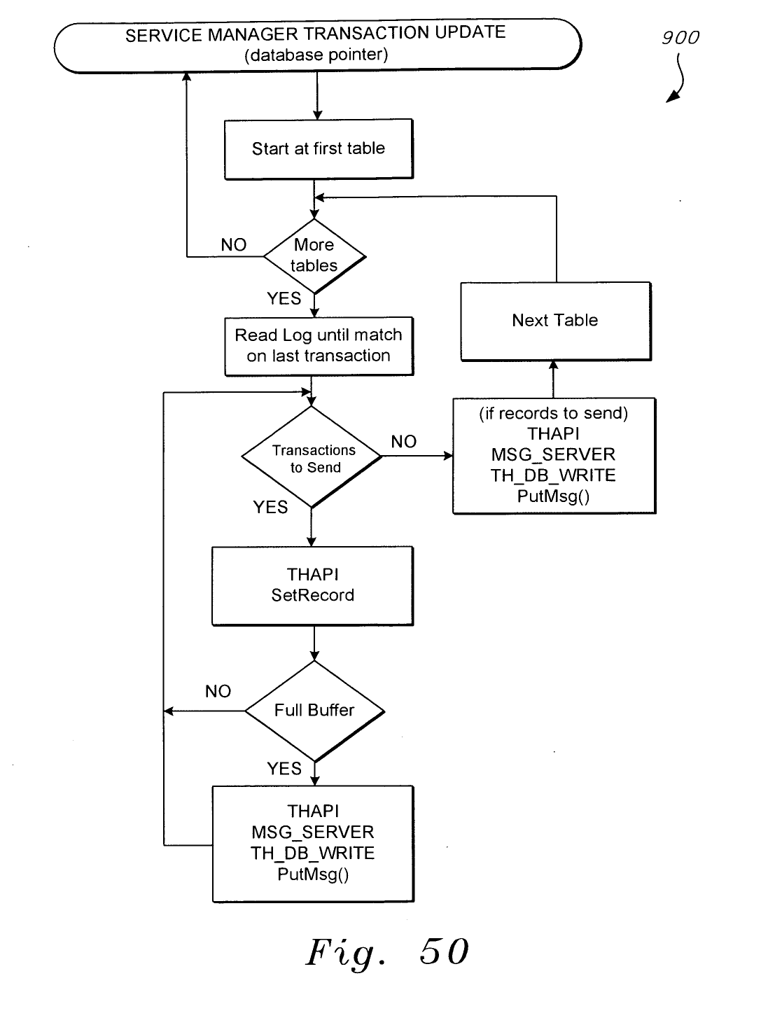

FIG. 48 is a flow diagram 880 showing some of the steps how a FSIP database access processor can register with the local Service Manager and how the Service Manager propagates its presence to all Service Managers in the database service group. These other Service Managers can then send transactions to synchronize the database that came online. FIG. 49 is a flow chart 890 showing some of the steps illustrating the way a Service Manager can send database information to other Service Managers dynamically when a TCP/IP connection is established. Network connection can come down from time to time, severing connections between FSIP systems. This chart 890 shows that when a connection comes back up, some of the steps send database table information to the other FSIP instance or instances.

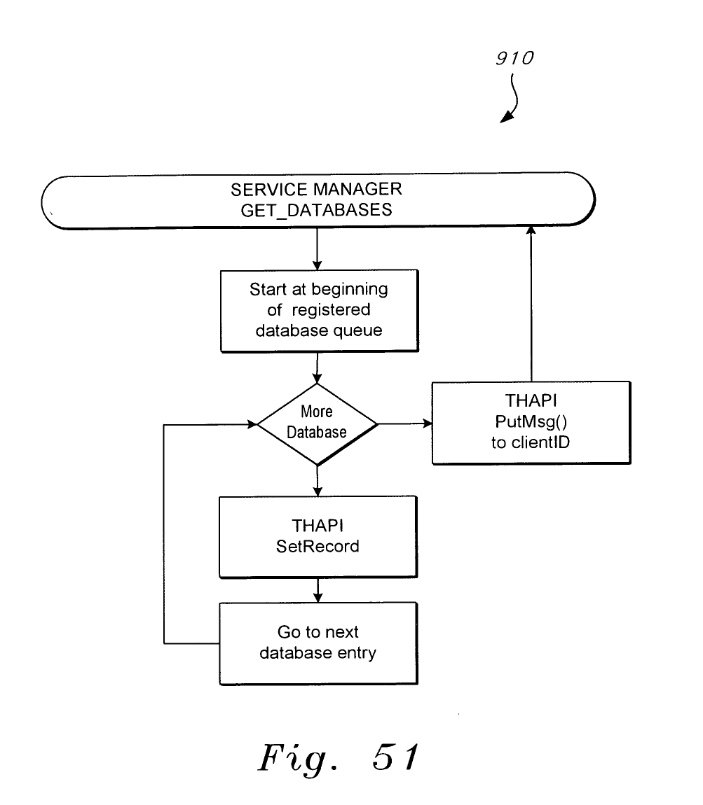

FIG. 50 is a flow chart 900 showing the synchronization process of finding the last table update processed by a database FSIP processor, and recreating TH_DB_WRITE records to update the database. Since network connections can be transient at times, a mechanism is used to update transactions when connections are restored. The flow chart 900 has some of the high level steps used by the FSIP to notify the remote instance or instances of the last transaction that was processed for each database table. With this information the remote FSIP instance or instances can transmit transactions to the FSIP that came online. This approach is different from the prior art because each FSIP Service Manager performs all steps to synchronize distributed database, versus the database itself or storage devices in the prior art.

FIG. 51 is a flow chart 910 showing how client applications find out about databases and tables. The client application would issue a GET_DATABASES query through the registered databases, tables, and classes, build a response message by issuing SetRecord( ) THAPI functions, then issue a putmsg( ) THAPI command to send the response back to the client. Client applications can then issue database commands to databases anywhere in the groups to which they have access.

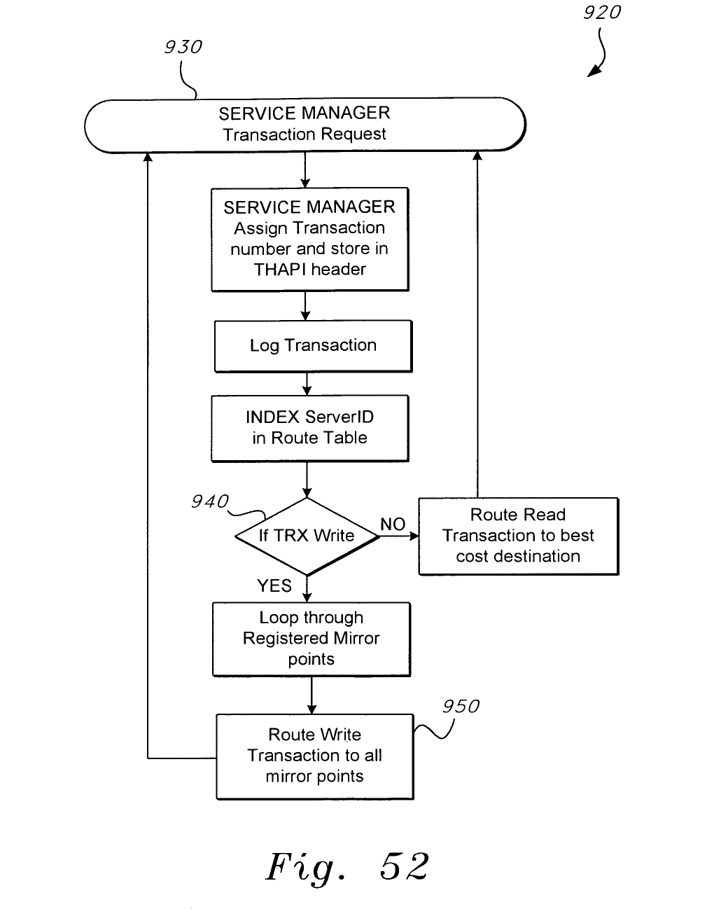

FIG. 52 is a flow chart 920 showing some of the steps the Service Manager performs to log and route a THAPI request. After logging the transaction request 930, the Service Manager determines whether the transaction request is a write transaction request or a read transaction request 940. If the transaction request is not a write transaction request the Service Manager routes the read transaction request to the best performing destination or destinations. If a multiple destination query is configured than the destination that returns first gets presented to the client and any others are discarded. If the transaction request 930 is a write transaction request the Service Manager loops through all registered databases with the same name and group name, and sends the write transaction request to all databases 950.

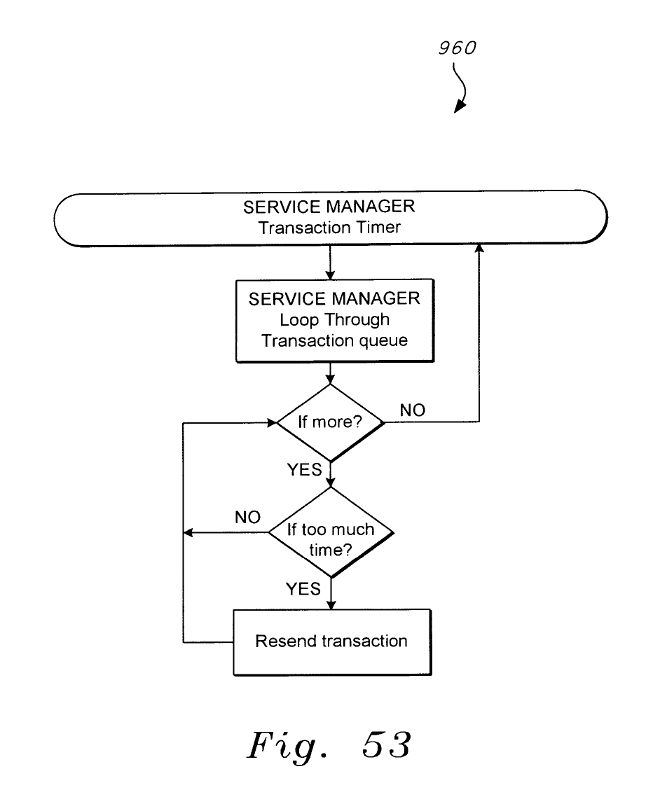

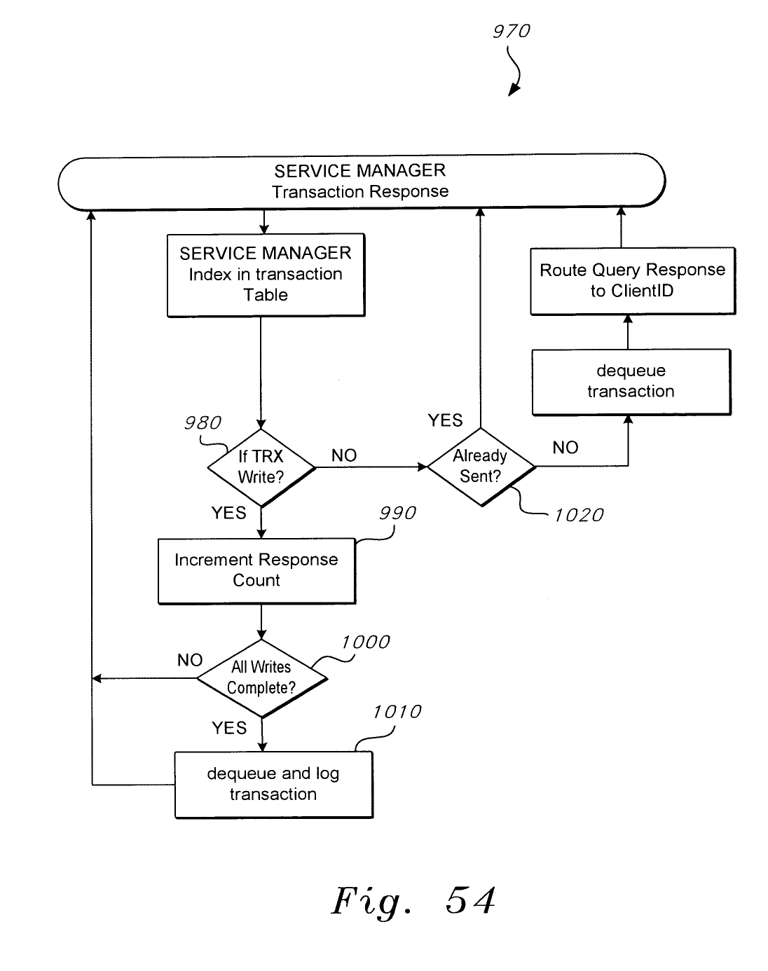

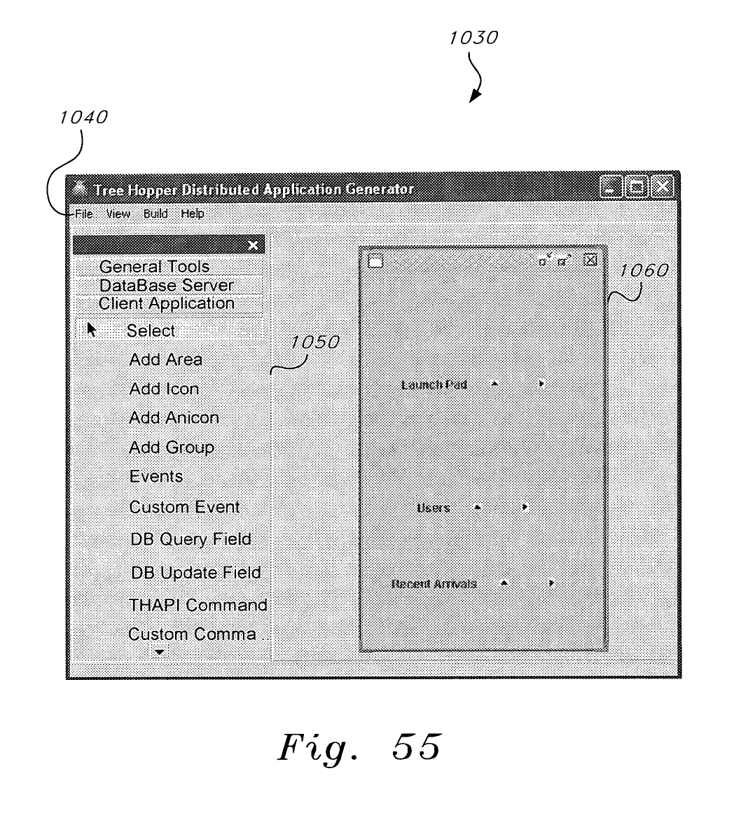

FIG. 53 is a flow chart 960 illustrating how the Service Manager has a timer to keep track of transactions, and some of the steps a Service Manager can do to keep track of transactions and retransmit the transactions if necessary. FIG. 54 is a flow chart 970 showing some of the steps the Service Manager can take to process transaction response acknowledgements. The Service Manager indexes into the transaction table and determines whether the transaction is a write transaction 980. The transaction is a write transaction the response count is incremented 990. A determination is then made whether all writes have been completed 1000. If they have the transaction is dequeued 1010 once all acknowledgements have been received. If the transaction is not a write transaction a determination is made whether the read or query transaction has been returned to the client 1020. If it has the transaction can be discarded. Otherwise the transaction can be dequeued and returned to the requesting client.

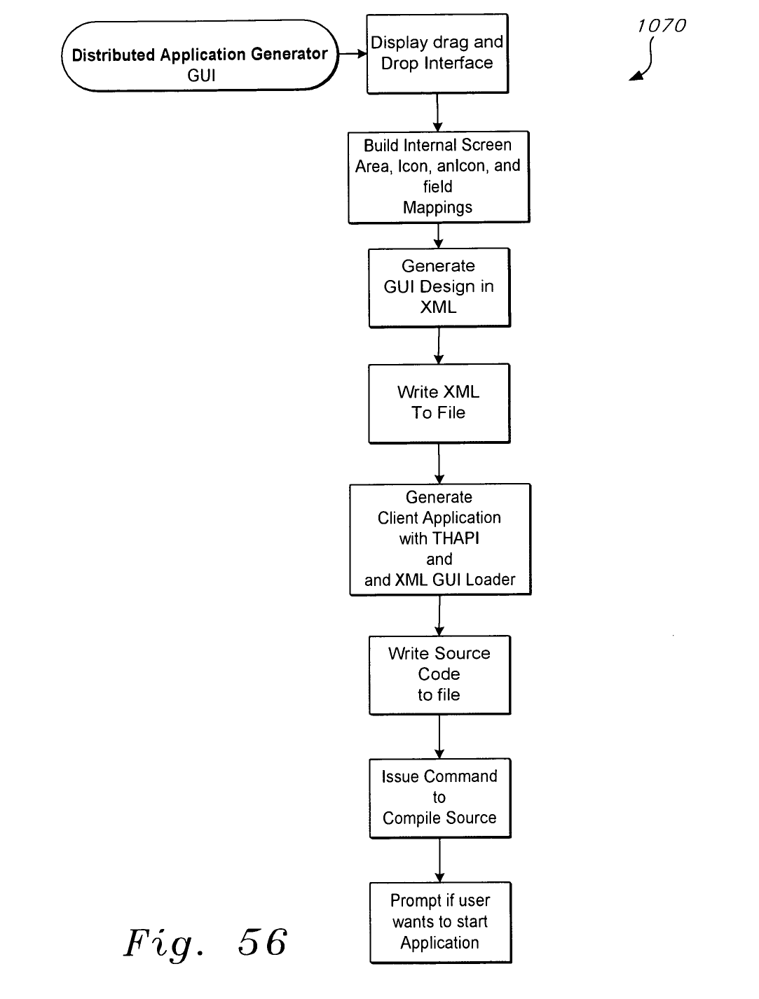

FIG. 55 is a screen shot 1030 showing the distributed application and database generator GUI. The screen shot 1030 includes a drop down menu bar 1040 and a tool menu windows on the left 1050 that allows a user to select from General Tools, Database Server, or Client Application. The child window 1060 on the right is the actual GUI created by the application generator when the client application is selected. Under the client application there are many buttons the user can select to create application. This differs from the prior art that requires programmer type skill set to create applications. The FSIP allows general users to create full function database client and server applications. This also differs from the prior art because the applications generated can take advantage of all the robust distributed multi-point database features of the FSIP. When the user is ready he/she can select the Build tab on the menu bar 1040.

FIG. 56 is a flow chart 1070 showing some of the steps the generator can take to build and output the distributed database application, sheltering users from actual programming tasks required in the prior art. While the user is interacting with the system the system builds internal information about the application. When the user decides to build the application, an XML representation can be created to represent the GUI with any input/output fields, icons, anicons, and/or other things the user wants in the application. The actual source code can then be generated that includes the THAPI distributed database commands and the code to load the xml and build the rest of the application. This source code is written and compiled, and the user is prompted if they would like to run the application.

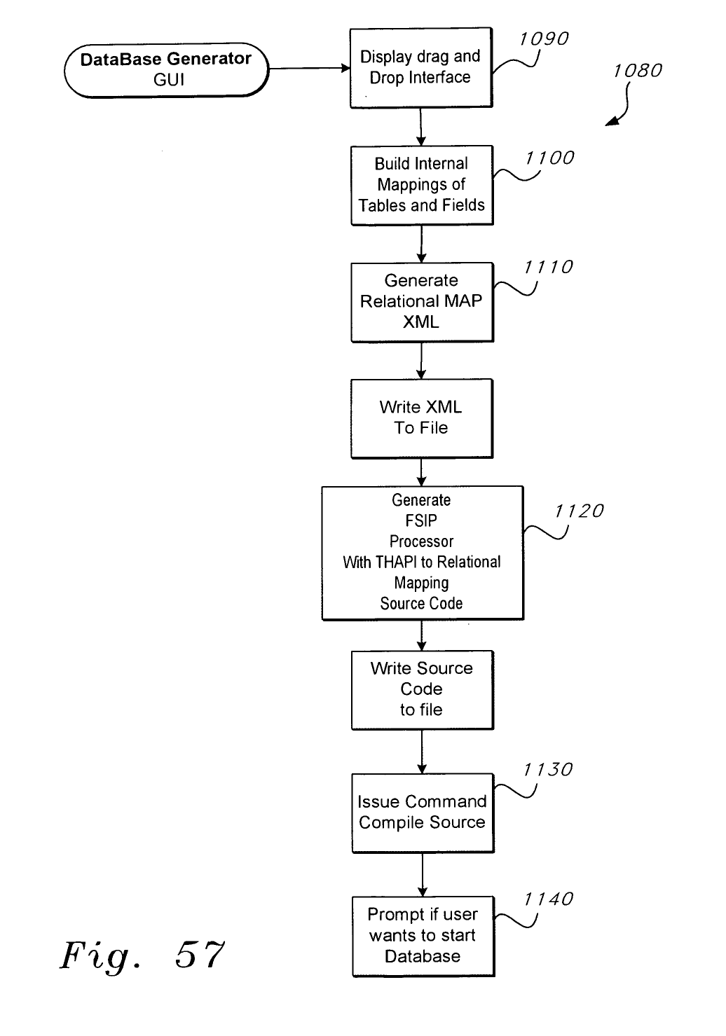

FIG. 57 is a flow chart 1080 showing some of the steps the generator can do to build and output a database FSIP processor, also known as a Database Access Processor (DAP) according to the present invention. When a user is in the drag and drop GUI 1090 internal mappings are built 1100. When the user selects to build the database server, a relationship mapping can be written to an XML file 1110. Relational mapping maps fields to database elements such as tables, classes, columns, etc. The database can be mapped into THAPI records and objects that can be distributed anywhere in the network. This is not done in the prior art. After the XML is written as output a DAP is automatically generated 1120 and processes the XML output. This code can then be compiled into an executable format 1130 and loaded by the user 1140.

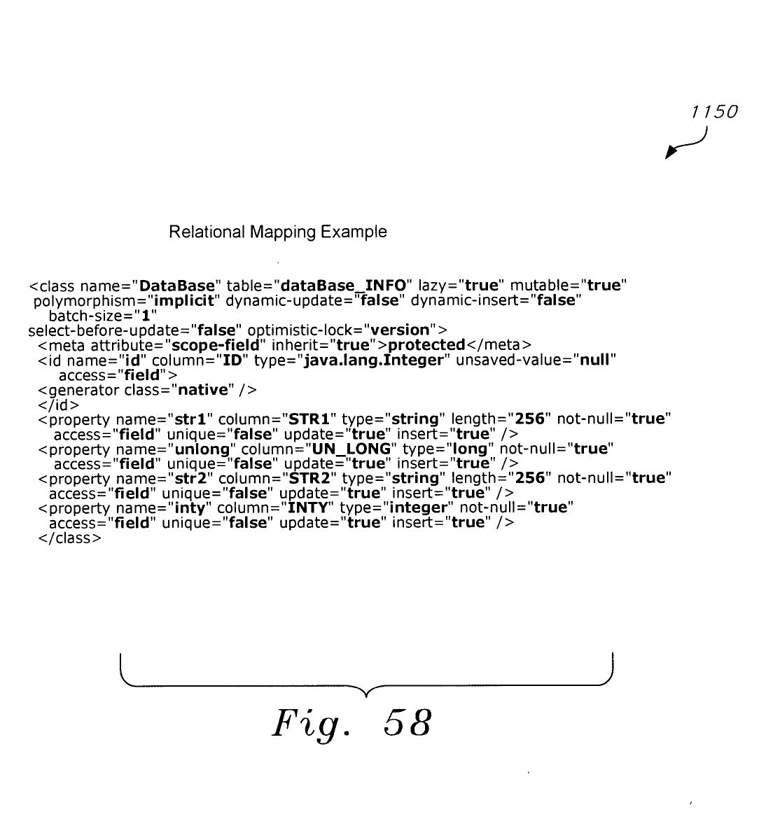

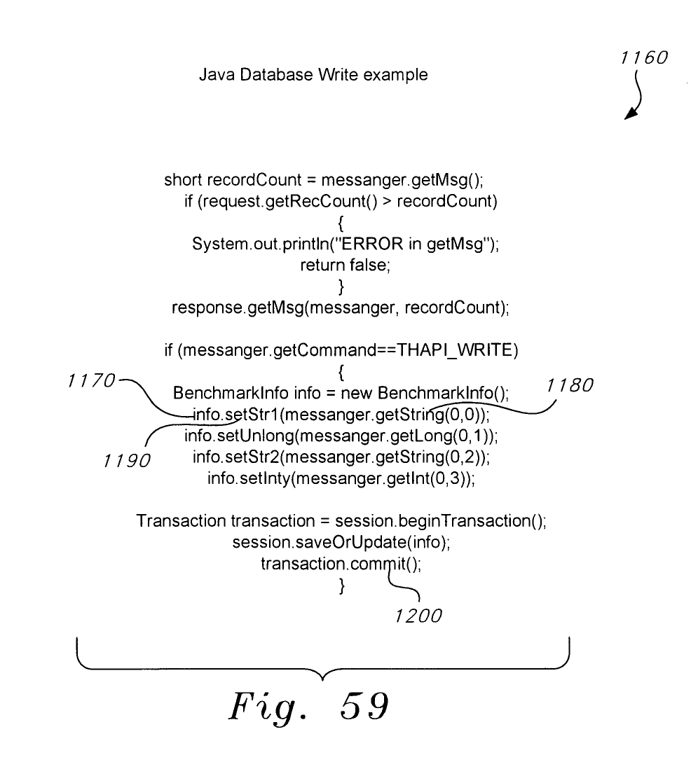

FIG. 58 is a simple example 1150 of a relational mapping XML output generated by the database generator. There are many other types of statements the database generator can create. FIG. 59 is a sample source code 1160 that the database generator creates that interfaces with client applications via THAPI and the database relational mapping system. In this simple example the database fields from a client application are set in a single source line 1170. In this single source line 1170 a getString method 1180 is the THAPI command to get a string object from the transaction record(s) sent by the client application. The info.setStr1 1190 is the source code that places the string in the relational mapping field. This transaction is then committed to the database 1200. An acknowledgement can be sent to the service manager where the client application is located. This is all done by DAP and client applications generated by the FSIP system without any programming by the user. Similar processes are used to generate other database transactions.

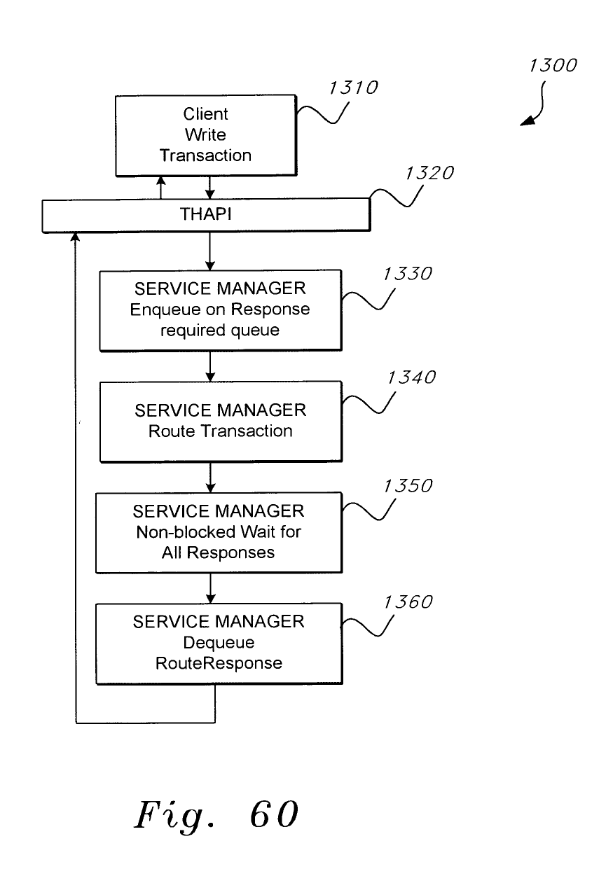

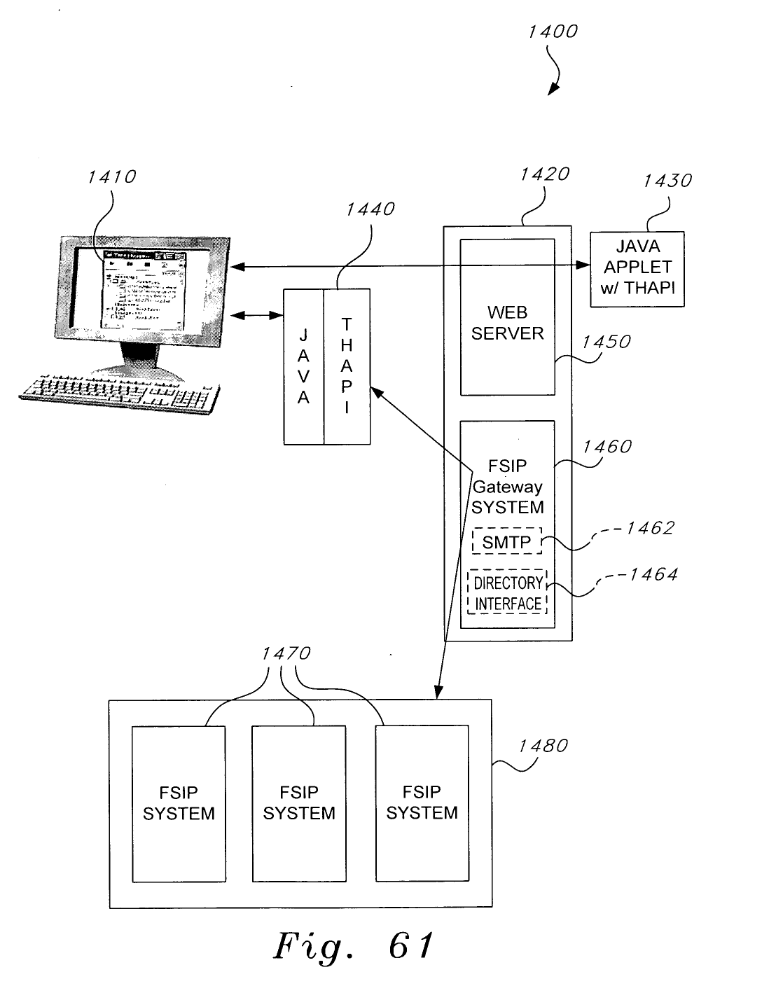

FIG. 60 is a flow chart 1300 of some of the steps the client side application takes to write a database transaction 1310 according to the present invention. The application can issue THAPI commands 1320 to send a request to the Service Manager on the system on which the client application resides. When the client application is running in a web browser the THAPI commands can be sent to the server directly. The Service Manager places THAPI command request(s) on a queue 1340 and routes the request(s) 1350 to a processor on the local machine, remote systems, and/or groups of remote systems. The Service Manager performs a non-blocked asynchronous wait 1360 for a response(s) and then routes the response(s) 1370 back to the client application.

FIG. 61 is an illustration 1400 that shows how the FSIP distributed computing system can be extended to function in a web browser. This enables any client of the system to run with a JAVA enabled web browser and without any special programs loaded. A computer is running a JAVA enabled web browser 1410. When the user clicks on a link the web server 1420 can download a JAVA applet 1430 that also has application and THAPI components. After the JAVA applet is loaded the application 1450 interacts with any system running the FSIP system. Although web browsers, JAVA and applets are available in the prior art, one that can access the wide range of features in the FSIP distributed computing environment is not available in the prior art. In addition the prior art has email and instant messenger systems, but never the two shall meet. By having a Simple Mail Transport Protocol, SMTP 1462 or other email gateway protocol running as a System Access Processor on FSIP, emails can be routed to instant messengers and vise a versa. Since the FSIP to FSIP communications can use encryption, an unsecured email can be converted to secure messenger. In the prior art email messages are not encrypted and considered to be unsecured. The FSIP Secure Messenger provides a novel approach to sending encrypted emails. Also, the Secure Messenger can support both email and Instant messenger features from within a single application. A directory services interface 1464 can also reside in the FSIP Gateway. This processor can be used to authenticate remote users and systems with directory services, like Active Directory. The Gateway services are not limited to the ones described here and are independent of each other. They are illustrated on a server, but can also run on a personal computer.

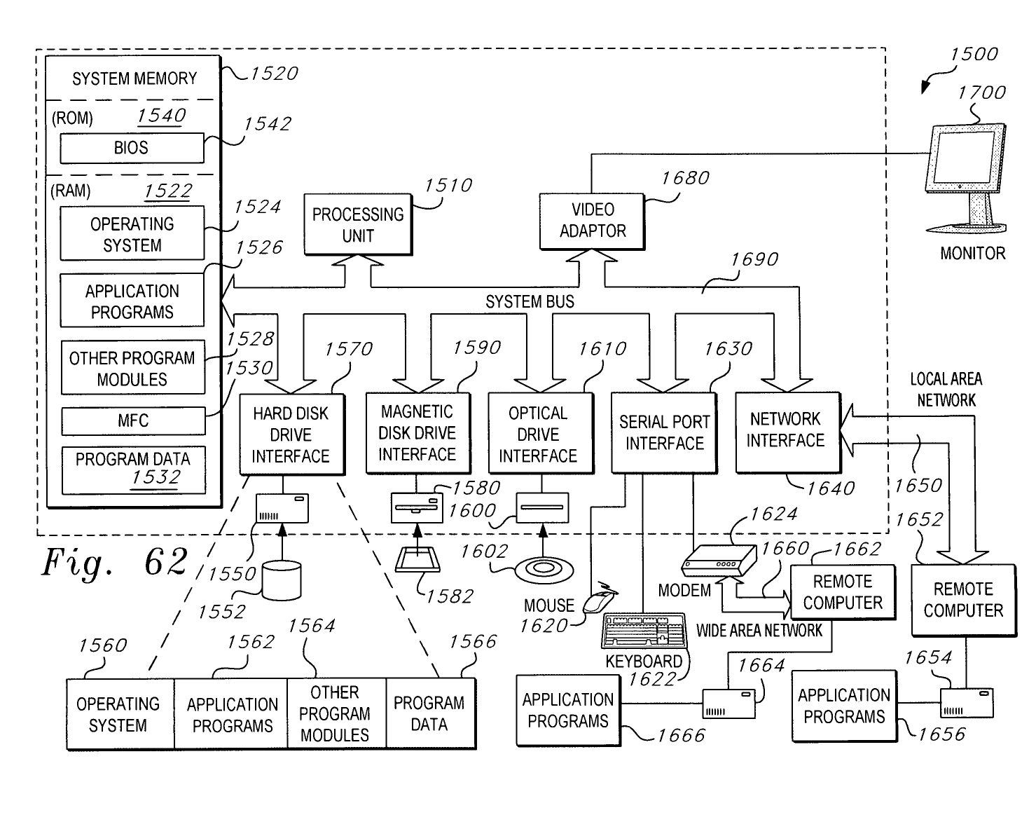

FIG. 62 shows an exemplary system for implementing the FSIP. The system includes a general purpose computing device in the form of a computer 1500. The computer 1500 includes a processing unit 1510 and system memory 1520. The processing unit 1510 and the system memory 1520, are communicatively interconnected by a system bus 1610. The system bus 1610 may be any of several types of bus structures including a memory bus or memory controller, a peripheral bus, and a local bus using any of a variety of bus architectures. The system memory 1520 includes random access memory (RAM) 1522 and read only memory (ROM) 1540. The basic input/output system (BIOS) 1542 containing the basic routines that help transfer information between elements within the computer 1500, such as during start-up, may be stored in the ROM 1540.

The computer 1500 can also include a magnetic hard disk drive 1550 for reading from and writing to a magnetic hard disk 1552, a magnetic disk drive 1580 for reading from or writing to a removable magnetic disk 1582, and an optical disk drive 1600 for reading from or writing to removable optical disk 1602 such as a CD-ROM or other optical media. The magnetic hard disk drive 1550, magnetic disk drive 1580, and optical disk drive 1600 are connected to the system bus 1690 by a hard disk drive interface 1570, a magnetic disk drive interface 1590, and an optical disk drive interface 1610, respectively. Such drives and their associated computer-readable media provide nonvolatile storage of computer-executable instructions, content structures, program modules and other content for the computer 1500. Although the exemplary environment described herein employs a magnetic hard disk 1552, a removable magnetic disk 1582 and a removable optical disk 1602, it will be appreciated that various other types of computer readable media for storing content can be used, including magnetic cassettes, flash memory cards, digital video disks, Bernoulli cartridges, RAMs, ROMs, and the like.

Program code means comprising one or more program modules may be stored on the hard disk 1552, the magnetic disk 1582, the optical disk 1602, the RAM 1522 or the ROM 1540. The RAM 1522 includes an operating system 1524, one or more application programs 1526, other program modules 1528, and program data 1530. A user may enter commands and information into computer 1500 using the pointing device or mouse 1620, the keyboard 1622, or other input devices (not shown), such as a microphone, joy stick, game pad, satellite dish, scanner, or the like. These and/or other input devices can be connected to the processing unit 1510 through a serial port interface 1630 coupled to the system bus 1690. Alternatively, the input devices can be connected by other interfaces, such as a parallel port, a game port and/or a universal serial bus (USB). A monitor 1700 or another display device can also be connected to the system bus 1650 via an interface, such as a video adapter 1680. In addition to the monitor 1700, the computer 1500 can include other peripheral output devices (not shown), such as speakers, printers, scanners, and/or the like.

The computer 1500 can operate in a networked environment using logical connections to one or more servers. It will be appreciated that remote computers 1652 and 1662, for example, may serve in such a capacity. It will further be appreciated that the computer 1500 can additionally, or alternatively, be employed in the context of various types of control systems. Note that as contemplated herein, a ‘server’ refers to a computer in a network shared by multiple users, and the term ‘server’ may also refer to both the hardware and/or software that performs one or more of the service(s), tasks, operations, and functions disclosed herein. Examples of types of servers contemplated as being within the scope of the present invention include, but are not limited to, web servers, application servers, remote access servers, mail servers, merchant servers, database servers, and the like.

Further, remote computers 1652 and 1662 may each be another personal computer, a server, a router, a network PC, a peer device or other common network node, and typically includes many or all of the elements described above relative to the computer 1500, although only memory storage devices 1654 and 1664 and their associated application programs 1656 and 1666 have been illustrated in FIG. 62.

Communications between two or more of such servers, computers, and the like may be accomplished by wireless or hardwire based communications systems, methods, and devices, or by various combinations of hardwire and wireless based systems, methods, and devices. Finally, in at least some embodiments of the present invention, one or more data gathering steps, data processing steps, and/or data display steps is performed at, or in conjunction with, a web site located on a server. By way of example, some or all of the features and capabilities of the FSIP may be embodied in the form of one or more web sites, each having one or more web pages, located on a designated server or other similarly configured computer or device. Such a web site, or web sites, may be employed in conjunction with any number of multiphase flows.

The logical connections depicted in FIG. 62 include a local area network (LAN) 1650 and a wide area network (WAN) 1660 that are presented here by way of example and not limitation. Such networking environments are commonplace, and include, but are not limited to, in office-wide or enterprise-wide computer networks, intranets, the Internet, and the like. When used in a LAN networking environment, the computer 1500 is connected to the LAN 1650 through a network interface 1640. When used in a WAN 1660 networking environment, the computer 1500 may include a modem 1624, a wireless link, or other means for establishing communications over the WAN 1660.

The modem 1624, which may be internal or external to the computer 1500, is connected to the system bus 1690 via a serial port interface 1630. In a networked environment, program modules depicted relative to the computer 1500, or portions thereof, may be stored in remote memory storage device(s) 1654 and 1664. It will be appreciated that the network connections shown are exemplary and other means of establishing communications over the WAN 1660 may be used.

The FSIP provides a unique and different approach to scanning file systems, creating and maintaining “views” of file systems in memory, reducing space on file systems, performing unique functions on specific files or a multiple thereof, multi-threading, with common repository to work on multiple storage subsystems at the same time, and distributing report pointers versus reports.

The FSIP includes software routines to perform a unique function to provide high end assessments of data storage subsystems. The FSIP also provides novel approaches to reducing storage allocation space by deleting, migrating and replacing duplicate files with shortcut pointers to a single instance of a file. Referring to FIG. 23, the two computers on the left include one running a single instance of the FSIP, and the other running two instances of the FSIP. Each instance is getting input from different data storage file systems. The output from each instance is stored in a common data area to consolidate reports for enterprise wide storage summarization.

There are many file scanning applications on the market today and in the prior art, but the novelty in this invention is the ability to scan the file system once and maintain the file system information in memory even as the file system is changing. This has tremendous value for personal computer users and corporate system administrators alike. The FSIP has a new set of easy to use interfaces to assist in the cleansing, security administration, remote access, file calibration, data distribution, data backup and data restore. Because all the views are pre-calculated in memory, the response time is instantaneous on the local system. The same high end features, such as individual subsystem analysis combined with reports and easy to use visual tools, can be used by a personal computer user, or multiple systems by corporate system administrators. FIG. 24 then takes the common output area and extends that to the user community. There are programs on the market that can report on storage usage by user. These reports are printed and manually distributed to the users of the storage. The FSIP writes the report to a common repository and then sends a message to the user who owns the data with a pointer to that users report. By sending just a pointer, this reduces the clutter of storage by storage reports. The user can be selectively assigned based on volume, directory or name of a directory. For example, a common practice for storing user home directories is to give the user a subdirectory, such as \\servername\users\emailname\home, where part of the directory is the user's name and email address. An initialization setting can be made to specific which branch in the tree is the users email address.

Another novel technique and one of the key characteristics of the FSIP is the underlying scanning technique. FIG. 9 shows a prior art example 250 of very small sample of a file systems directory structure. The chart 250 shows a root directory followed by eight subdirectories, and of course there could be any number of files in these directories, but they are not illustrated here. In the prior art directories are scanned in a single thread in a breadth first starting at the root and scanning to the end until complete. This approach has worked fine for decades. The main problem with this approach is it is not an efficient way to summarize information pertaining to the directories and files therein. For example, in the prior art one could find the size of a directory by going to the properties menu of the windows explorer, then a scan is initiated by the explorer, and the user can finally see the size of that directory. With the FSIP all of the directories for the entire file system are calculated during the initial scan and is displayed next to the size column of each and every directory and sub-directory. This applies to all the other unique views created by the FSIP during the scan and maintained while the file system is being changed.

The example 260 shown in FIG. 10 is a brief sample of the concurrent depth first or tree hopping technique of the FSIP, first in a forward direction. This example uses five threads, but any number of threads can be used in the present invention. Thread1 starts by scanning the root and detects that there are more subdirectories than Dir1 and Dir2. Thread 1 then signals Thread2 to start scanning Dir1, while Thread1 continues with Dir2. Thread2 then signals Thread4 and Thread5 to perform depth first scans of Dir1a and Dir1B while Thread2 continues with Dir1c. Meanwhile, Thread1 scans Dir2b and signals Thread3 to do Dir2a while Thread1 continues in a depth first manner to Dir2c. Thread1 in this very simple example shows how the tree is hopped to the end. A very unique part of the present invention is that as Thread1 hops to the end it signals to other threads to do sibling subdirectories, making it a concurrent depth first search.

FIG. 11 demonstrates the reverse summarization of the Tree Hopper concurrent depth first approach 270. Instead of scanning forward the FSIP scans and “hops” to the end of the tree, then scans and hops backwards. In this example Thread1 finished Dir2c and summarizes results to Dir2b before Thread3 finishes Dir2a. Since there are no other sibling directories and another thread is active at the level, Thread1 does a final summary to Dir2, then returns to the thread pool. When Thread3 completes Dir2a and detects all the other sibling directories are complete, Thread3 summarizes to Dir2. When Thread3 detects Dir1 is still being scanned by another thread, Thread3 summarizes all Dir2 information to the root, then returns to the thread pool. This example illustrates that Thread5 is the last active thread so after summarizing to Dir1, Thread5 continues backwards and summarizes the root to complete the scan. The technique is advantageous because it is a very efficient way to summarize file and directory information, first by hopping to the end and then by going from the back to the beginning. Now every subdirectory contains size information. It is also much more efficient to summarize security permissions and other views. FIG. 14 is a screen shot 300 of the Tree Hopper status monitor. In this example, during this scan, seventeen threads are all running the depths first search on different parts of the directory structure.

FIG. 12 shows a high level flow chart 280 of the scanning process of the FSIP. The FSIP is initialized by reading a configuration file. The configuration file has a plethora of parameters and arguments for those parameters. These parameters are created by either editing the configuration file, or by a GUI. The FSIP checks to see if a file system scan is required. By default the first time through the file system is scanned. If so a thread is created to scan the file system. The main thread continues and displays and processes users' requests. The “Find Next” block is the start of the File System Scan loop. Every time the FSIP selects a new directory to scan, this process is executed. The input to this process is a fully qualified directory path. The output is a file or directory structure retrieved from the file system.

The “More Files” decision block checks the return code from the “Find Next” to determine if there are anymore files or directories in that path. The “No” branch causes the FSIP to hit the “More Directories” decision block. A “No” means back to the root directory and means the scan has completed. This is unique to file scanning methods versus the prior art. Since we actually tree hop to the end, and work our way backwards, the scan is complete when we get back to the root. A flow chart 290 illustrates this process in FIG. 13. For the prior art the scan is complete when the scan hits the end of the last branch. This is evident in the prior art, because directory summarization isn't done in the prior art.

To further illustrate this difference, in FIG. 9 the prior art 280 finishes the scan after reading all file information in directory Dir2c. In the case of the present invention FIG. 11 shows the last directory scanned is Dir1b, and is not finished until everything is summarized back to the root. In the prior art, file system information is gathered and then either reported on or displayed with a tree view. This tree view is often separated into a folder window and a second file window. The prior art does not have any virtual file views displayed with the original file to assist the user in finding backup, snapshot, volume shadow, file revisions, stale data, and other copies.

In the prior art, if you want to see all extension of type DOC, you would do a search on *.DOC. If you wanted to see the biggest files on the file system, you would first do a search of *.*, then sort on size by clicking the Size field. If you wanted to see the total size of an extension and sorted by the largest extensions, and the largest files within that extension, that's not feasible with prior art. Also, if you tried to search a tera-byte file system with a *.* search, it would take an unusually long period of time, to the point of being unusable. In the current invention each view is a button and the responses are instantaneous.

Building multiple views during the file system scan is critical to large data center and PC users a like. The FSIP uses dynamic memory allocation, several different control block mechanisms, and some novel algorithms to accomplish this. These control block mechanisms are single threaded, double threaded, multi-threaded, multi-dimensional link lists, link tables, and multi-dimensional link list tables.

FIGS. 15 and 16 are illustrations 340 and 350 of link lists and link tables, respectively. FIG. 15 is an illustration 340 of two single headed single threaded link lists. The name anchor points in ascending order based on the files name, and the size anchor points through the linked control blocks based on size. This illustrates two different views of the files one based on name the other based on size for the same control block. FIG. 16 illustrates linked tables 350 with a similar concept. One table is ordered by file name, and the other is ordered by file size.

These view techniques are used for but are not limited to file size, file name, multiple age views, duplicated files, and extensions by name, size within an extension, waste files, size with in waste files, alarm files, size within alarm files, Access Rights and so on. Now when a user wants to know the largest files on a file system the information is already available based on the size “View”, and is returned in under a second. If the user wants to search for a specific file name or extension, again the view is already created and the information is returned in under a second.

The FSIP can detect duplicate files, and duplicate files with different names. Since all files on the file system are inserted into a link table by order of size, the index in the link table of the current file is used as an entry. The procedure first loops backwards until either the beginning of the table or a different file size is detected. Then the FSIP loops forward to review all the files of the same size. One factor all duplicate files have in common is their size is the same. In this same size loop, each file is checked to see if the name and last modify time is the same. The granularity of the last modify time is a second, and is recorded in the file system as a thirty-two bit integer, representing the number of seconds since Jan. 1, 1970. If the name and the last modify date are the same, the file block is en-queued on a multi-dimensional link list. The first dimension of the link list is a list of unique duplicate files. The second dimension off each entry is a list of duplicates for that entry. One file could have any number of duplicates.

If the files name and modify date do not match, it doesn't mean the files are not identical. Different users can save the same file with a different name or the file could have a different last modify date but actually still be identical. The process checks these files with the same size but different names and modify dates. If they are identical, the file block is en-queued on the multi-dimensional duplicates link list. This same procedure of identifying duplicate files on a single system can be used for identifying duplicate files on a multiplicity of file systems.

In the prior art there are numerous code examples to scan a file system. None do so in the fashion and efficiency the FSIP does. In the prior art developers are forced to develop the interfaces to the files systems to perform and activities on any files. With the FSIP, developers and even users can develop programs, DLL's or scripts, and the FSIP passes the program or script the file information, thus shielding the user from the underlying file system calls. For example, what if a company wants to look for all MP3 files, move them, and then erase them. The FSIP can be configured to issue a batch file or script to perform this simple task any time an MP3 is found. The configuration directive “exiton” configures this feature. The FSIP leverages semaphores to throttle the number of concurrent exit routines running at one time, to prevent overloading the system.

In the prior art there are interfaces to applications to load them, pass parameters and issue a macro, from within a program. The FSIP extends the prior art so that a user can write a macro, configure the FSIP to scan the file system for a specific file or type of file, pass the file system information to that macro, and execute the macro. The configuration directive “onmacro” significantly reduces the effort required when mass numbers of documents or spreads sheets need to be modified with things like new company name, legal notices, or any other office automation task, thereby again freeing the user from the tasks of interfacing with the underlying file system. The FSIP leverages semaphores to throttle the number of concurrent macros running at one time, to prevent overloading the system.

The permissions summary report provides an easy to view summary of all the files and directories security permission. In the prior art there are tools to report on the file system permissions. The report generated in the prior art is about three lines of very detailed permission information for each and every file and directory. For large files systems the size of this report can be in the hundreds to thousands of pages. The FSIP summarizes backwards and creates permission “views” with control blocks, link list and linked tables. If the Access Rights of files and directories at the last branch of the tree match its parent directories permissions, then the parent directory is added to the link table and a counter is set to one, to indicate one subdirectory has the same permissions. If the parent of the parent has the same Access Rights, the parent is deleted from the link table, the parent of the parent is added, and the counter is incremented. At this point in the scan the linked table would show the parent of the parent, and a count of two, which means two subdirectories of the same permissions.

If permissions didn't match then the linked table would not delete that item. This is done for every file and every different type of access group in the file system. This would continue throughout the scan. When the scan is complete the permissions summary is then merged with user and group information and actual rights are calculated and visually reported. As a result the output of the FSIP is a page or two, which significantly reduces the time required to perform a file systems permissions audit. Furthermore, the FSIP looks for known permission vulnerabilities or weaknesses and highlights those items in the report. This has many advantages over the prior art. Firstly, on a single display one can see all the trustee access rights for the entire file system, which is not available in the prior art. Secondly, and also very important is user and group Actual Rights are calculated and reported on a single user interface. In the prior art one can do this by maneuvering through several screens, one file or one directory at a time, making it extremely difficult to know the actual rights a user might have for the entire file system. Thirdly, the FSIP allows an administrator to search all systems for a specified user or group, and get actual Access Rights for the entire company.

The data center totals reports and charts are unique to the prior art. By having multiple instances of the FSIP writing to a common data center totals file, the FSIP creates a holistic view of all the storage subsystems and file systems with in a data center. The FSIP generates a system by system report of all the file systems and can generate any chart or report of the single system, but give a data center totals illustration versus a single systems illustration. The FSIP takes it a few steps further by sending web pointers to the reports, and providing an option for the Tree Hopper Explorer to run as an applet in that browser, so the reports go to the owner of the data and a user friendly interface design to assist in storage reduction.

The duplicate and aged file reports are output of the FSIP tree hopper scanning thread. This output is then input to other processes of the FSIP. These other processes or part of the “Process User Request” block or a stand alone utility. This utility can read a multiplicity of duplicate reports and consolidate duplicate files across a multiplicity of file systems to create a single data center wide duplicate report. Furthermore, this utility or process can read the single system or multi-system duplicate report and process duplicates based on user selectable criteria. Users of the apparatus can direct the FSIP to copy a duplicate file to a single shared data source, then delete all copies of the file and then create shortcuts that point to that shared data source, thus reducing the file system space allocated by all the duplicate files with user transparency.

Users can also select to delete duplicate files if desired or leave one copy of the duplicate and create shortcuts to that single copy. This is significantly different to the prior art of a single information store (SIS). SIS makes reference to a filter driver above the file system and SIS owns the common files. SIS makes no reference of handling duplicate files located on multiple desperate file systems. FSIP is not required to run on the same system the file system is running on. FSIP does not own the common file. The FSIP moves the file to a network share, and then creates a shortcut to that share. Also the methods of detecting duplicate files are different in the FSIP.

Like the duplicate file approach, the FSIP generates an age file report for each instance. This report file is then input into a standalone process or process block of the FSIP. Aged files can be processed similar to duplicates by copying the file to alternate media, then delete and place a short cut in its place. In the case of aged files, the users of the FSIP have addition choices to place a command or a text file. The text file can instruct the end user to call the help desk to retrieve the file. The command can actually initiate a restore command to a backup utility to restore the file from backup media, with magnetic tape for example. This method differs from the prior art in the fact it doesn't require the FSIP to run on the system on which the file system resides. The FSIP also gives the flexibility to restore from any archival system, and can create shortcuts directly to network shares.

FIG. 26 illustrates virtual views of files that is not found in the prior art. Lets say a user has his/her data backed up every night. Now he/she makes a mistake, and needs to restore the file. First of all, most backups run once a day, and most snapshot and shadow copies run once an hour. The FSIP FAP component allows for backups when the files are changed. So how do they get their file restored in the prior art? They either have to know all the unique commands and/or locations that file is or they have to call someone that can do it for them. With the FSIP, the FAP sets a virtualization bit for each file indicating there are other copies of the file somewhere. Since the FAP manages the Mirror Directory Block shown in FIG. 17, virtual files locations are known. So when a user clicks on the plus sign next to the file, like in FIG. 26, the Tree Hopper Explorer issues a command to the FAP to get information about backups, revisions, snapshots, volume shadow copies or any other virtual file, then visually displays it to the user with the original file without having to go to any other menu, screen or program. Now the user can easily see and restore the file themselves.

The FSIP automates tasks done to by users with files, secures transparent remote access of files, improves file system security management, provides enterprise or organization wide file system security management, provides enterprise or organization wide file system monitoring, provides instantaneous file system views, provides file system utilization reports for every computer user, provides enterprise or organization wide automated storage reporting, provides concurrent multi-point when a file changes with instantaneous transfers, provides distributed database logging, and provides distributed database synchronization. The FSIP provides distributed database client and server automatic generation, improved data presentation to users, provides a Personal Virtual Networks (PVM) versus Virtual Primate Networks, and provides a single coherent platform to provide these critical file system interfaces.

In the prior art computer users are used to plugging their digital devices in, moving the files the files manually or with the aid of software, then attaching to an email, where on the other side the users open the message and then receives it. The FSIP automates this process by allowing users to create groups and automatically and securely transmit to a group with minimal mouse, speech or no input at all. This provides a new and enhanced user collaboration interface. Furthermore, the FSIP provides new ways to administer users by self generating users and passwords so the less skilled do not concern themselves to know the Operating Systems' specifics for these tasks.

Distributed Computing Environments (DCE) came about when computers became networked. The FSIP brings a new set of features that increases functionality, while reducing complexity to the user. With automatic file transfers, user and macro exits, Tree Hopper Application Programming Interface, automatic application generation, automatic database generation, and the like, will significantly enhance the development of distributed applications, making this approach the next generation DCE.

In summary, the system, method and/or computer program product for a file system interface carry out steps including scanning a file system of the computer system to obtain file system information, automatically collecting and organizing the file system information into an internal cache of the file system information organized in a predetermined manner to enable instantaneous response of at least one query that provides a predetermined view of the file system, automatically monitoring the file system for changes, and automatically maintaining the internal cache. The system, method and/or computer program product for a file system interface can further carry out steps including maintaining internal data structure consistency of the file system information, instructing the computer system to construct at least one visual report of the file system without rescanning the file system, and instructing the computer system to scan a predefined portion of the file system, whereby multiple portions of the file system can be simultaneously scanned. The system, method and/or computer program product for a file system interface can further carry out steps including storing the file system information in a single data store, executing a depth first traversal of the file system, and storing the file system information in a set of data structures in memory that is built incrementally during the traversal.

The system, method and/or computer program product for a file system interface can further carry out steps including enabling a facility enabling user-specified computer instructions to be executed, linking to the at least one visual report available to a user, generating varied reports based on the age of at least one file on the file system, determining the presence of duplicate files on the computer system, generating a report of security permissions for at least one part of the file system, cross referencing file system security information with user and group information, calculating user and group actual access rights for at least one part of at least one of the file system and multiple file systems; providing a single visual report of actual access rights for all users and groups of a system or multiple systems, generating a report of security vulnerability of at least one part of the file system, and providing with an original file/files virtual views of backup, mirror, revisions, snapshot, and volume shadow copies of the original file/files.

The system, method and/or computer program product for a file system interface can further carry out steps including providing transparent views of remote file systems running the steps, and instructing a computer system to record the users file system transactions, and to store and replay the file system transactions. The system, method and/or computer program product for a file system interface can further carry out steps including reading and writing files to virtual locations, displaying icons in a matter to automate execution of software programs, providing virtual views of remote file shares, securely administering remote file system interface platforms, and enabling remote file system interface platform users to allow, disallow and store authorized and unauthorized connections.

The system, method and/or computer program product for a file system interface can further carry out steps including securely selecting computer resources available to authorized connections, keeping one copy of duplicate files, and programmatically creating shortcuts to the single copy where remaining duplicate files reside and removing the duplicate files to save on disk storage space. The system, method and/or computer program product for a file system interface can further carry out steps including migrating a single copy of a duplicate to shared storage and creating a shortcut to point to the single copy in shared storage, migrating old/aging files to alternate lower cost media, and programmatically creating a shortcut to the migrated file.

The system, method and/or computer program product for a file system interface can further carry out steps including receiving voice input from a microphone to interface with a FSIP, securely registering specific users' voice print for accessing a FSIP, translating voice instructions to control the loading, running and operations of a FSIP. The system, method and/or computer program product for a file system interface can further carry out steps including outputting sounds to the computers speakers with information from a FSIP, customizing speaker output to personal preference, forwarding database transaction records to any number of systems, logging database transactions at the creation point and in selected locations running a FSIP, storing transaction logs at user selected locations running a FSIP, and viewing and selecting a database transaction to apply or reapply the transaction to a database or group of distributed databases.

The system, method and/or computer program product for a file system interface can further carry out steps including processing database transactions at any number of locations running a FSIP, creating synchronized databases in disparate geographical locations, automatically creating database tables and features based on input transactions, creating a database without requiring human programming, and creating client side database transactions by selecting display elements. The system, method and/or computer program product for a file system interface can further carry out steps including monitoring file system changes and maintaining file system interface data structures, transferring data to another file system when data is changed, working in conjunction with a user messaging system, effecting a query to obtain information on a predetermined user from all File Access Processors, a local directory on the system, and a directory services system, creating a permissions monitor to manage company wide data security, adding security credentials from a user that performs an add remote operation to a remote system, storing the added security credentials to the remote system, and managing file system changes by alerting users of security changes.

The system, method and/or computer program product for a file system interface can further carry out steps including updating internal structures, automatically transmitting changed file, and sending journal changes to journal monitors, enabling manual transfer of files to a user or group, creating a Personal Virtual Network to emulate a LAN and provide a LAN to LAN connection over an authorized FSIP, enabling the use of personal voice and video over a FSIP, providing a user collaboration interface, creating animation icons, displaying an animation icon, enabling automatic file transfer, enabling operation on a JAVA enabled web browser, providing a gateway to connect a JAVA enabled web browser with a FSIP, and enabling the use of personal voice and video over a FSIP. The system, method and/or computer program product for a file system interface can further carry out steps including detecting use of plug and play devices, such as cameras, phones, other removable media, or the like, and automatically transmitting files to remote users and groups including listening for plug and play devices. The system, method and/or computer program product for a file system interface can further carry out steps including providing a single secure messenger configured to securely transfer messages including email messages and instant messenger messages. The system is configured to provide a distributed computing environment executable on any business/personal computer using any type of operating system or hardware.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A computer system comprising:
a processor; and
a computer readable media with executable instructions that carry out steps comprising:
scanning a file system of the computer system to obtain file system information;
automatically collecting and organizing the file system information into an internal cache of the file system information organized in a predetermined manner to enable instantaneous response of at least one query that provides a predetermined view of the file system;
automatically monitoring the file system for changes; and
automatically maintaining the internal cache.

2. The system according to claim 1, wherein the executable instructions further carry out steps comprising maintaining internal data structure consistency of the file system information.

3. The system according to claim 1, wherein the executable instructions further carry out steps comprising instructing the computer system to construct at least one visual report of the file system without rescanning the file system.

4. The system according to claim 1, wherein the executable instructions further carry out steps comprising instructing the computer system to scan a predefined portion of the file system, whereby multiple portions of the file system can be simultaneously scanned.

5. The system according to claim 1, wherein the executable instructions further carry out steps comprising storing file system report information information in a single data store.

6. The system according to claim 1, wherein the step of scanning the file system further comprises executing a depth first traversal of the file system, and storing the file system information in a set of data structures in memory that is built incrementally during the traversal.

7. The system according to claim 1, wherein the executable instructions further carry out steps comprising enabling execution of user-specified computer instructions.

8. The system according to claim 1, wherein the executable instructions further carry out steps comprising linking to at least one visual report.

9. The system according to claim 1, wherein the executable instructions further carry out steps comprising generating varied reports based on age of at least one file on the file system.

10. The system according to claim 1, wherein the executable instructions further carry out steps comprising determining the presence of duplicate files on the computer system.

11. The system according to claim 1, wherein the executable instructions further carry out steps comprising:
generating a report of security permissions for at least one part of at least one of the file system and multiple file systems; and
providing a single visual report of all file system permissions.

12. The system according to claim 1, wherein the executable instructions further carry out steps comprising:
cross referencing file system security information with user and group information;
calculating user and group actual access rights for at least one part of at least one of the file system and multiple file systems; and
providing a single visual report of actual access rights for all users and groups of a system or multiple systems.

13. The system according to claim 1, wherein the executable instructions further carry out steps comprising generating a report of security vulnerability of at least one part of at least one of the file system and multiple file systems.

14. The system according to claim 1, wherein the executable instructions further carry out steps comprising providing with an original file/files virtual views of backup, mirror, revisions, snapshot, and volume shadow copies of the original file/files.

15. The system according to claim 1, wherein the executable instructions further carry out steps comprising providing transparent views of remote file systems running the executable instructions.

16. The system according to claim 1, wherein the executable instructions further carry out steps comprising instructing a computer system to record file system transactions of a user, and to store and replay the file system transactions.

17. The system according to claim 1, wherein the executable instructions further carry out steps comprising reading and writing files to virtual locations.

18. The system according to claim 1, wherein the executable instructions further carry out steps comprising displaying icons in a matter to automate execution of software programs.

19. The system according to claim 1, wherein the executable instructions further carry out steps comprising providing virtual views of remote file shares.

20. The system according to claim 1, wherein the executable instructions further carry out steps comprising securely connecting a computer to a plurality of computers.

21. The system according to claim 20, wherein the executable instructions further carry out steps comprising providing a file system interface to enforce access to the plurality of computers.

22. The system according to claim 21, wherein the executable instructions further carry out steps comprising self generating credentials of user accounts and passwords from the file system interface for purposes of secure remote system and file access.

23. The system according to claim 22, wherein the executable instructions further carry out steps comprising securely exchanging the self generated credentials from the file system interface.

24. The system according to claim 22, wherein the executable instructions further carry out steps comprising effecting a secure login prior to using the self generated credentials.

25. The system according to claim 22, wherein the executable instructions further carry out steps comprising creating a personal virtual network to link to computers.

26. The system according to claim 20, wherein the executable instructions further carry out steps comprising securely administering remote file system interface platforms.

27. The system according to claim 20, wherein the executable instructions further carry out steps comprising enabling users of a remote File System Interface Platform to allow, disallow, and store authorized and unauthorized connections.

28. The system according to claim 1, wherein the executable instructions further carry out steps comprising securely selecting computer resources available to authorized connections.

29. The system according to claim 1, wherein the executable instructions further carry out steps comprising:
creating a single copy of duplicate files;
programmatically creating shortcuts to the single copy of duplicate files; and
removing at least one duplicate file from the single copy of duplicate files to save on disk storage space.

30. The system according to claim 1, wherein the executable instructions further carry out steps comprising:
migrating a single copy of a duplicate file to shared storage; and
creating a shortcut to point to the single copy in shared storage.

31. The system according to claim 1, wherein the executable instructions further carry out steps comprising:
migrating old/aging files to alternate lower cost media; and
programmatically creating a shortcut to the migrated files.

32. The system according to claim 1, wherein the executable instructions further carry out steps comprising receiving voice input from a microphone to interface with a File System Interface Platform.

33. The system according to claim 1, wherein the executable instructions further carry out steps comprising securely registering voice prints of particular users for accessing a File System Interface Platform.

34. The system according to claim 1, wherein the executable instructions further carry out steps comprising translating voice instructions to control loading, running and operations of a File System Interface Platform.

35. The system according to claim 1, wherein the executable instructions further carry out steps comprising outputting sounds to speakers of a computer with information from a File System Interface Platform.

36. The system according to claim 1, wherein the executable instructions further carry out steps comprising customizing speaker output to a personal preference.

37. The system according to claim 1, wherein the executable instructions further carry out steps comprising forwarding database transaction records to any number of systems.

38. The system according to claim 1, wherein the executable instructions further carry out steps comprising:
logging database transactions at a creation point; and
running a File System Interface Platform at predetermined locations.

39. The system according to claim 1, wherein the executable instructions further carry out steps comprising storing transaction logs at predetermined locations that are running a File System Interface Platform.

40. The system according to claim 1, wherein the executable instructions further carry out steps comprising viewing and selecting a database transaction to apply or reapply the transaction to a database or group of distributed databases.

41. The system according to claim 1, wherein the executable instructions further carry out steps comprising processing database transactions at any number of locations running a File System Interface Platform.

42. The system according to claim 1, wherein the executable instructions further carry out steps comprising creating synchronized databases in disparate geographical locations.

43. The system according to claim 1, wherein the executable instructions further carry out steps comprising automatically creating database tables and features based on input transactions.

44. The system according to claim 1, wherein the executable instructions further carry out steps comprising creating a database without human programming.

45. The system according to claim 1, wherein the executable instructions further carry out steps comprising creating client side database transactions by selecting display elements.

46. The system according to claim 1, wherein the executable instructions further carry out steps comprising monitoring file system changes and maintaining file system interface data structures.

47. The system according to claim 1, wherein the executable instructions further carry out steps comprising transferring data to another file system when data is changed.

48. The system according to claim 1, wherein the executable instructions further carry out steps comprising working in conjunction with a user messaging system.

49. The system according to claim 1, wherein the system is configured to provide a distributed computing environment executable on any business/personal computer using any type of operating system or hardware.

50. The system according to claim 1, wherein the executable instructions further carry out steps comprising effecting a query to obtain company wide system security information on a predetermined user.

51. The system according to claim 1, wherein the executable instructions further carry out steps comprising creating a permissions monitor to manage company wide data security.

52. The system according to claim 1, wherein the executable instructions further carry out steps comprising:
adding security credentials from a user that performs an add remote operation to a remote system; and
storing the added security credentials to the remote system.

53. The system according to claim 1, wherein the executable instructions further carry out steps comprising managing file system changes by alerting users of security changes, updating internal structures, automatically transmitting changed file, and sending journal changes to journal monitors.

54. The system according to claim 1, wherein the executable instructions further carry out steps comprising enabling manual transfer of files to a user or group.

55. The system according to claim 1, wherein the executable instructions further carry out steps comprising creating a Personal Virtual Network to emulate a local area network (LAN) and provide a LAN to LAN connection over an authorized File System Interface Platform.

56. The system according to claim 1, wherein the executable instructions further carry out steps comprising enabling the use of personal voice and video over a File System Interface Platform.

57. The system according to claim 1, wherein the executable instructions further carry out steps comprising providing a user collaboration interface.

58. The system according to claim 1, wherein the executable instructions further carry out steps comprising creating animation icons.

59. The system according to claim 58, wherein the executable instructions further carry out steps comprising displaying an animation icon.

60. The system according to claim 1, wherein the executable instructions further carry out steps comprising enabling automatic file transfer.

61. The system according to claim 1, wherein the executable instructions further carry out steps comprising enabling operation on a JAVA enabled web browser.

62. The system according to claim 1, wherein the executable instructions further carry out steps comprising providing a gateway to connect a JAVA enabled web browser with a File System Interface Platform.

63. The system according to claim 1, wherein the executable instructions further carry out steps comprising:
detecting use of plug and play devices; and
automatically transmitting files to remote users and groups.

64. The system according to claim 1, wherein the executable instructions further carry out steps comprising:
providing a single secure messenger configured to securely transfer messages including email messages and instant messenger messages.

65. A method for introspecting a computer system, said method comprising:
scanning a file system of the computer system to obtain file system information;
automatically collecting and organizing the file system information into an internal cache of the file system information organized in a predetermined manner to enable instantaneous response of at least one query that provides a predetermined view of the file system;
automatically monitoring the file system for changes; and
automatically maintaining the internal cache.

66. The method according to claim 65, further comprising maintaining internal data structure consistency of the file system information.

67. The method according to claim 65, further comprising instructing the computer system to construct one or more visual reports of the file system without rescanning the system.

68. The method according to claim 65, further comprising instructing the computer system to scan a predefined portion of the file system, whereby multiple portions of the file system can be simultaneously scanned.

69. The method according to claim 65, further comprising storing the file system information in a single data store.

70. The method according to claim 65, wherein the step of scanning the file system further comprises executing a depth first traversal of the file system, and storing the file system information in a set of data structures in memory that is built incrementally during the traversal.

71. The method according to claim 65, further comprising enabling execution of user-specified computer instructions.

72. The method according to claim 65, further comprising linking to the at least one visual report.

73. The method according to claim 65, further comprising generating varied reports based on age of at least one file on the file system.

74. The method according to claim 65, further comprising determining the presence of duplicate files on the computer system.

75. The method according to claim 65, further comprising:
generating a report of security permissions for at least one part of at least one of the file system and multiple file systems; and
providing a single visual report of all file system permissions.

76. The method according to claim 65, further comprising:
cross referencing file system security information with user and group information;
calculating user and group actual access rights for at least one part of at least one of the file system and multiple file systems; and
providing a single visual report of actual access rights for all users and groups of a system or multiple systems.

77. The method according to claim 65, further comprising generating a report of security vulnerability of at least one part of at least one of the file system and multiple file systems.

78. The method according to claim 65, further comprising providing with an original file/files virtual views of backup, mirror, revisions, snapshot, and volume shadow copies of the original file/files.

79. The method according to claim 65, further comprising providing transparent views of remote file systems running the executable instructions.

80. The method according to claim 65, further comprising instructing a computer system to record file system transactions of a user, and to store and replay the file system transactions.

81. The method according to claim 65, further comprising reading and writing files to virtual locations.

82. The method according to claim 65, further comprising displaying icons in a matter to automate execution of software programs.

83. The method according to claim 65, further comprising providing virtual views of remote file shares.

84. The method according to claim 65, further comprising securely connecting a computer to a plurality of computers.

85. The method according to claim 84, further comprising providing a file system interface to enforce access to the plurality of computers.

86. The method according to claim 85, further comprising self generating credentials of user accounts and passwords from the file system interface for purposes of secure remote system and file access.

87. The method according to claim 86, further comprising securely exchanging the self generated credentials from the file system interface.

88. The method according to claim 86, further comprising effecting a secure login prior to using the self generated credentials.

89. The method according to claim 86, further comprising creating a personal virtual network to link to computers.

90. The method according to claim 85, further comprising securely administering remote file system interface platforms.

91. The method according to claim 85, further comprising enabling users of a remote file system interface platform to allow, disallow, and store authorized and unauthorized connections.

92. The method according to claim 65, further comprising securely selecting computer resources available to authorized connections.

93. The method according to claim 65, further comprising:
creating a single copy of duplicate files;
programmatically creating shortcuts to the single copy of duplicate files; and
removing at least one duplicate file from the single copy of duplicate files to save on disk storage space.

94. The method according to claim 65, further comprising:
migrating a single copy of a duplicate file to shared storage; and
creating a shortcut to point to the single copy in shared storage.

95. The method according to claim 65, further comprising:
migrating old/aging files to alternate lower cost media; and
programmatically creating a shortcut to the migrated files.

96. The method according to claim 65, further comprising receiving voice input from a microphone to interface with a File System Interface Platform.

97. The method according to claim 65, further comprising securely registering voice prints of particular users for accessing a File System Interface Platform.

98. The method according to claim 65, further comprising translating voice instructions to control loading, running and operations of a File System Interface Platform.

99. The method according to claim 65, further comprising outputting sounds to speakers of a computer with information from a File System Interface Platform.

100. The method according to claim 65, further comprising customizing speaker output to a personal preference.

101. The method according to claim 65, further comprising forwarding database transaction records to any number of systems.

102. The method according to claim 65, further comprising:
logging database transactions at a creation point; and
running a File System Interface Platform at predetermined locations.

103. The method according to claim 65, further comprising storing transaction logs at predetermined locations that are running a File System Interface Platform.

104. The method according to claim 65, further comprising viewing and selecting a database transaction to apply or reapply the transaction to a database or group of distributed databases.

105. The method according to claim 65, further comprising processing database transactions at any number of locations running a File System Interface Platform.

106. The method according to claim 65, further comprising creating synchronized databases in disparate geographical locations.

107. The method according to claim 65, further comprising automatically creating database tables and features based on input transactions.

108. The method according to claim 65, further comprising creating a database without human programming.

109. The method according to claim 65, further comprising creating client side database transactions by selecting display elements.

110. The method according to claim 65, further comprising monitoring file system changes and maintaining file system interface data structures.

111. The method according to claim 65, further comprising transferring data to another file system when data is changed.

112. The method according to claim 65, further comprising working in conjunction with a user messaging system.

113. The method according to claim 65, further comprising providing a distributed computing environment executable on any business/personal computer using any type of operating system or hardware.

114. The method according to claim 65, further comprising effecting a query to obtain company wide system security information on a predetermined user.

115. The method according to claim 65, further comprising creating a permissions monitor to manage company wide data security.

116. The method according to claim 65, further comprising:
adding security credentials from a user that performs an add remote operation to a remote system; and
storing the added security credentials to the remote system.

117. The method according to claim 65, further comprising managing file system changes by alerting users of security changes, updating internal structures, automatically transmitting changed file, and sending journal changes to journal monitors.

118. The method according to claim 65, further comprising enabling manual transfer of files to a user or group.

119. The method according to claim 65, further comprising creating a Personal Virtual Network to emulate a local area network (LAN) and provide a LAN to LAN connection over an authorized File System Interface Platform.

120. The method according to claim 65, further comprising enabling the use of personal voice and video over a File System Interface Platform.

121. The method according to claim 65, further comprising providing a user collaboration interface.

122. The method according to claim 65, further comprising creating animation icons.

123. The method according to claim 121, further comprising displaying an animation icon.

124. The method according to claim 65, further comprising enabling automatic file transfer.

125. The method according to claim 65, further comprising enabling operation on a JAVA enabled web browser.

126. The method according to claim 65, further comprising providing a gateway to connect a JAVA enabled web browser with a File System Interface Platform.

127. The method according to claim 65, further comprising:
detecting use of plug and play devices; and
automatically transmitting files to remote users and groups.

128. The method according to claim 65, wherein the executable instructions further carry out steps comprising:
providing a single secure messenger configured to securely transfer messages including email messages and instant messenger messages.

129. A computer program product comprising a computer readable media with executable instructions that carry out steps comprising:
scanning a file system of the computer system to obtain file system information;
automatically collecting and organizing the file system information into an internal cache of the file system information organized in a predetermined manner to enable instantaneous response of at least one query that provides a predetermined view of the file system;
automatically monitoring the file system for changes; and
automatically maintaining the internal cache.

130. The computer program product according to claim 129, wherein the executable instructions further carry out steps comprising maintaining internal data structure consistency of the file system information.

131. The computer program product according to claim 129, wherein the executable instructions further carry out steps comprising instructing the computer system to construct one or more visual reports of the file system without rescanning the system.

132. The computer program product according to claim 129, wherein the executable instructions further carry out steps comprising instructing the computer system to scan a predefined portion of the file system, whereby multiple portions of the file system can be simultaneously scanned.

133. The computer program product according to claim 129, wherein the executable instructions further carry out steps comprising storing the file system information in a single data store.

134. The computer program product according to claim 129, wherein the step of scanning the file system further comprises executing a depth first traversal of the file system, and storing the file system information in a set of data structures in memory that is built incrementally during the traversal.

135. The computer program product according to claim 129, wherein the executable instructions further carry out steps comprising enabling execution of user-specified computer instructions.

136. The computer program product according to claim 129, wherein the executable instructions further carry out steps comprising linking to the at least one visual report.

137. The computer program product according to claim 129, wherein the executable instructions further carry out steps comprising generating varied reports based on age of at least one file on the file system.

138. The computer program product according to claim 129, wherein the executable instructions further carry out steps comprising determining the presence of duplicate files on the computer system.

139. The computer program product according to claim 129, wherein the executable instructions further carry out steps comprising:
generating a report of security permissions for at least one part of at least one of the file system and multiple file systems; and
providing a single visual report of all file system permissions.

140. The computer program product according to claim 129, wherein the executable instructions further carry out steps comprising:
cross referencing file system security information with user and group information;
calculating user and group actual access rights for at least one part of at least one of the file system and multiple file systems; and
providing a single visual report of actual access rights for all users and groups of a system or multiple systems.

141. The computer program product according to claim 129, wherein the executable instructions further carry out steps comprising generating a report of security vulnerability of at least one part of at least one of the file system and multiple file systems.

142. The computer program product according to claim 129, wherein the executable instructions further carry out steps comprising providing with an original file/files virtual views of backup, mirror, revisions, snapshot, and volume shadow copies of the original file/files.

143. The computer program product according to claim 129, wherein the executable instructions further carry out steps comprising providing transparent views of remote file systems running the executable instructions.

144. The computer program product according to claim 129, wherein the executable instructions further carry out steps comprising instructing a computer system to record file system transactions of a user, and to store and replay the file system transactions.

145. The computer program product according to claim 129, wherein the executable instructions further carry out steps comprising reading and writing files to virtual locations.

146. The computer program product according to claim 129, wherein the executable instructions further carry out steps comprising displaying icons in a matter to automate execution of software programs.

147. The computer program product according to claim 129, wherein the executable instructions further carry out steps comprising providing virtual views of remote file shares.

148. The computer program product according to claim 129, wherein the executable instructions further carry out steps comprising securely connecting a computer to a plurality of computers.

149. The computer program product according to claim 148, wherein the executable instructions further carry out steps comprising providing a file system interface to enforce access to the plurality of computers.

150. The computer program product according to claim 149, wherein the executable instructions further carry out steps comprising self generating credentials of user accounts and passwords from the file system interface for purposes of secure remote system and file access.

151. The computer program product according to claim 150, wherein the executable instructions further carry out steps comprising securely exchanging the self generated credentials from the file system interface.

152. The computer program product according to claim 150, wherein the executable instructions further carry out steps comprising effecting a secure login prior to using the self generated credentials.

153. The computer program product according to claim 149, wherein the executable instructions further carry out steps comprising creating a personal virtual network to link to computers.

154. The computer program product according to claim 149, wherein the executable instructions further carry out steps comprising securely administering remote file system interface platforms.

155. The computer program product according to claim 149, wherein the executable instructions further carry out steps comprising enabling users of a remote file system interface platform to allow, disallow, and store authorized and unauthorized connections.

156. The computer program product according to claim 129, wherein the executable instructions further carry out steps comprising securely selecting computer resources available to authorized connections.

157. The computer program product according to claim 129, wherein the executable instructions further carry out steps comprising:
creating a single copy of duplicate files;
programmatically creating shortcuts to the single copy of duplicate files; and
removing at least one duplicate file from the single copy of duplicate files to save on disk storage space.

158. The computer program product according to claim 129, wherein the executable instructions further carry out steps comprising:
migrating a single copy of a duplicate file to shared storage; and
creating a shortcut to point to the single copy in shared storage.

159. The computer program product according to claim 129, wherein the executable instructions further carry out steps comprising:
migrating old/aging files to alternate lower cost media; and
programmatically creating a shortcut to the migrated files.

160. The computer program product according to claim 129, wherein the executable instructions further carry out steps comprising receiving voice input from a microphone to interface with a File System Interface Platform.

161. The computer program product according to claim 129, wherein the executable instructions further carry out steps comprising securely registering voice prints of particular users for accessing a File System Interface Platform.

162. The computer program product according to claim 129, wherein the executable instructions further carry out steps comprising translating voice instructions to control loading, running and operations of a File System Interface Platform.

163. The computer program product according to claim 129, wherein the executable instructions further carry out steps comprising outputting sounds to speakers of a computer with information from a File System Interface Platform.

164. The computer program product according to claim 129, wherein the executable instructions further carry out steps comprising customizing speaker output to a personal preference.

165. The computer program product according to claim 129, wherein the executable instructions further carry out steps comprising forwarding database transaction records to any number of systems.

166. The computer program product according to claim 129, wherein the executable instructions further carry out steps comprising:
logging database transactions at a creation point; and
running a File System Interface Platform at predetermined locations.

167. The computer program product according to claim 129, wherein the executable instructions further carry out steps comprising storing transaction logs at predetermined locations that are running a File System Interface Platform.

168. The computer program product according to claim 129, wherein the executable instructions further carry out steps comprising viewing and selecting a database transaction to apply or reapply the transaction to a database or group of distributed databases.

169. The computer program product according to claim 129, wherein the executable instructions further carry out steps comprising processing database transactions at any number of locations running a File System Interface Platform.

170. The computer program product according to claim 129, wherein the executable instructions further carry out steps comprising creating synchronized databases in disparate geographical locations.

171. The computer program product according to claim 129, wherein the executable instructions further carry out steps comprising automatically creating database tables and features based on input transactions.

172. The computer program product according to claim 129, wherein the executable instructions further carry out steps comprising creating a database without human programming.

173. The computer program product according to claim 129, wherein the executable instructions further carry out steps comprising creating client side database transactions by selecting display elements.

174. The computer program product according to claim 129, wherein the executable instructions further carry out steps comprising monitoring file system changes and maintaining file system interface data structures.

175. The computer program product according to claim 129, wherein the executable instructions further carry out steps comprising transferring data to another file system when data is changed.

176. The computer program product according to claim 129, wherein the executable instructions further carry out steps comprising working in conjunction with a user messaging system.

177. The computer program product according to claim 129, wherein the computer program product is configured to provide a distributed computing environment executable on any business/personal computer using any type of operating system or hardware.

178. The computer program product according to claim 129, wherein the executable instructions further carry out steps comprising effecting a query to obtain information on a predetermined user from all File Access Processors, a local directory on the system, and a directory services system.

179. The computer program product according to claim 129, wherein the executable instructions further carry out steps comprising creating a permissions monitor to manage company wide data security.

180. The computer program product according to claim 129, wherein the executable instructions further carry out steps comprising:
adding security credentials from a user that performs an add remote operation to a remote system; and
storing the added security credentials to the remote system.

181. The computer program product according to claim 129, wherein the executable instructions further carry out steps comprising managing file system changes by alerting users of security changes, updating internal structures, automatically transmitting changed file, and sending journal changes to journal monitors.

182. The computer program product according to claim 129, wherein the executable instructions further carry out steps comprising enabling manual transfer of files to a user or group.

183. The computer program product according to claim 129, wherein the executable instructions further carry out steps comprising creating a Personal Virtual Network to emulate a local area network (LAN) and provide a LAN to LAN connection over an authorized File System Interface Platform.

184. The computer program product according to claim 129, wherein the executable instructions further carry out steps comprising enabling the use of personal voice and video over a File System Interface Platform.

185. The computer program product according to claim 129, wherein the executable instructions further carry out steps comprising providing a user collaboration interface.

186. The computer program product according to claim 129, wherein the executable instructions further carry out steps comprising creating animation icons.

187. The computer program product according to claim 184, wherein the executable instructions further carry out steps comprising displaying an animation icon.

188. The computer program product according to claim 184, wherein the executable instructions further carry out steps comprising enabling automatic file transfer.

189. The computer program product according to claim 129, wherein the executable instructions further carry out steps comprising enabling operation on a JAVA enabled web browser.

190. The computer program product according to claim 129, wherein the executable instructions further carry out steps comprising providing a gateway to connect a JAVA enabled web browser with a File System Interface Platform.

191. The computer program product according to claim 129, further comprising:
detecting use of plug and play devices; and
automatically transmitting files to remote users and groups.

192. The computer program product according to claim 129, wherein the executable instructions further carry out steps comprising:
providing a single secure messenger configured to securely transfer messages including email messages and instant messenger messages.
